(19) United States
(12) Patent Application Publication
(10) Pub. No.: US 2024/0272773 A1
(43) Pub. Date: Aug. 15, 2024

(54) USER INTERFACES FOR SHARING LOCATIONS OF FINDABLE ITEMS WITH AN ENTITY

(71) Applicant: Apple Inc., Cupertino, CA (US)

(72) Inventors: Frank DE JONG, San Francisco, CA (US); Marcello LUPPI, London (GB)

(21) Appl. No.: 18/440,762

(22) Filed: Feb. 13, 2024

Related U.S. Application Data
(60) Provisional application No. 63/484,737, filed on Feb. 13, 2023.
(60) Provisional application No. 63/552,541, filed on Feb. 12, 2024.

(51) Int. Cl. G06F 3/0484

(52) U.S. Cl. CPC G06F 3/0484

(57) ABSTRACT

Some embodiments described in this disclosure are directed to one or more electronic devices that provide for sharing location information of a remote locator object with an entity for a duration associated with a time-bounded event. Some embodiments described in this disclosure are directed to one or more electronic devices that provide for reporting of an item associated with a remote locator object as lost to an entity for aiding in the recovery of the item. Some embodiments described in this disclosure are directed to one or more electronic device that facilitate processes for providing access to one or more features associated with a remote locator object that is associated with an item to an entity for aiding in the recovery of the item.

### CROSS-REFERENCE TO RELATED APPLICATIONS

This application claims the benefit of U.S. Provisional Application No. 63/484,737, filed Feb. 13, 2023, and U.S. Provisional Application No. 63/552,541, filed Feb. 12, 2024, the contents of which are herein incorporated by reference in their entireties for all purposes.

### FIELD OF THE DISCLOSURE

This relates generally to user interfaces that enable a user to share and/or manage locations of findable items on an electronic device.

### BACKGROUND OF THE DISCLOSURE

User interaction with electronic devices has increased significantly in recent years. These devices can be devices such as computers, tablet computers, televisions, multimedia devices, mobile devices, and the like.

In some circumstances, users may wish to use such devices to track items. Enhancing the user's interactions with the device improves the user's experience with the device and decreases user interaction time, which is particularly important where input devices are battery-operated.

### SUMMARY OF THE DISCLOSURE

Some embodiments described in this disclosure are directed to one or more electronic devices that provide for sharing location information of a remote locator object with an entity for a duration associated with a time-bounded event. Some embodiments described in this disclosure are directed to one or more electronic devices that provide for reporting of an item associated with a remote locator object as lost to an entity for aiding in the recovery of the item. Some embodiments described in this disclosure are directed to one or more electronic device that facilitate processes for providing access to one or more features associated with a remote locator object that is associated with an item to an entity for aiding in the recovery of the item.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The full descriptions of the embodiments are provided in the Drawings and the Detailed Description, and it is understood that the Summary provided above does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 5I-5N provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein.

FIGS. 6A-6I illustrate exemplary ways in which an electronic device shares location information of a remote locator object with an entity for a duration associated with a time-bounded event, in accordance with some embodiments of the disclosure.

FIGS. 7A-7E are flow diagrams illustrating a method of sharing location information of a remote locator object with an entity for a duration associated with a time-bounded event, in accordance with some embodiments of the disclosure.

FIGS. 8A-8G illustrate exemplary ways in which an electronic device facilitates reporting of an item associated with a remote locator object as lost to an entity for aiding in the recovery of the item, in accordance with some embodiments of the disclosure.

FIGS. 9A-9D are flow diagrams illustrating a method of facilitating reporting of an item associated with a remote locator object as lost to an entity for aiding in the recovery of the item, in accordance with some embodiments of the disclosure.

FIGS. 10A-10CC illustrate exemplary ways in which an electronic device facilitates providing access to one or more features associated with a remote locator object to an entity in accordance with some embodiments of the disclosure.

FIG. 11 is a flow diagram illustrating a method of facilitating providing access to one or more features associated with a remote locator object to an entity in accordance with some embodiments of the disclosure.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Some embodiments described in this disclosure are directed to one or more electronic devices that provide for sharing location information of a remote locator object with an entity for a duration associated with a time-bounded event. Some embodiments described in this disclosure are directed to one or more electronic devices that provide for reporting of an item associated with a remote locator object as lost to an entity for aiding in the recovery of the item. Some embodiments described in this disclosure are directed to one or more electronic device that facilitate processes for providing access to one or more features associated with a remote locator object that is associated with an item to an entity for aiding in the recovery of the item.

There is a need for electronic devices to track the location of remote locator objects and share and manage the location of remote locator objects relative to a time-bounded event. Such techniques can reduce the cognitive burden on a user who uses such devices and/or wishes to control their use of such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and/or iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

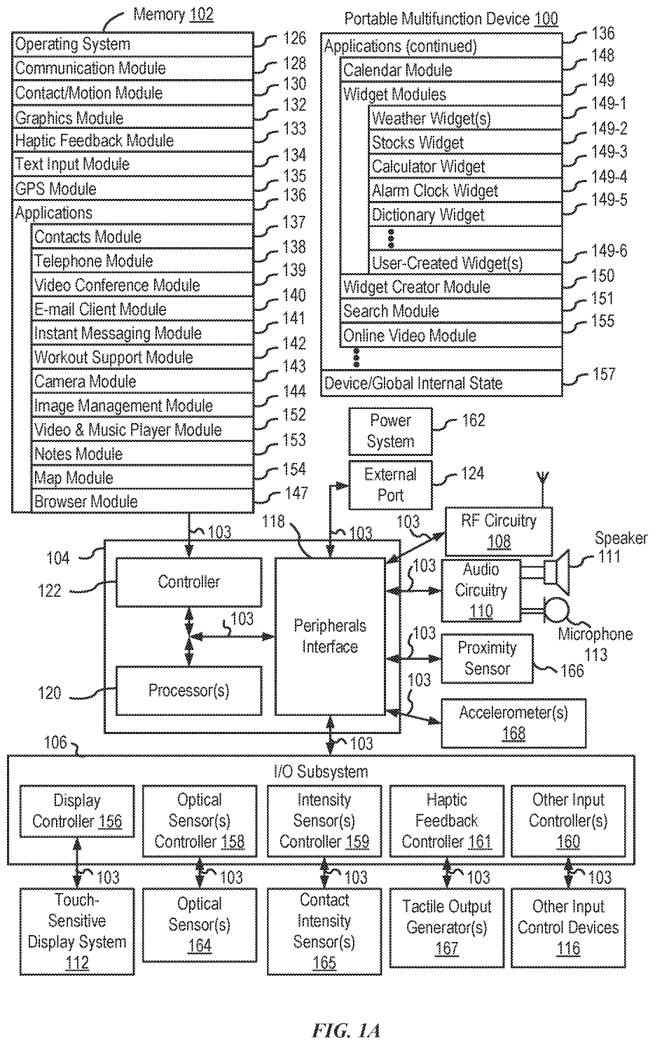

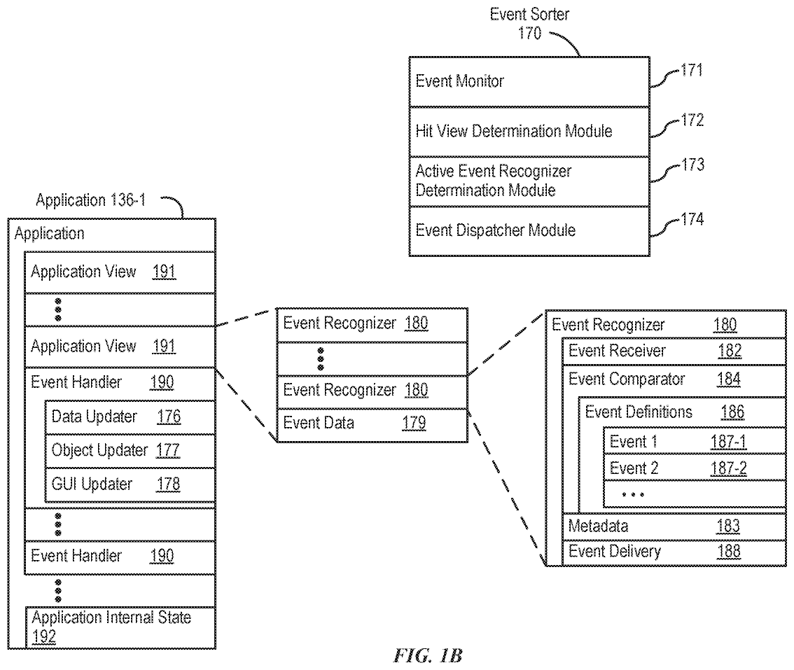

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

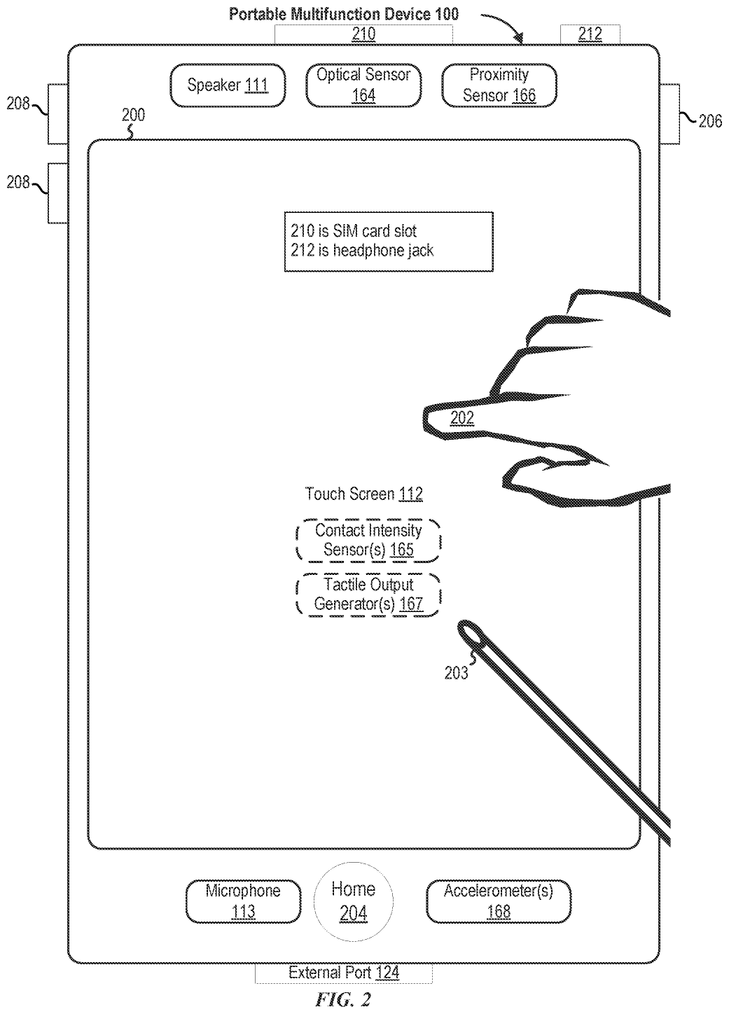

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

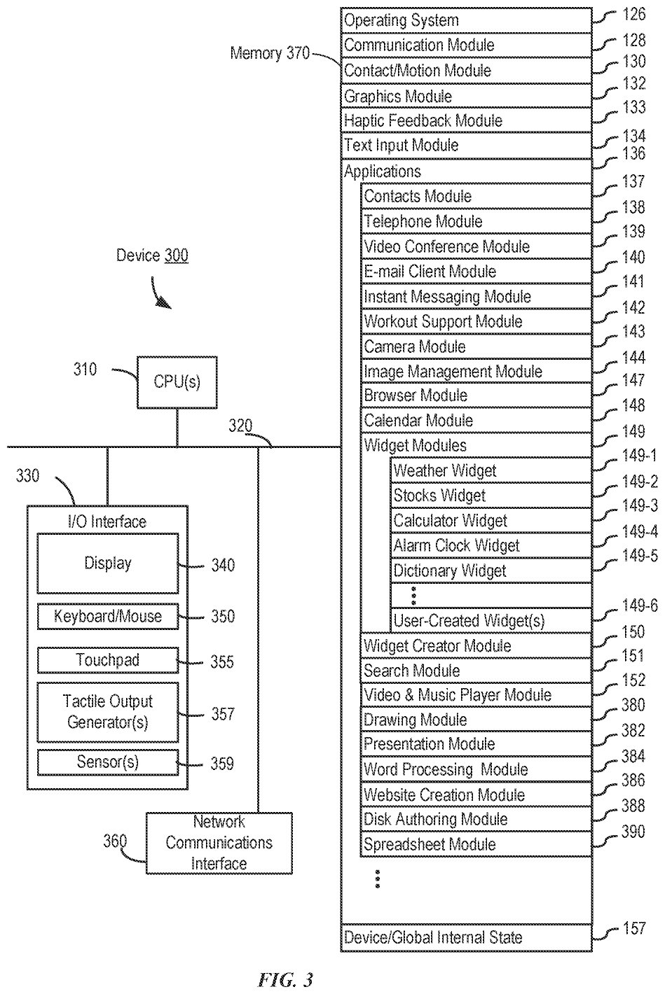

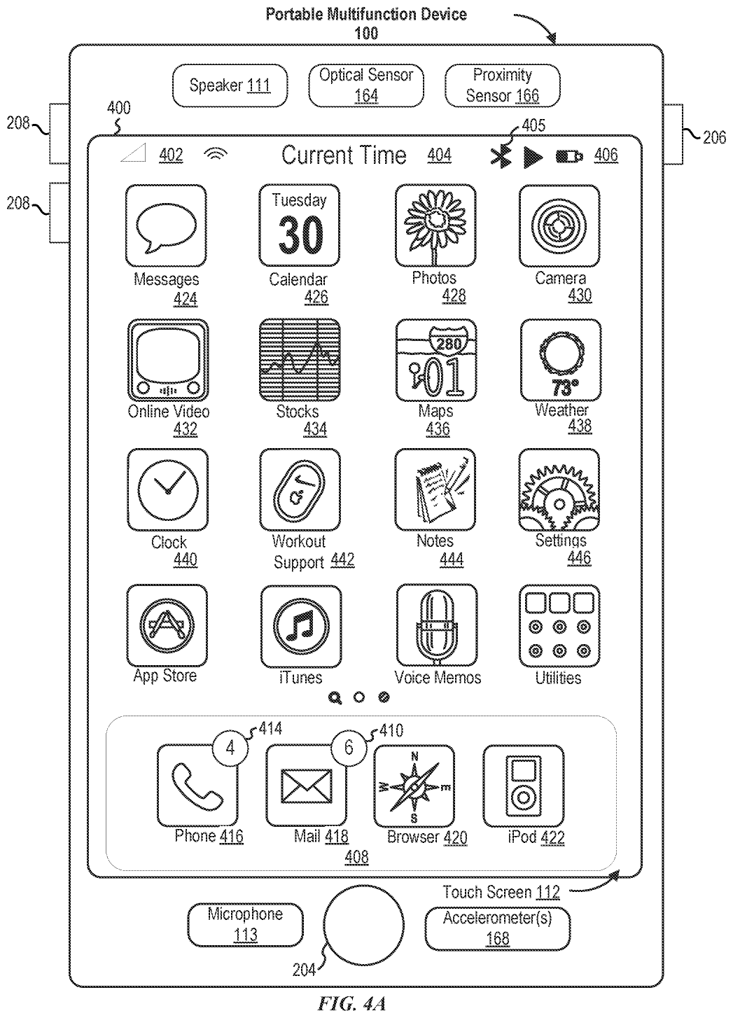

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and/or terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

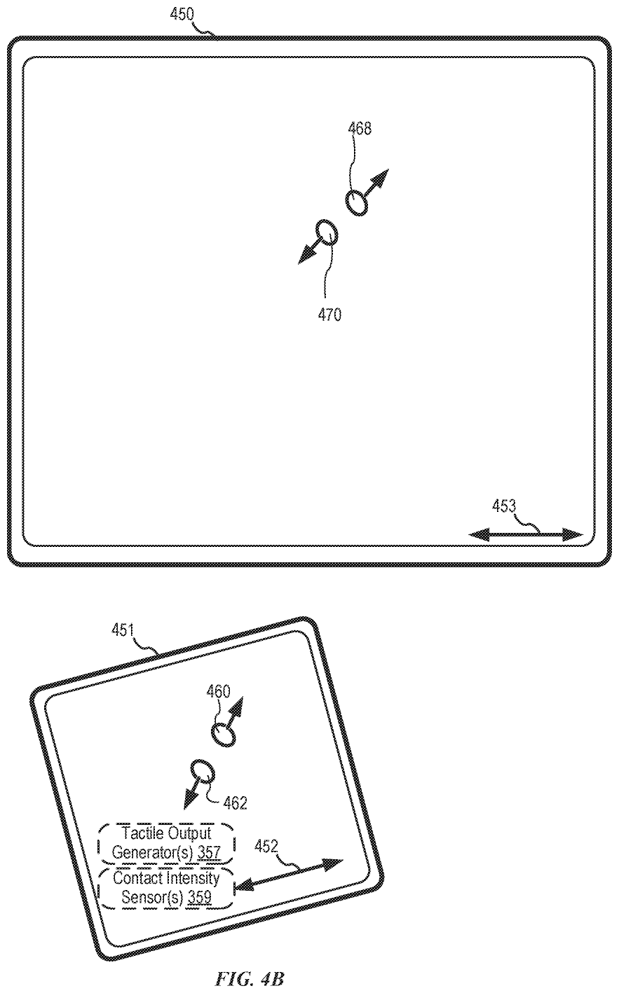

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

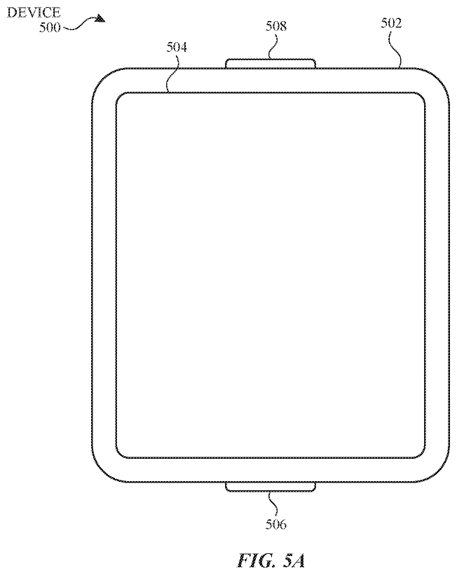

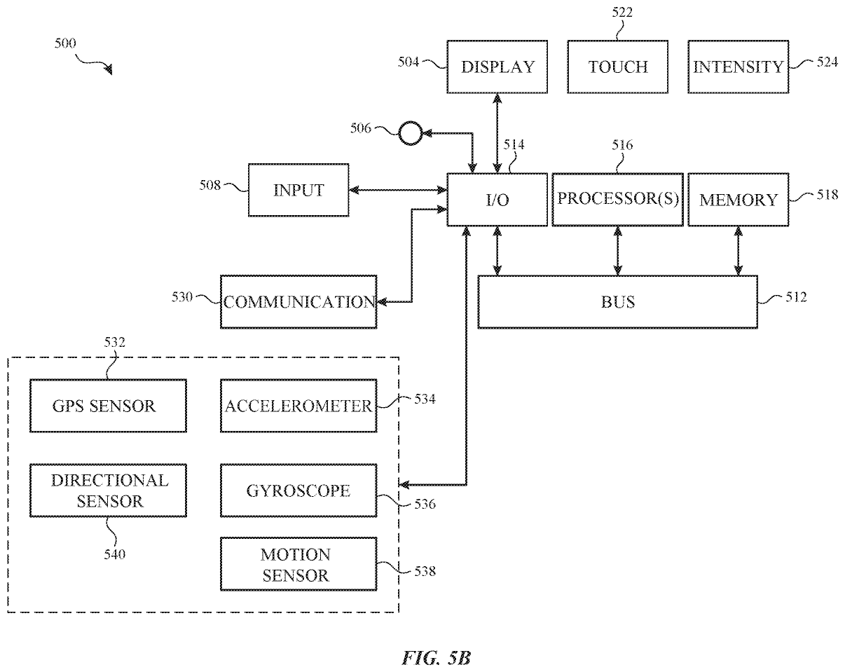

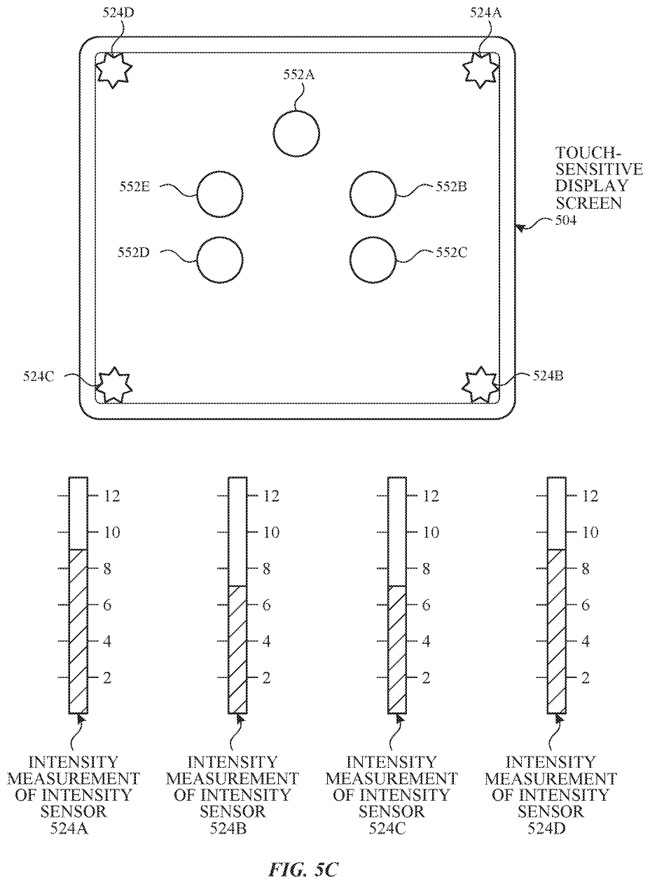

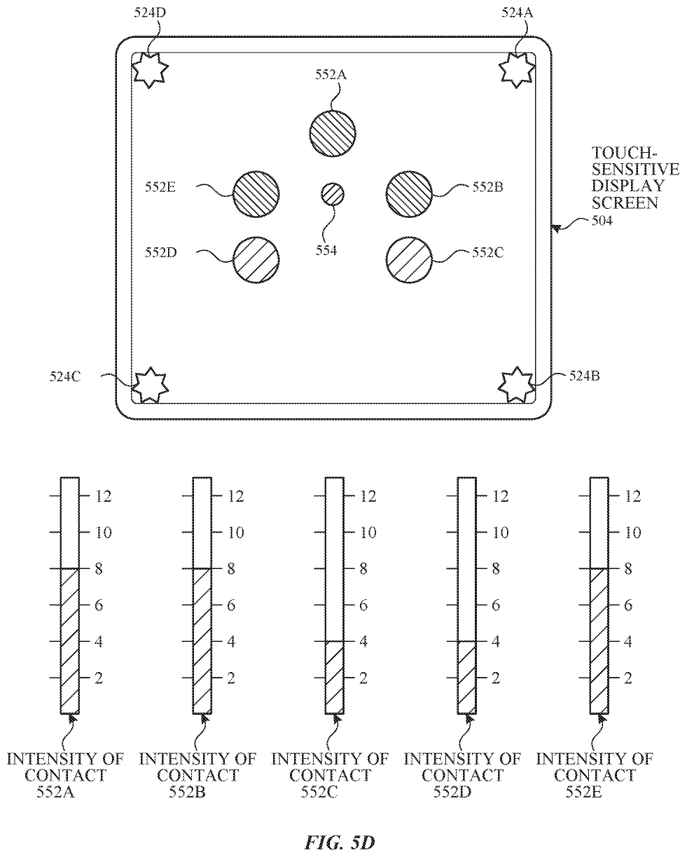

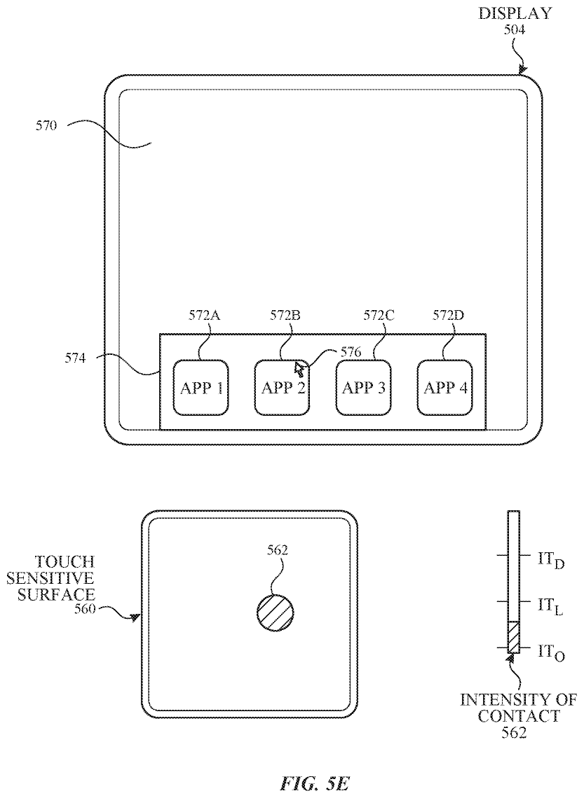

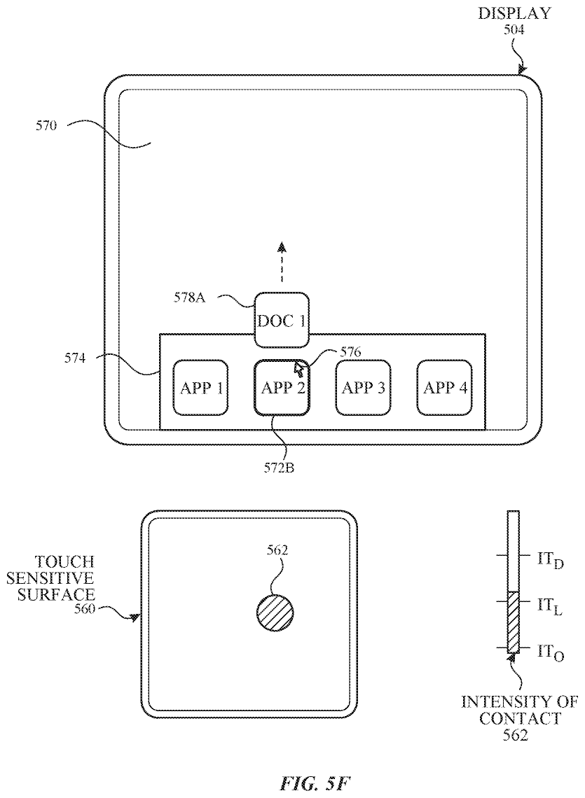

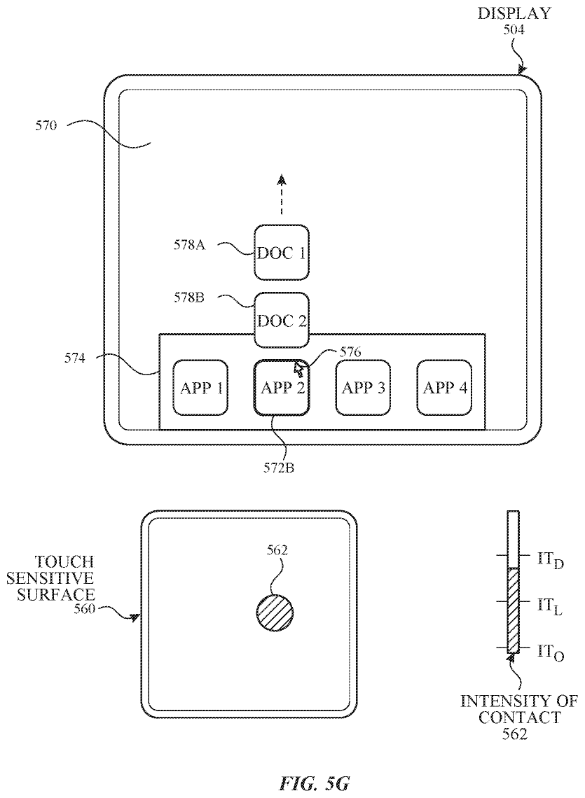

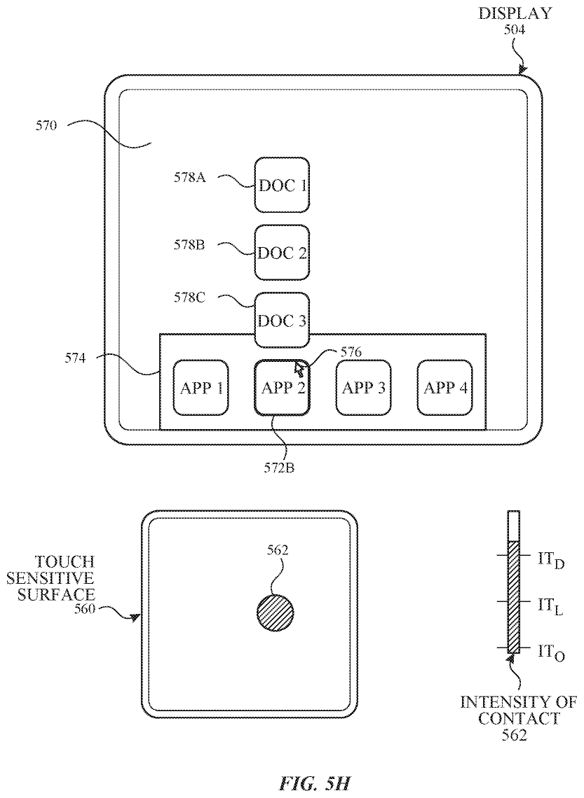

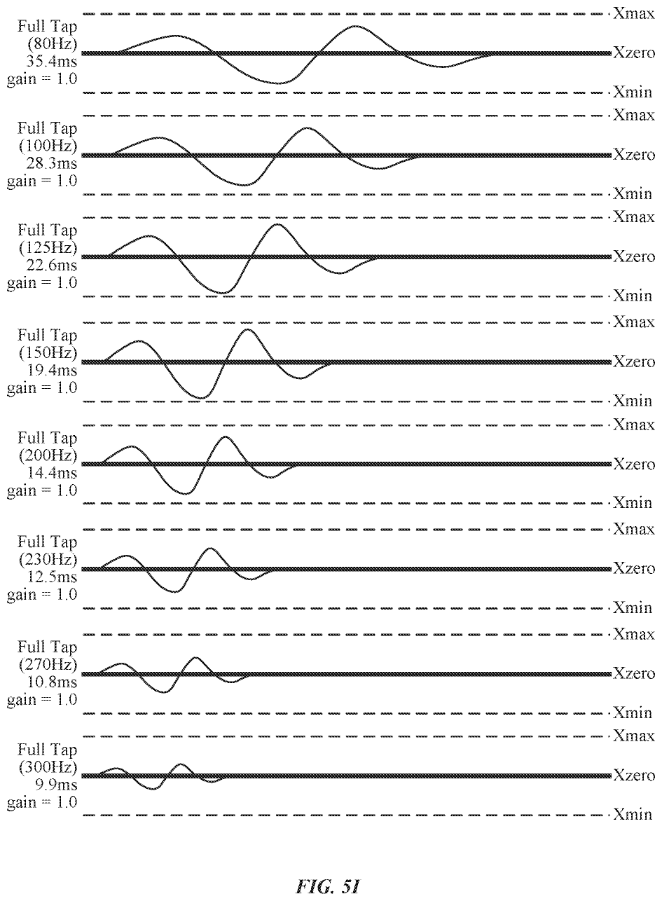

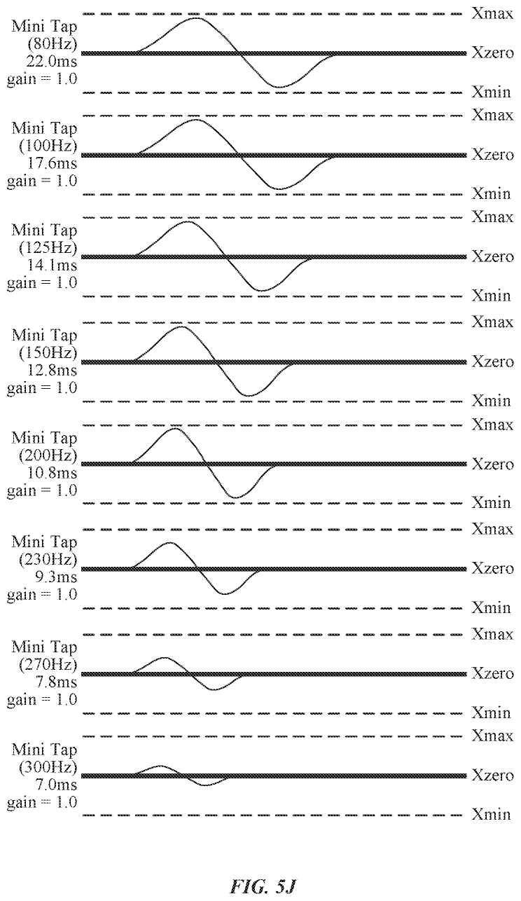

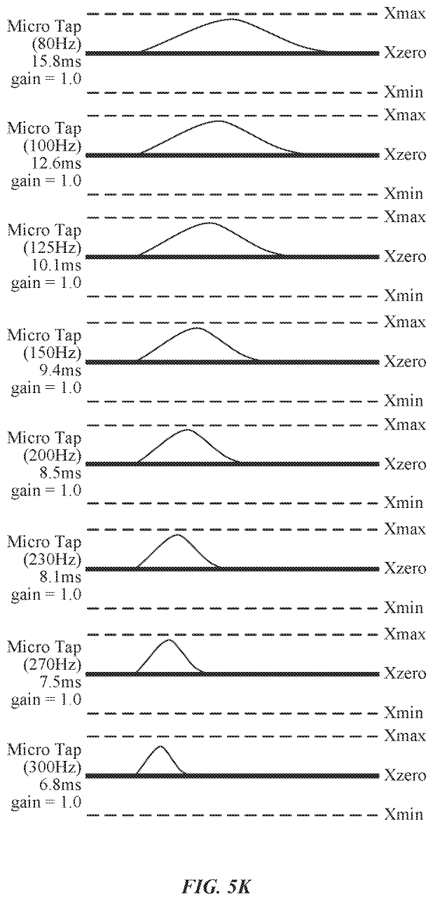

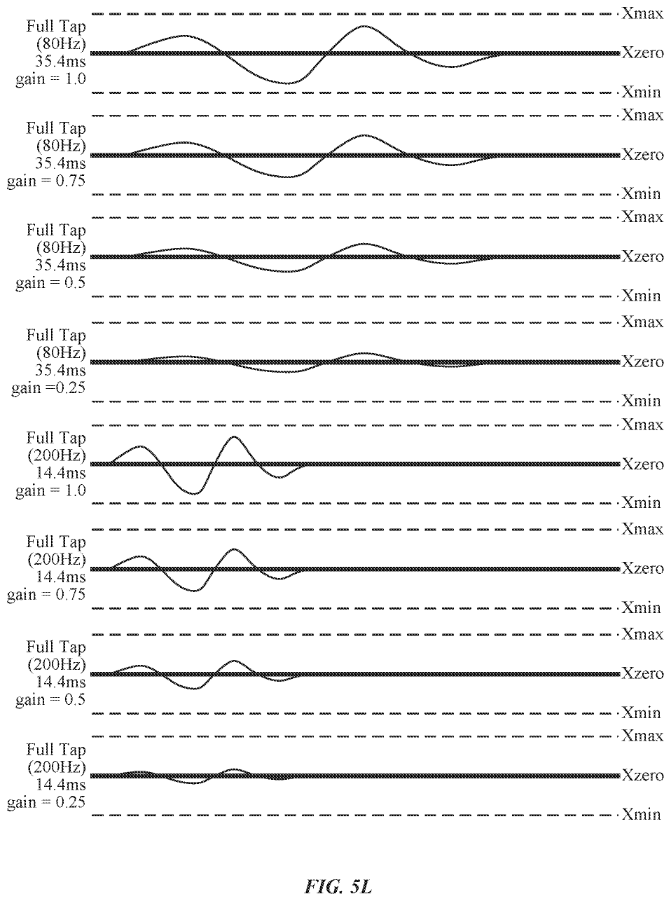

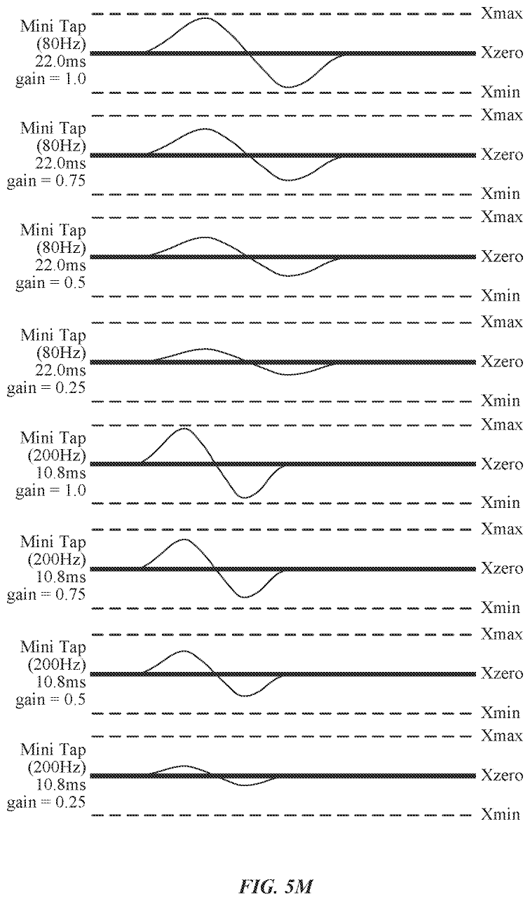

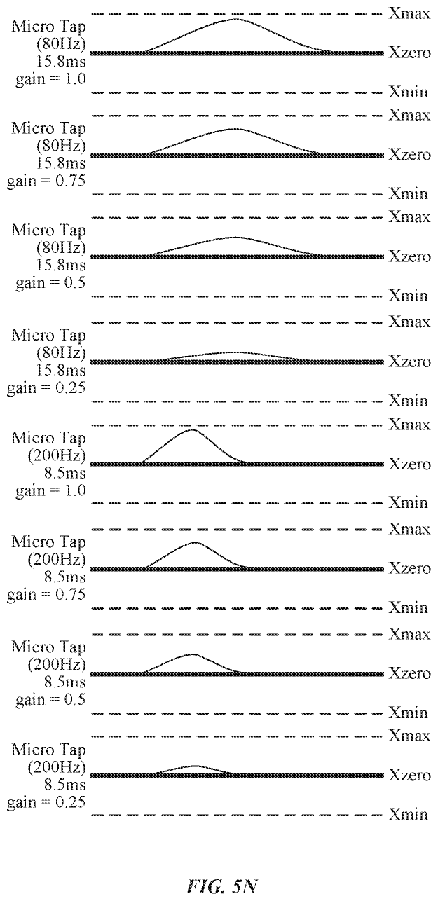

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

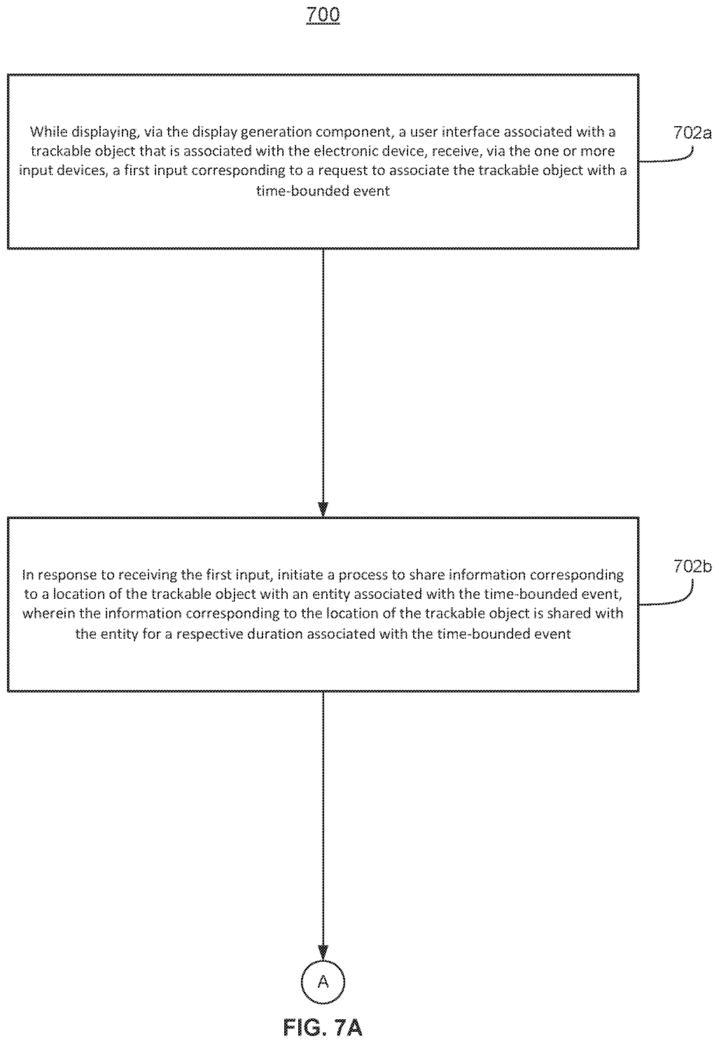

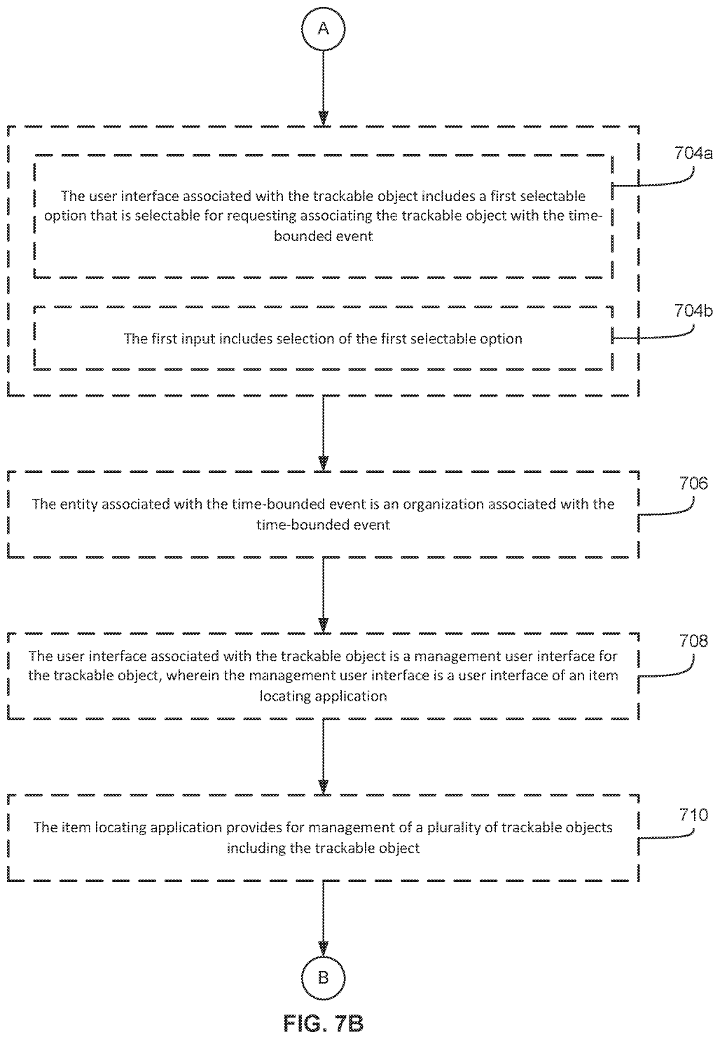

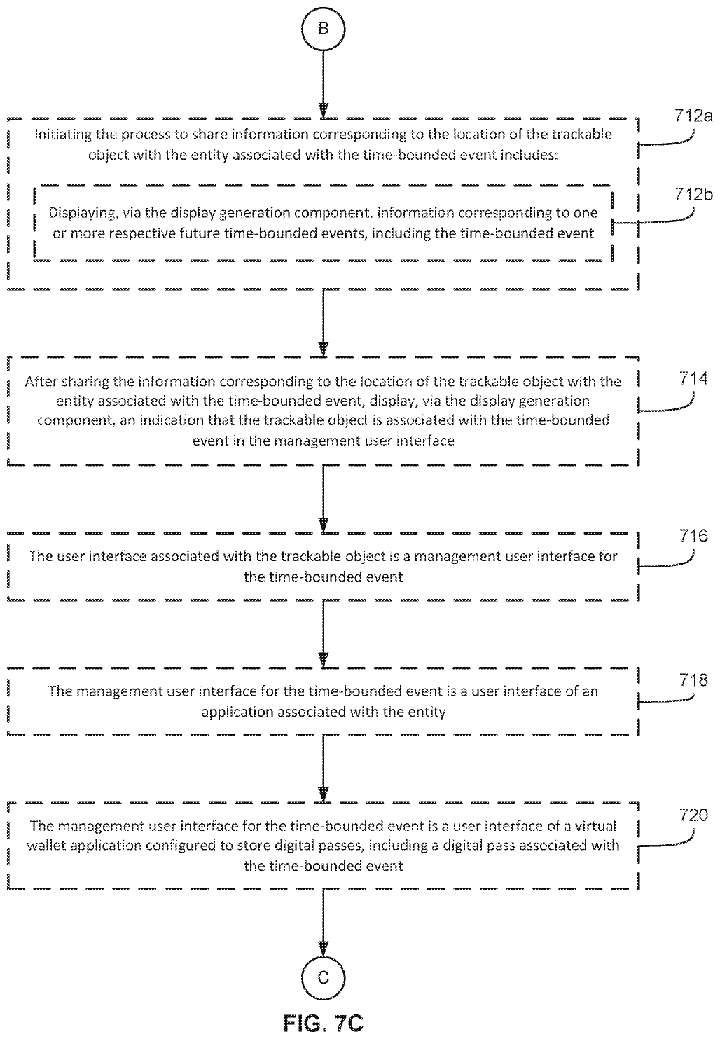

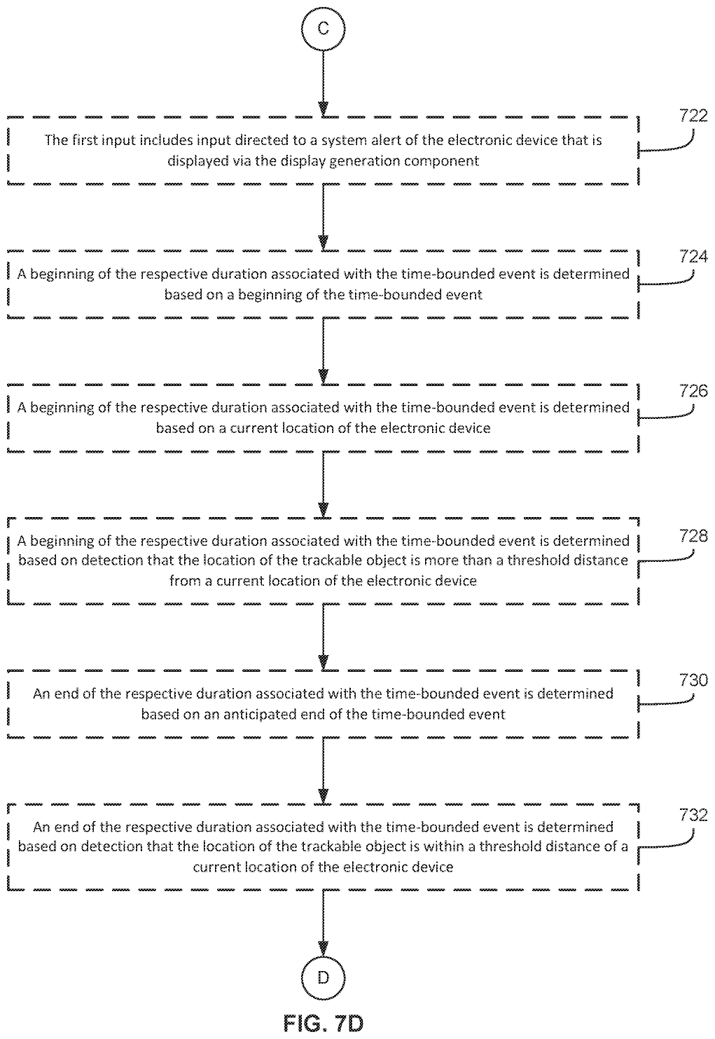

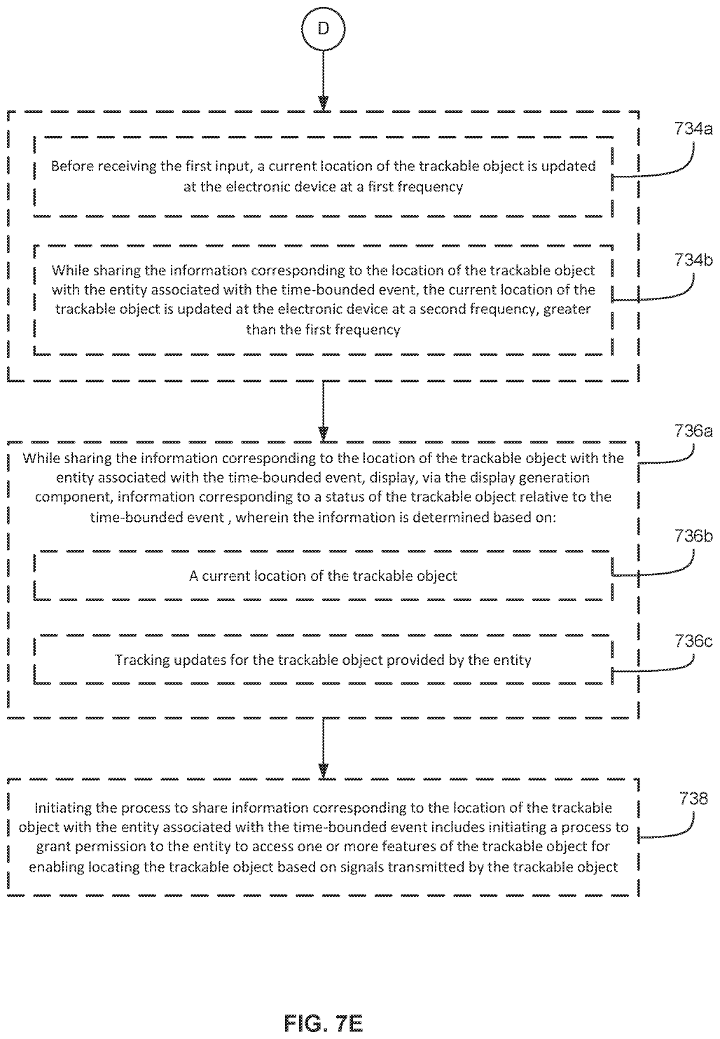

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, and 100 (FIGS. 7, 9, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D})”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D})”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D})”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

In some embodiments, electronic device 500 includes one or more tactile output generators, where the one or more tactile output generators generate different types of tactile output sequences, as described below in Table 1. In some embodiments, a particular type of tactile output sequence generated by the one or more tactile output generators of the device corresponds to a particular tactile output pattern. For example, a tactile output pattern specifies characteristics of a tactile output, such as the amplitude of the tactile output, the shape of a movement waveform of the tactile output, the frequency of the tactile output, and/or the duration of the tactile output. When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device.

More specifically, FIGS. 5I-5K provide a set of sample tactile output patterns that may be used, either individually or in combination, either as is or through one or more transformations (e.g., modulation, amplification, truncation, etc.), to create suitable haptic feedback in various scenarios and for various purposes, such as those mentioned above and those described with respect to the user interfaces and methods discussed herein. This example of a palette of tactile outputs shows how a set of three waveforms and eight frequencies can be used to produce an array of tactile output patterns. In addition to the tactile output patterns shown in these figures, each of these tactile output patterns is optionally adjusted in amplitude by changing a gain value for the tactile output pattern, as shown, for example for FullTap 80 Hz, FullTap 200 Hz, MiniTap 80 Hz, MiniTap 200 Hz, MicroTap 80 Hz, and MicroTap 200 Hz in FIGS. 5L-5N, which are each shown with variants having a gain of 1.0, 0.75, 0.5, and 0.25. As shown in FIGS. 5L-5N, changing the gain of a tactile output pattern changes the amplitude of the pattern without changing the frequency of the pattern or changing the shape of the waveform. In some embodiments, changing the frequency of a tactile output pattern also results in a lower amplitude as some tactile output generators are limited by how much force can be applied to the moveable mass and thus higher frequency movements of the mass are constrained to lower amplitudes to ensure that the acceleration needed to create the waveform does not require force outside of an operational force range of the tactile output generator (e.g., the peak amplitudes of the FullTap at 230 Hz, 270 Hz, and 300 Hz are lower than the amplitudes of the FullTap at 80 Hz, 100 Hz, 125 Nz, and 200 Hz).

FIGS. 5I-5N show tactile output patterns that have a particular waveform. The waveform of a tactile output pattern represents the pattern of physical displacements relative to a neutral position (e.g., Xzero) versus time that a moveable mass goes through to generate a tactile output with that tactile output pattern. For example, a first set of tactile output patterns shown in FIG. 5I (e.g., tactile output patterns of a “FullTap”) each have a waveform that includes an oscillation with two complete cycles (e.g., an oscillation that starts and ends in a neutral position and crosses the neutral position three times). A second set of tactile output patterns shown in FIG. 5J (e.g., tactile output patterns of a “MiniTap”) each have a waveform that includes an oscillation that includes one complete cycle (e.g., an oscillation that starts and ends in a neutral position and crosses the neutral position one time). A third set of tactile output patterns shown in FIG. 5K (e.g., tactile output patterns of a “MicroTap”) each have a waveform that includes an oscillation that include one half of a complete cycle (e.g., an oscillation that starts and ends in a neutral position and does not cross the neutral position). The waveform of a tactile output pattern also includes a start buffer and an end buffer that represent the gradual speeding up and slowing down of the moveable mass at the start and at the end of the tactile output. The example waveforms shown in FIGS. 5I-5N include Xmin and Xmax values which represent the maximum and minimum extent of movement of the moveable mass. For larger electronic devices with larger moveable masses, there may be larger or smaller minimum and maximum extents of movement of the mass. The examples shown in FIGS. 5I-5N describe movement of a mass in one dimension, however similar principles would also apply to movement of a moveable mass in two or three dimensions.

As shown in FIGS. 5I-5K, each tactile output pattern also has a corresponding characteristic frequency that affects the “pitch” of a haptic sensation that is felt by a user from a tactile output with that characteristic frequency. For a continuous tactile output, the characteristic frequency represents the number of cycles that are completed within a given period of time (e.g., cycles per second) by the moveable mass of the tactile output generator. For a discrete tactile output, a discrete output signal (e.g., with 0.5, 1, or 2 cycles) is generated, and the characteristic frequency value specifies how fast the moveable mass needs to move to generate a tactile output with that characteristic frequency. As shown in FIGS. 5I-5N, for each type of tactile output (e.g., as defined by a respective waveform, such as FullTap, MiniTap, or MicroTap), a higher frequency value corresponds to faster movement(s) by the moveable mass, and hence, in general, a shorter time to complete the tactile output (e.g., including the time to complete the required number of cycle(s) for the discrete tactile output, plus a start and an end buffer time). For example, a FullTap with a characteristic frequency of 80 Hz takes longer to complete than FullTap with a characteristic frequency of 100 Hz (e.g., 35.4 ms vs. 28.3 ms in FIG. 5I). In addition, for a given frequency, a tactile output with more cycles in its waveform at a respective frequency takes longer to complete than a tactile output with fewer cycles its waveform at the same respective frequency. For example, a FullTap at 150 Hz takes longer to complete than a MiniTap at 150 Hz (e.g., 19.4 ms vs. 12.8 ms), and a MiniTap at 150 Hz takes longer to complete than a MicroTap at 150 Hz (e.g., 12.8 ms vs. 9.4 ms). However, for tactile output patterns with different frequencies this rule may not apply (e.g., tactile outputs with more cycles but a higher frequency may take a shorter amount of time to complete than tactile outputs with fewer cycles but a lower frequency, and vice versa). For example, at 300 Hz, a FullTap takes as long as a MiniTap (e.g., 9.9 ms).

As shown in FIGS. 5I-5K, a tactile output pattern also has a characteristic amplitude that affects the amount of energy that is contained in a tactile signal, or a “strength” of a haptic sensation that may be felt by a user through a tactile output with that characteristic amplitude. In some embodiments, the characteristic amplitude of a tactile output pattern refers to an absolute or normalized value that represents the maximum displacement of the moveable mass from a neutral position when generating the tactile output. In some embodiments, the characteristic amplitude of a tactile output pattern is adjustable, e.g., by a fixed or dynamically determined gain factor (e.g., a value between 0 and 1), in accordance with various conditions (e.g., customized based on user interface contexts and behaviors) and/or preconfigured metrics (e.g., input-based metrics, and/or user-interface-based metrics). In some embodiments, an input-based metric (e.g., an intensity-change metric or an input-speed metric) measures a characteristic of an input (e.g., a rate of change of a characteristic intensity of a contact in a press input or a rate of movement of the contact across a touch-sensitive surface) during the input that triggers generation of a tactile output. In some embodiments, a user-interface-based metric (e.g., a speed-across-boundary metric) measures a characteristic of a user interface element (e.g., a speed of movement of the element across a hidden or visible boundary in a user interface) during the user interface change that triggers generation of the tactile output. In some embodiments, the characteristic amplitude of a tactile output pattern may be modulated by an “envelope” and the peaks of adjacent cycles may have different amplitudes, where one of the waveforms shown above is further modified by multiplication by an envelope parameter that changes over time (e.g., from 0 to 1) to gradually adjust amplitude of portions of the tactile output over time as the tactile output is being generated.

Although specific frequencies, amplitudes, and waveforms are represented in the sample tactile output patterns in FIGS. 5I-5K for illustrative purposes, tactile output patterns with other frequencies, amplitudes, and waveforms may be used for similar purposes. For example, waveforms that have between 0.5 to 4 cycles can be used. Other frequencies in the range of 60 Hz-400 Hz may be used as well. Table 1 below provides representative examples of tactile output/haptic feedback behaviors and configurations, and examples of their use with respect to the user interfaces for managing content-based tactile outputs that are illustrated and described herein.

TABLE 1

| | | Textural |
|---|---|---|
| Type of Tactile | | (continuous) |
| Output Sequence | Waveform | or Discrete |
| “Major” | MiniTap at 180 Hz | Discrete |
| “Minor” | MicroTap at 80 Hz | Textural |
| “Major-reduced” | MiniTap at 200 Hz | Discrete |
| “Minor-Reduced” | MicroTap at 200 Hz | Discrete |

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

### User Interfaces and Associated Processes

### Time-Bounded Location Sharing of a Remote Locator Object

Users interact with electronic devices in many different manners. In some embodiments, an electronic device is able to track the location of a trackable object such as a remote locator object. In some embodiments, access to such remote locator objects can be shared by an owner of the remote locator object with an entity (e.g., one or more persons associated with the entity). The embodiments described below provide ways in which an electronic device shares location information of a remote locator object with an entity for a duration of time that is associated with a time-bounded event, thus enhancing the user's interactions with the electronic device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

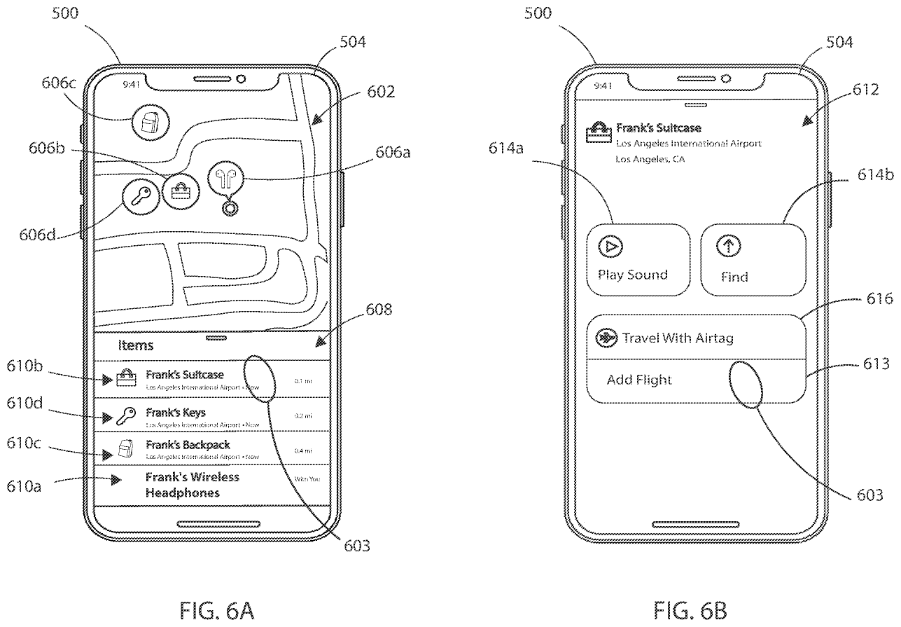

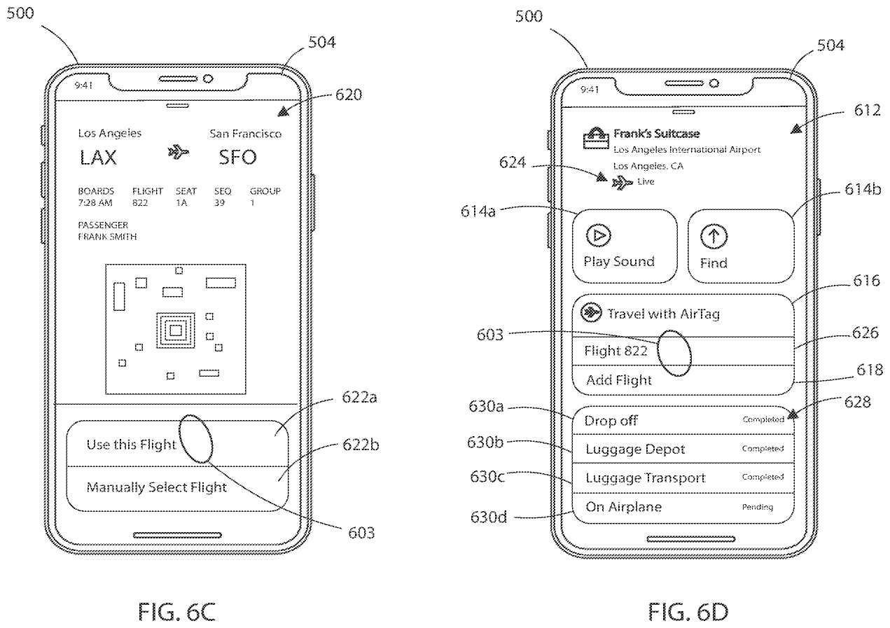

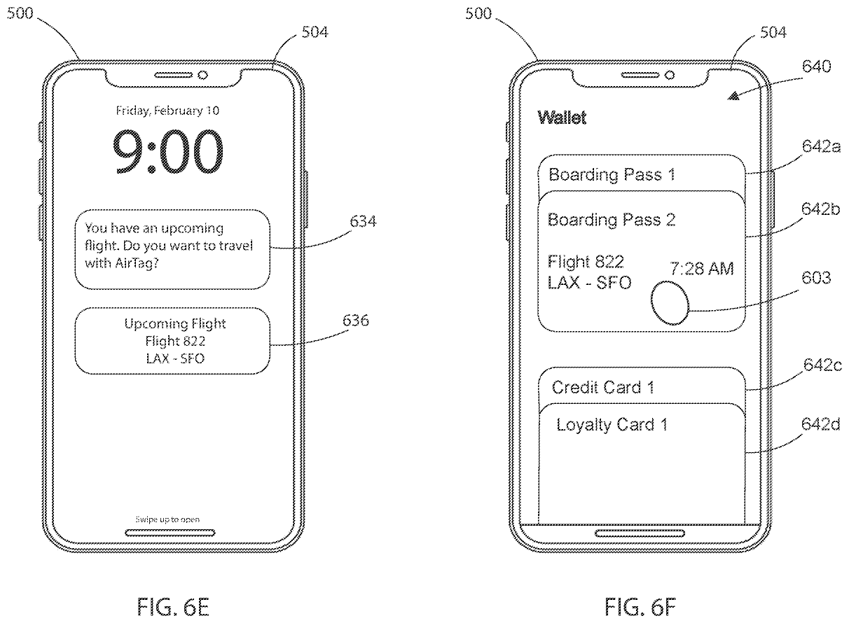

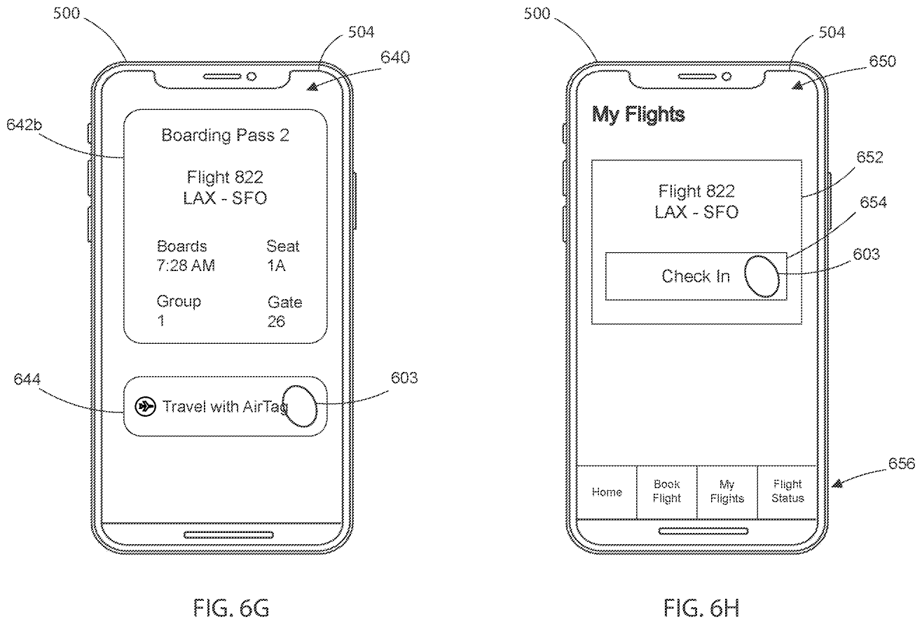

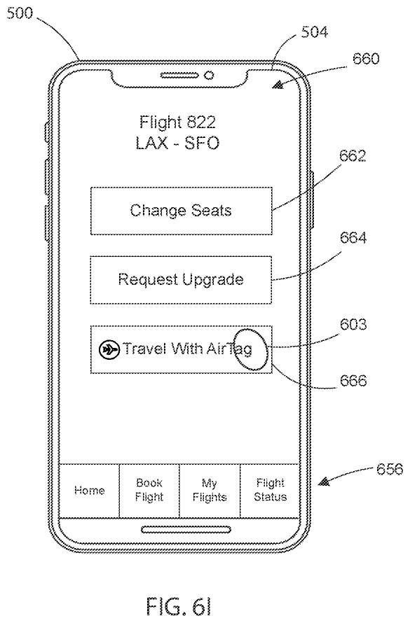

FIGS. 6A-6I illustrate exemplary ways in which an electronic device shares location information of a remote locator object with an entity for a duration associated with a time-bounded event, in accordance with some embodiments of the disclosure. The embodiments in these figures are used to illustrate the processes described below, including the processes described with reference to FIGS. 7A-7E.

FIGS. 6A-6I illustrate an electronic device 500 associated with a user, including touch screen 504 displaying one or more aspects of sharing a location of a remote locator object with an entity for a duration that is associated with a time-bounded event. In FIG. 6A, electronic device 500 represents a mobile electronic device belonging to Frank, as described below. Furthermore, and as shown in FIG. 6A, electronic device 500 displays a user interface 602 of an item locating application that displays information regarding one or more findable items the locations to which the user (e.g., Frank) has access. It should be understood that, as described below, the location of the electronic device 500 and the location of the user of the electronic device 500 are referred to herein interchangeably.

As shown in FIG. 6A, in some embodiments, the user interface 602 of the item locating application includes a list 608 of findable items to which the user (e.g., Frank) has access to the locations thereof. For example, and as shown in FIG. 6A, the list 608 (titled “Items”) includes findable items (e.g., remote locator objects or other trackable objects) that are owned by the user, such as Frank's Suitcase in first item 610b, Frank's Keys in second item 610d, Frank's Backpack in third item 610c, and Frank's Wireless Headphones in fourth item 610a. As shown in FIG. 6A, the findable items of the list 608 optionally include graphical representations corresponding to the particular findable item, such as graphical representation of a suitcase for Frank's Suitcase in 610b and graphical representation of a key for Frank's Keys in 610d.

In some embodiments, the user interface 602 of the item locating application includes one or more distance indications that indicate the distance the items of list 608 are from the electronic device 500 (and thus from the user). In some embodiments, the one or more distance indications are optionally accompanied by a time indication (e.g., Now, 2 seconds ago, 1 minute ago, 1 hour ago, or 5 hours ago) that indicates when a particular distance indication was last updated. For example, as shown in FIG. 6A, in the user interface 602, first item 610b of list 608 indicates that findable item Frank's Suitcase is approximately 0.1 miles from the current location of the electronic device 500, and such location information was last updated Now (e.g., when the user interface 602 is first displayed on the electronic device 500). Further, in FIG. 6A, second item 610d of list 608 indicates that findable item Frank's Keys is 0.2 miles from the current location of the electronic device 500, and such location information was last updated Now. Additionally, as shown in FIG. 6A as an example, third item 610c of list 608 indicates that findable item Frank's Backpack is approximately 0.4 miles from the current location of the electronic device 500, and such location information was last updated Now, and fourth item 610a indicates that findable item Frank's Wireless Headphones is “With You” (e.g., at the current location of the user). As indicated in the example of FIG. 6A, the location of the findable items in the list 508 is optionally given as a name of the location, such as Los Angeles International Airport. In some embodiments, the location of the findable items is alternatively provided as an address. In some embodiments, a given item in list 608 does not include an indication of a distance of the corresponding findable item when that findable item is indicated as being “With You” (e.g., is within a threshold distance of device 500A, such as 0.1, 0.5, 1, 5, 10, or 100 meters).

In some embodiments, the user interface 602 of the item locating application in FIG. 6A includes a representation of a map of a physical region surrounding and/or including the location of the user (e.g., Frank) and/or the electronic device 500. In some embodiments, the map indicates the location of the user (e.g., Frank) and/or the electronic device 500 as a circle, the locations of the findable items (e.g., including remote locator objects) of list 608, such as a representation of Frank's Suitcase (icon 606b) at a location on the map corresponding to the location of Frank's Suitcase in the physical region, a representation of Frank's Keys (icon 606d) at a location on the map corresponding to the location of Frank's Keys, a representation of Frank's Backpack (icon 606c) at a location on the map corresponding to the location of Frank's Backpack, and a representation of Frank's Wireless Headphones (icon 606a) at a location on the map corresponding to the location of Frank's Wireless Headphones, and/or locations of additional users that share their location with the user (e.g., Frank). As shown in the example of FIG. 6A, no additional users are currently sharing their locations with Frank and thus, no additional user is displayed on the map in the user interface 602. As further shown in FIG. 6A, and as noted above, the representations 606a, 606b, 606c, and 606d indicate the corresponding findable item (e.g., a graphic of the corresponding findable item) such that the user (e.g., Frank) can visually identify the findable item on the map of the user interface 602. In some embodiments, and as shown in FIG. 6A, the representations of the findable items on the map of the user interface 602 are bubbles and/or circles including the graphics discussed above. However, it should be understood that the representations are optionally any shape and/or size. In some embodiments, and as shown in FIG. 6A, the representation 606a of the findable item Frank's Wireless Headphones and the current location of the user/electronic device 500 are stacked on map of the user interface 602 because the current location of the user and the findable item Frank's Wireless Headphones are in close proximity.

In FIG. 6A, while the user interface 602 of the item locating application is displayed via the touch screen 504, the electronic device 500 detects a selection, via contact 603, directed to the first item 610b of the list 608 in the user interface 602. For example, the electronic device 500 detects a click, tap, slide, and/or hover input on the touch screen 504 over a location corresponding to the first item 610b. In some embodiments, as shown in FIG. 6B, in response to detecting the selection of the first item 610b, the electronic device 500 displays, via the touch screen 504, user interface 612 associated with the findable item Frank's Suitcase. For example, as shown in FIG. 6B, the electronic device 500 replaces display of the user interface 602 with the user interface 612. In some embodiments, the user interface 612 corresponds to an expansion of the first item 610b in the list 608 of the user interface 502. For example, as shown in FIG. 6B, the user interface 612 includes the name of the selected findable item (e.g., Frank's Suitcase) and the current location of the selected findable item (e.g., Los Angeles International Airport, which is located in Los Angeles, California).

In some embodiments, the user interface 612 associated with the findable item Frank's Suitcase enables provides for management of the findable item Frank's Suitcase. For example, as shown in FIG. 6B, the user interface 612 includes a first selectable option 614a and a second selectable option 614b. In some embodiments, the first selectable option 614a is selectable to cause the findable item (e.g., the remote locator object) named Frank's Suitcase to emit sound (e.g., a ring, chime, tone, song, or other tune) that enables the user to locate the findable item. In some embodiments, the second selectable option 614b is selectable to selectable to initiate a process for navigating to the findable item Frank's Suitcase. For example, the electronic device displays, via the touch screen 504, a user interface of a navigation application that provides instructions (e.g., route details and/or overview) for travelling to the location of the findable item.

Additionally, as shown in FIG. 6B, the user interface 612 includes region 616 that is associated with a time-bounded event. For example, the time-bounded event is a travel event that the user (e.g., Frank) is going to be participating in. In the example of FIGS. 6A-6E, the time-bounded event is a flight, though, it should be understood, other time-bounded events are possible (e.g., as described below with reference to method 700). In some embodiments, the information included in the region 616 is based on the current location of the electronic device 500 and/or the findable item Frank's Suitcase. For example, because the current location of the electronic device 500 (e.g., and the user) and the findable item Frank's Suitcase is Los Angeles International Airport, the electronic device 500 prompts the user to associate the findable item Frank's Suitcase with a particular flight, such as via selectable option 613. As discussed below, in some embodiments, the selectable option 613 is selectable to initiate a process for associating the findable item Frank's Suitcase with a particular time-bounded event (e.g., flight).

In FIG. 6B, the electronic device 500 detects a selection directed to the selectable option 613. For example, as shown in FIG. 6B, the electronic device 500 detects a tap of contact 603 on a location of the touch screen 504 that corresponds to the selectable option 613. In some embodiments, as shown in FIG. 6C, in response to detecting the selection of the selectable option 613, the electronic device 500 initiates a process for associating the findable item Frank's Suitcase with a particular flight. For example, as shown in FIG. 6C, the electronic device 500 displays, via the touch screen 504, a user interface 620 for associating the findable item Frank's Suitcase with a time-bounded event (e.g., flight), as discussed below.

In some embodiments, as shown in FIG. 6C, in accordance with a determination that the user has an upcoming flight (e.g., today, tomorrow, next week, and/or next month), the electronic device 500 suggests the upcoming flight as the time-bounded event to associate with the findable item Frank's Suitcase. In some embodiments, as shown in FIG. 6C, suggesting an upcoming flight includes displaying a representation of a digital boarding pass for the user (e.g., Frank) that is associated with the upcoming flight in the user interface 620. In some embodiments, the electronic device 500 displays the digital boarding pass because the electronic device 500 has access to the digital boarding pass. For example, the user has previously downloaded and saved the digital boarding pass to (e.g., a memory of) the electronic device 500 for use later in boarding a plane associated with the indicated flight (e.g., Flight 822). As shown in FIG. 6C, the user interface 620 includes first selectable option 622a and second selectable option 622b. In some embodiments, the first selectable option 622a is selectable to associate the suggested upcoming flight with the findable item Frank's Suitcase, as discussed in more detail below. In some embodiments, the second selectable option 622b is selectable to associate the findable item Frank's Suitcase with a different time-bounded event, such as a different flight. For example, selection of the second selectable option 622b enables the user to manually select a time-bounded event (e.g., by entering (e.g., via keyboard input) details for the time-bounded event (e.g., flight), such as passenger information, flight number, airline, and the like). In some embodiments, if no known upcoming time-bounded event is recognized/identified by the electronic device 500 (e.g., because the user has not downloaded and saved a digital boarding pass to the electronic device 500), the user interface 620 does not include a representation of a digital boarding pass as discussed above and optionally only includes the selectable option 622b. It should be understood that, in some embodiments, if the user has additional upcoming flights or other time-bounded events, the user interface 620 includes additional representations of digital passes that are associated with the additional time-bounded events and that are browsable (e.g., scrollable) to allow the user to associated the findable item with one or more of the time-bounded events in the manner discussed above.

In FIG. 6C, while the user interface 620 is displayed on the touch screen 504, the electronic device 500 detects a selection of the first selectable option 622a. For example, as shown in FIG. 6C, the electronic device 500 detects a tap of contact 603 on a location of the touch screen 504 that corresponds to the first selectable option 622a. In some embodiments, in response to detecting the selection of the first selectable option 622a, the electronic device 500 associates the findable item Frank's Suitcase with the flight (e.g., Flight 822) identified by the representation of the digital boarding pass for the user.

In some embodiments, associating a findable item with a time-bounded event includes providing an entity associated with the time-bounded event access to location information of the findable item. For example, in FIG. 6C, when the electronic device 500 associates the findable item Frank's Suitcase with the user's upcoming flight (e.g., Flight 822), the electronic device 500 shares (e.g., directly or via a server (e.g., a wireless communications terminal)) location information of the findable item Frank's Suitcase with an entity (e.g., an airline or other organization) that is facilitating and/or fulfilling the upcoming flight. In some embodiments, when the location information is shared, the entity has access to the location information (e.g., a current location of Frank's Suitcase) for a respective duration. In some embodiments, the respective duration corresponds to the duration of time-bounded event (e.g., the duration of the user's flight, such as from takeoff to landing). In some embodiments, the respective duration corresponds to a duration between when the user is no longer with the findable item (e.g., when the findable item is more than a threshold distance, such as 0.1, 0.5, 1, 5, 10, or 100 meters, from the current location of the electronic device 500) and when the user is reunited with the findable item (e.g., when the findable item is within the threshold distance from the current location of the electronic device 500). For example, the airline has access to the current location of the findable item Frank's Suitcase from when the user (e.g., Frank) checks in the suitcase (the physical item with which the remote locator object is attached) at baggage drop to when the user picks up the suitcase from baggage claim at the user's destination (e.g., destination airport) and/or when the user leaves the destination with the suitcase.

Additionally or alternatively, in some embodiments, the user is able to associate a findable item with a time-bounded event that is associated with an entity via a wallet application that is operating on the electronic device. In some embodiments, as similarly described above, while the electronic device 500 is displaying a home screen user interface (e.g., of FIG. 4A) that includes a plurality of icons corresponding to applications configured to be run on the electronic device 500, the user selects a respective icon to launch the wallet application. In some embodiments, as shown in FIG. 6F, when the wallet application is launched, the electronic device displays a user interface 640 of the wallet application on the touch screen 504. In some embodiments, the wallet application is configured to store digital credit or debit cards, boarding passes, health or insurance cards, and the like that are readily accessible by the user. Accordingly, as shown in FIG. 6F, the user interface 640 of the wallet application optionally includes a representation of a first digital boarding pass 642a, a representation of a second digital boarding pass 642b, a representation of a first credit card 642c, and/or a representation of a first rewards/loyalty card 642d.

In some embodiments, a representation of a respective digital boarding pass is selectable to initiate a process to associate a respective findable item with a respective time-bounded event associated with the respective digital boarding pass. For example, as shown in FIG. 6F, the electronic device 500 detects, via a tap of contact 603, a selection directed to the representation of the second digital boarding pass 642b in the user interface 640. In some embodiments, second digital boarding pass 642b corresponds to the digital boarding pass of FIG. 6C described above. In some embodiments, in response to detecting the selection of the representation of the second digital boarding pass 642b, the electronic device 500 displays, in the user interface 640, selectable option 644 with the representation of the second digital boarding pass 642b. In some embodiments, the selectable option 644 is selectable to initiate a process for associating the time-bounded event (e.g., Flight 822) indicated by the representation of the second digital boarding pass 642b with a findable item. In some embodiments, in FIG. 6F, if the user had alternatively selected (e.g., via a tap of contact 603) the representation of the first digital boarding pass 642a, the electronic device 500 would alternatively display the selectable option 644 with the representation of the first digital boarding pass 642b that would be selectable to initiate a process for associating the time-bounded event indicated by the representation of the first digital boarding pass 642a with a findable item. In FIG. 6G, the electronic device 500 detects, via a tap of contact 603, a selection directed to the selectable option 644. In some embodiments, in response to detecting the selection of the selectable option 644, the electronic device 500 initiates a process for selecting a findable item with which to associate the flight (e.g., via the item locating application described with reference to FIG. 6A or a similar application) optionally if the findable item discussed above (e.g., Frank's Suitcase) has not previously been selected.

Additionally or alternatively, in some embodiments, the user is able to associate a findable item with a time-bounded event that is associated with an entity via an application associated with the entity. In some embodiments, while the electronic device 500 is displaying the home screen user interface that includes the plurality of icons corresponding to applications configured to be run on the electronic device 500 (e.g., as similarly discussed above), the user selects a respective icon to launch the application associated with the entity (e.g., the airline application). In some embodiments, as shown in FIG. 6H, when the application associated with the entity is launched, the electronic device displays user interface 650 of the application (e.g., the airline application) on the touch screen 504. In some embodiments, as shown in FIG. 6H, the user interface 650 includes first region 652 (e.g., under My Flights) that is displaying information corresponding to the upcoming time-bounded event (e.g., the user's upcoming flight, such as Flight 822). In some embodiments, as shown in FIG. 6H, the first region 652 also includes selectable option 654 that is selectable to initiate a process for confirming participation in the time-bounded event (e.g., checking in for the user's upcoming flight). Additionally, as shown in FIG. 6H, in some embodiments, the user interface 650 includes second region 656 that includes a plurality of selectable options (e.g., tabs) for interacting with the application associated with the entity.

In FIG. 6H, while displaying the user interface 650, the electronic device 500 detects a selection, via a tap of contact 603, directed to the selectable option 654 in the first region 652. In some embodiments, as shown in FIG. 6I, in response to detecting the selection of the selectable option 654, the electronic device 500 initiates a process for checking in for the user's upcoming flight, including displaying user interface 660. In some embodiments, user interface 660 is a management user interface for the time-bounded event (e.g., Flight 822). As shown in FIG. 6I, in some embodiments, the user interface 660 includes one or more options for managing the time-bounded event. For example, in FIG. 6I, the user interface 660 includes a first option 662 that is selectable to initiate a process for requesting a seat change for the flight and a second option 664 that is selectable to initiate a process for requesting a seat upgrade for the flight. Additionally, in some embodiments, the user interface 660 includes selectable option 666 that is selectable to initiate a process for associating the time-bounded event (e.g., Flight 822) with a findable item. In some embodiments, in FIG. 6H, if the user had alternatively provided input (e.g., via a tap of contact 603) for checking in for an alternative flight, the electronic device 500 would alternatively display a management user interface for that alternative flight, which would include selectable option 666 that would be selectable to initiate a process for associating the alternative flight with a findable item. In FIG. 6I, the electronic device 500 detects, via a tap of contact 603, a selection directed to the selectable option 666 in the user interface 660. In some embodiments, in response to detecting the selection of the selectable option 666, the electronic device 500 initiates a process for selecting a findable item with which to associate the flight (e.g., via the item locating application described with reference to FIG. 6A or a similar application) optionally if the findable item (e.g., Frank's Suitcase) described above has not previously been selected.

In some embodiments, after the findable item Frank's Suitcase has been associated with the flight (e.g., Flight 822) indicated in FIG. 6C and the location information for the findable item is shared with the entity (e.g., the airline), the electronic device 500 updates the user interface 612 associated with the findable item Frank's Suitcase based on the association with the flight. For example, as shown in FIG. 6D, when the user interface 612 is redisplayed on the touch screen 504, the region 616 is updated to include information/indication 626 (e.g., a link) indicating that the findable item Frank's Suitcase is associated with Flight 822 and the location information for the findable item is thus shared with the airline of Flight 822 (as discussed above with reference to FIG. 6C). It should be understood that, in some embodiments, if the findable item Frank's Suitcase is associated with additional time-bounded events (e.g., additional flights, train rides, or bus rides), the region 616 would be updated to include indications (e.g., similar to the indication 626) for those additional time-bounded events.

Additionally, in some embodiments, as shown in FIG. 6D, the electronic device 500 updates the user interface 612 to include information 630 corresponding to a status of the findable item Frank's Suitcase relative to the time-bounded event (e.g., the flight). For example, in FIG. 6D, the information 630 indicates, via status indicator 628 (e.g., Completed or Pending), one or more updates for the findable item during the flight, such as that the findable item has been dropped off at the baggage drop off (at 630a), the findable item has been processed to the luggage depot (at 630b), the findable item has been processed for transporting to the airplane (630c), and the findable item is in the process of being loaded onto the airplane (630d). In some embodiments, the information 630 including the status indicators 628 are updated by the electronic device 500 based on (e.g., real-time or periodic) status information received from the entity (e.g., the airline). For example, the airline provides the electronic device 500 with the status updates for the findable item Frank's Suitcase based on a tracking of the location of the findable item (e.g., throughout the airport). Additionally or alternatively, the status updates are optionally provided (e.g., by way of notification or other indication) on a lock screen user interface of the electronic device 500, such as the lock screen user interface of FIG. 6E. Accordingly, by the above-described user-device interactions, the user is able to follow along with the processing and loading of the findable item Frank's Suitcase onto the airplane, and thus to help provide the user with peace of mind as the user's item(s) are transported to the user's destination.

In some embodiments, in FIG. 6D, the indication 626 is selectable to display information corresponding to the time-bounded event. For example, the indication is or includes a link that is selectable to display live (e.g., real-time) status information for the user's upcoming flight (e.g., via the wallet application discussed above and/or the application of the entity discussed above). In FIG. 6D, the electronic device 500 detects a selection directed to the indication 626 in the user interface 612. For example, as shown in FIG. 6D, the electronic device 500 detects a tap of contact 603 on the touch screen 504 over a location of the indication 626.

In some embodiments, in response to detecting the selection of the indication 626, the electronic device 500 displays live status information for the upcoming time-bounded event (e.g., the user's upcoming flight). In some embodiments, the electronic device 500 displays the live status information in the wallet application of the electronic device 500. For example, with reference to FIG. 6F, in response to detecting the selection of the indication 626 in FIG. 6D, the electronic device 500 displays the user interface 640 of the wallet application described previously above, which includes the digital boarding pass 642b that is displaying the live status information of the user's upcoming flight (such as Flight 822 discussed above). Alternatively, in some embodiments, the electronic device 500 displays the live status information in the application that is associated with the entity (e.g., the airline application). For example, with reference to FIG. 6H, in response to detecting the selection of the indication 626 in FIG. 6D, the electronic device 500 displays the user interface 650 of the airline application described previously above, which includes region 652 that is displaying the live status information of the user's upcoming flight (e.g., Flight 822).

In some embodiments, the above-described processes may be initiated by way of suggestion by the electronic device 500. For example, in FIG. 6E, while the electronic device 500 is displaying a lock screen user interface on the touch screen 504, the electronic device 500 generates a notification 634 prompting the user to associate one or more findable items with a particular (e.g., upcoming) time-bounded event, such as the time-bounded event indicated by indication 636. As similarly described above, the electronic device 500 optionally suggests the time-bounded event based on known (e.g., stored) information for the time-bounded event, such as based on a digital boarding pass for a flight that the user has downloaded and saved to the electronic device 500 or a calendar event for a flight that the user has generated or added to a calendar application of the electronic device 500. In some such embodiments, when the known time-bounded event approaches (e.g., the time-bounded event is scheduled to occur within the next day, weck, two weeks, or month), the electronic device 500 generates the notification 634 that includes a message suggesting associating one or more findable items with the known time-bounded event (e.g., flight). In some embodiments, if the electronic device 500 detects a selection (e.g., via contact 603 discussed above) directed to the notification 634, the electronic device 500 launches the item locating application and displays the user interface 602 of FIG. 6A, enabling the user to associate one or more findable items with the upcoming flight in a similar manner as described above.

It should be understood that, in some embodiments, the above-described approach of associating the findable item Frank's Suitcase with the time-bounded event may be similarly applied for one or more of the other findable items owned by the users (e.g., the findable items represented in FIG. 6A) and/or for other time-bounded events (e.g., train rides, bus rides, and/or rideshare events.

FIGS. 7A-7E are flow diagrams illustrating a method 700 of sharing location information of a remote locator object with an entity for a duration associated with a time-bounded event, in accordance with some embodiments, such as in FIGS. 6A-6I. The method 700 is optionally performed at an electronic device such as device 100, device 300, device 500 as described above with reference to FIGS. 1A-1B, 2-3, 4A-4B and 5A-5H. Some operations in method 700 are, optionally combined and/or the order of some operations is, optionally, changed.

As described below, the method 700 provides ways to share location information of a remote locator object with an entity. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device (e.g., electronic device 500) in communication with a display generation component and one or more input devices (e.g., touch screen 504). For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the electronic device is in communication with a trackable object, and the trackable object is a remote locator object having one or more wireless antenna, as discussed in more detail below. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.

In some embodiments, while displaying, via the display generation component, a user interface (e.g., user interface 612 in FIG. 6B) associated with a trackable object (e.g., Frank's Suitcase in FIG. 6B) that is associated with the electronic device, the electronic device receives (702a), via the one or more input devices, a first input corresponding to a request to associate the trackable object with a time-bounded event (e.g., a flight as indicated in FIG. 6B), such as selection (e.g., via a tap of contact 603) of selectable option 613 as shown in FIG. 6B. In some embodiments, the trackable object is a remote locator object with a battery, one or more wireless antenna and a processor that enables the remote locator object to function as a remote locator object when associated with another physical object associated with the user other than the user of the electronic device (e.g., wallet, purse, backpack, suitcase, car, or a set of keys). In some embodiments, the trackable object is configured to transmit location data of the trackable object to the electronic device (e.g., wirelessly, such as over Bluetooth, RF, IR, NFC, or Wi-Fi). In some embodiments, the trackable object is associated with a name or label that is identifiable on an electronic device (e.g., the electronic device of the user associated with (e.g., owning) the trackable object). In some embodiments, the trackable object is configured to be fixed, clipped, attached, and/or coupled to a physical object (e.g., a personal item, such as a bag, purse, luggage, keychain, suitcase, briefcase, backpack, and/or wallet bag) belonging to or associated with the user of the electronic device. In some embodiments, while the first selectable option is displayed, the user is or is going to be participating in the time-bounded event. For example, the time-bounded event is a travel event, such as a flight, bus ride, train ride, taxi ride, or other ridesharing event, that has a designated (e.g., predetermined) beginning and end (e.g., start of the travel and end of the travel). In some embodiments, the time-bounded event is associated with an entity (e.g., an organization, agency, company, or business) that is providing, organizing, sponsoring, or otherwise facilitating the time-bounded event. In some embodiments, the entity is a trusted entity that is a member of a network of entities with which location sharing capabilities are allowed and/or enabled for the electronic device. In some embodiments, the user interface associated with the trackable object is a user interface of an item locating application. For example, the item locating application is an application that displays one or more representations of one or more findable items (including the trackable object) and/or users along with indications of the locations of the one or more findable items and/or users. In some embodiments, the user opens the item locating application to view one or more items, such as the trackable object, that the user owns or has gained access to via invitation. In some embodiments, the user selects one or more of the items to locate, and in response, the item locating application optionally displays to the user an indication of the location of the selected one or more items (e.g., on a map) along with the first selectable option. In some embodiments, the user interface associated with the trackable object is a user interface associated with the entity associated with the time-bounded event. For example, the user interface is displayed in an application owned and/or operated by the entity and that is displayed and accessible via the electronic device. In some embodiments, the trackable object is fixed to (e.g., attached to) and/or associated with the personal item discussed above when the first input is detected. In some embodiments, the user interface associated with the trackable object includes a first selectable option for associating the trackable object with the time-bounded event. In some embodiments, the first input corresponds to a selection of the first selectable option. In some embodiments, the first input includes a click, push, press, swipe, or the like detected, for example, via a touch-sensitive surface, a stylus, a keyboard or a mouse, that is directed to the first selectable option. In some embodiments, as described below, selection of the first selectable option initiates a process for sharing the location of the trackable object, and thus the item (e.g., a personal item) with which the trackable object is associated, for a duration of the time-bounded event.

In some embodiments, in response to receiving the first input, the electronic device initiates (702b) a process to share information corresponding to a location of the trackable object with an entity (e.g., an airline as indicated in FIG. 6C) associated with the time-bounded event, such as displaying user interface 620 that includes selectable option 622a as shown in FIG. 6C, wherein the information corresponding to the location of the trackable object is shared with the entity for a respective duration (e.g., a predetermined duration that is defined without user input) associated with the time-bounded event. For example, the location of the trackable object is a physical location of the trackable object within a physical environment (e.g., the physical environment surrounding the user of the electronic device). In some embodiments, sharing information corresponding to the location of the trackable object with the entity includes enabling the entity (e.g., users associated with the entity, such as employees of the entity) to gain access to the location of the trackable object, and thus the personal item to which the trackable object is attached. In some embodiments, the information is shared by the electronic device directly or by a server (e.g., a wireless communications terminal) that is in communication with the electronic device. In some embodiments, the entity has access to the location of the trackable object for a respective duration associated with the time-bounded event. For example, the entity has access to the location of the trackable object for a duration of the time-bounded event, such as from the beginning of the time-bounded event to the end of the time-bounded event (e.g., from a beginning of a flight to an end of the flight), and after the end of the time-bounded event no longer has access to the location of the trackable object (e.g., without the need for user input to stop such access). In some embodiments, the entity has access to the location of the trackable object starting from when the location of the user (e.g., the location of the electronic device) is no longer near (e.g., within a threshold distance of, such as 0.1, 0.2, 0.5, 0.8, 1, 1.2, 1.5, 2, 5, 10, 20 or 40 m of) the location of the trackable object, and loses access to the location of the trackable object when the location of the user is within the threshold distance of the location of the trackable object. In some embodiments, the duration that the entity has access to the location of the trackable object is based on the current location of the trackable object (e.g., and optionally irrespective of the location of the user (e.g., the location of the electronic device)). For example, the entity has access to the location of the trackable object starting from when the current location of the trackable object corresponds to a location associated with the time-bounded event (e.g., when the trackable object is at an airport, train station, bus stop, and/or rideshare loading zone), and loses access to the location of the trackable object when the location of the trackable object is near the location of the user (e.g., within the threshold distance discussed above). In some embodiments, as outlined above, the start time for when the entity has access to the location of the trackable object is not necessarily when the first input is received (e.g., a beginning of the respective duration is independent of when the first input is received). In some embodiments, while the entity has access to the location of the trackable object, the electronic device receives updates (e.g., periodically or continuously) regarding the location of the trackable object (e.g., because the trackable object is no longer with the user). For example, the electronic device displays an indication (e.g., a visual indication such as a user interface element or notification) that includes updates regarding the location of the trackable object during the time-bounded event (e.g., during a flight, the indication notifies the user that the trackable object, and thus the personal item, has been loaded as cargo). In some embodiments, the entity has access to the location of the trackable object without having access to the current location of the user (and the location of the electronic device). In some embodiments, sharing access to the location of the trackable object (or a different trackable object) with an entity, in the manner outlined above, that is associated with a second (e.g., different) time-bounded event results in sharing the location of the trackable object with the entity for a duration that is different from the respective duration discussed above (e.g., because a duration of the second time-bounded event is different from the time-bounded event described above). Sharing access to a location of a trackable object that is owned by a user with an entity that is associated with a time-bounded event enables the user to efficiently track the location of the trackable object during the time-bounded event, without requiring the user to manually define a start and an end of the location sharing for time-bounded events of varying durations, and which also provides an indication of a location of a physical item with which the trackable object is attached, thereby improving user-device interaction and enabling a user or a delegated entity to more quickly and accurately determine the location of the physical item.

In some embodiments, the user interface associated with the trackable object includes a first selectable option (e.g., selectable option 613 in FIG. 6B) that is selectable for requesting associating the trackable object with the time-bounded event (704a). In some embodiments, the first input includes selection of the first selectable option (704b) (e.g., as similarly described above with reference to steps 702a-702b), such as via a tap of contact 603 as shown in FIG. 6B. Sharing access to a location of a trackable object that is owned by a user with an entity that is associated with a time-bounded event enables the user to efficiently track the location of the trackable object during the time-bounded event, without requiring the user to manually define a start and an end of the location sharing for time-bounded events of varying durations, and which also provides an indication of a location of a physical item with which the trackable object is attached, thereby improving user-device interaction and enabling a user or a delegated entity to more quickly and accurately determine the location of the physical item.

In some embodiments, the entity associated with the time-bounded event is an organization (e.g., an airline as indicated in FIG. 6C) associated with the time-bounded event (706) (e.g., as similarly described above with reference to steps 702a-702b). Sharing access to a location of a trackable object that is owned by a user with an organization that is associated with a time-bounded event enables the user to efficiently track the location of the trackable object during the time-bounded event, without requiring the user to manually define a start and an end of the location sharing for time-bounded events of varying durations, and which also provides an indication of a location of a physical item with which the trackable object is attached, thereby improving user-device interaction and enabling a user or a delegated organization to more quickly and accurately determine the location of the physical item.

In some embodiments, the user interface associated with the trackable object is a management user interface for the trackable object, such as user interface 612 in FIG. 6B, wherein the management user interface is a user interface of an item locating application (708), such as the item locating application described with reference to FIG. 6A). For example, the management user interface for the trackable object includes information corresponding to the trackable object, such as an identifier of the trackable object (e.g., name, title, and/or label optionally designated by the user), a location of the trackable object (e.g., a current location or a last detected location of the trackable object), and/or a graphical representation (e.g., an image or rendering) of the trackable object (e.g., displayed at a location on a map corresponding to the last detected location for the trackable object). In some embodiments, the management user interface includes one or more options for managing the trackable object, including a selectable option that is selectable for requesting associating the trackable object with the time-bounded event, as similarly described above with reference to steps 702a-702b, a selectable option for causing the trackable object to emit audio, and/or a selectable option for initiating a mode for finding the trackable object (e.g., such as described with reference to method 900). Sharing access to a location of a trackable object that is owned by a user with an entity that is associated with a time-bounded event via a user interface for the trackable object enables the user to efficiently track the location of the trackable object during the time-bounded event, without requiring the user to manually define a start and an end of the location sharing for time-bounded events of varying durations, and which also provides an indication of a location of a physical item with which the trackable object is attached, thereby improving user-device interaction and enabling a user or a delegated entity to more quickly and accurately determine the location of the physical item.

In some embodiments, the item locating application provides for management of a plurality of trackable objects (e.g., findable items indicated in list 608 in FIG. 6A) including the trackable object (710) (e.g., findable item indicated by item 610b in FIG. 6A). For example, as similarly described above with reference to steps 702a-702b, the item locating application provides for tracking locations of a plurality of trackable objects owned by or shared with the user of the electronic device. In some embodiments, the item locating application is configured to display a management user interface for each of the plurality of trackable objects (e.g., such as the management user interface described above with reference to step 708). In some embodiments, as similarly described above with reference to steps 702a-702b, the item locating application is configured to display a map that includes a plurality of representations of the plurality of trackable objects. For example, the electronic device displays an icon or other representation including a graphic corresponding to a findable item at a location on the map that corresponds to the location of the findable item in the physical environment surrounding the user (and the electronic device). Sharing access to a location of a trackable object that is owned by a user with an entity that is associated with a time-bounded event enables the user to efficiently track the location of the trackable object during the time-bounded event, without requiring the user to manually define a start and an end of the location sharing for time-bounded events of varying durations, and which also provides an indication of a location of a physical item with which the trackable object is attached, thereby improving user-device interaction and enabling a user or a delegated entity to more quickly and accurately determine the location of the physical item.

In some embodiments, initiating the process to share information corresponding to the location of the trackable object with the entity associated with the time-bounded event includes (712a) displaying, via the display generation component, information corresponding to one or more respective future time-bounded events, such as display of digital boarding pass in user interface 620 as shown in FIG. 6C, including the time-bounded event (712b). For example, the electronic device displays information corresponding to the time-bounded event with which the trackable object is associated in the management user interface. In some embodiments, the information corresponding to the one or more respective time-bounded events includes one or more representations of one or more digital passes (e.g., digital tickets, digital boarding passes, digital passports, and/or digital identification cards that have been stored or identified previously on the electronic device) for providing the user with access/entry to the one or more respective time-bounded events. In some embodiments, the information corresponding to the one or more respective time-bounded events includes a name/title of the one or more respective time-bounded events (e.g., a flight name or number), the entity associated with the one or more respective time-bounded events (e.g., airline name), and/or a time associated with the one or more respective time-bounded events (e.g., a start time and/or end time for the flight). Displaying information corresponding to a time-bounded event after sharing access to a location of a trackable object that is owned by a user with an entity that is associated with the time-bounded event facilitates discovery that the entity has access to the location of the trackable object and facilitates casy selection of the time-bounded event for accessing information corresponding to the time-bounded event, thereby improving user-device interaction and enabling a user or a delegated entity to more quickly and accurately determine the location of the physical item.

In some embodiments, after sharing the information corresponding to the location of the trackable object with the entity associated with the time-bounded event, the electronic device displays (714), via the display generation component, an indication that the trackable object is associated with the time-bounded event in the management user interface, such as indication 626 in user interface 612 as shown in FIG. 6D. For example, the electronic device displays an indication that includes a name or other identifying information of the time-bounded event that the trackable object is associated with and/or the entity associated with the time-bounded event (e.g., a flight name or number and/or airline). In some embodiments, the indication is selectable to initiate display of live (e.g., real-time or most up to date) status information for the time-bounded event. For example, selection of the indication causes the electronic device to display a user interface of a virtual wallet application (e.g., described below with reference to step 720) or a user interface of an application of the entity associated with the time-bounded event (e.g., described below with reference to step 718) that includes information regarding the status of the time-bounded event (e.g., if the flight is on-time, delayed, or cancelled and/or if there are gate/terminal changes for the flight). Displaying an indication that a location of a trackable object that is owned by a user has been shared with an entity that is associated with a time-bounded event facilitates discovery that the entity has access to the location of the trackable object and enables the user to efficiently track the location of the trackable object during the time-bounded event, as well as access status updates for the time-bounded event, thereby improving user-device interaction and enabling a user or a delegated entity to more quickly and accurately determine the location of the physical item.

In some embodiments, the user interface associated with the trackable object is a management user interface for the time-bounded event (716), such as user interface 650 in FIG. 6H. For example, the management user interface for the time-bounded event includes information corresponding to the time-bounded event, such as an identifier of the time-bounded event (e.g., name or title, such as a flight name or number), information corresponding to the entity associated with the time-bounded event (e.g., a name of the airline providing and/or facilitating the flight in which the use is or will be participating), and/or a representation (e.g., an image or preview of) of a digital pass (e.g., boarding pass or ticket) for the time-bounded event. In some embodiments, the management user interface includes one or more options for managing the time-bounded event (e.g., including an option for checking in/confirming participation in the time-bounded event), including a selectable option that is selectable to for requesting associating the trackable object with the time-bounded event, as similarly described above with reference to steps 702a-702b. Sharing access to a location of a trackable object that is owned by a user with an entity that is associated with a time-bounded event via a user interface for the time-bounded event enables the user to efficiently share the location of the trackable object during the time-bounded event, without requiring the user to manually define a start and an end of the location sharing for time-bounded events of varying durations, thereby improving user-device interaction and enabling a user or a delegated entity to more quickly and accurately determine the location of the physical item.

In some embodiments, the management user interface for the time-bounded event is a user interface of an application associated with the entity (718) (e.g., as similarly described above with reference to steps 702a-702b), such as an airline application as described with reference to FIG. 6H. Sharing access to a location of a trackable object that is owned by a user with an entity that is associated with a time-bounded event via a user interface for the time-bounded event enables the user to efficiently share the location of the trackable object during the time-bounded event, without requiring the user to manually define a start and an end of the location sharing for time-bounded events of varying durations, thereby improving user-device interaction and enabling a user or a delegated entity to more quickly and accurately determine the location of the physical item.

In some embodiments, the management user interface for the time-bounded event is a user interface of a virtual wallet application configured to store digital passes, such as user interface 640 in FIG. 6F, including a digital pass associated with the time-bounded event (720) (e.g., representation of digital boarding pass 642b in FIG. 6F). For example, the virtual wallet application is configured to store digital boarding passes/tickets, digital credit and/or debit cards, digital insurance cards, digital rewards/loyalty cards, and/or digital health cards owned by or otherwise accessible to the user. In some embodiments, the virtual wallet application is configured to display representations of the digital passes, including a representation of the digital pass associated with the time-bounded event (e.g., a representation of the digital boarding pass for the user's upcoming flight that is scannable (e.g., via a code, NFC authenticator, or other image authenticator) to grant the user access to the flight) in the management user interface. In some embodiments, the representations of the digital passes are configured to be used for a variety of additional purposes, such as purchasing goods or items, tracking and/or storing reward points, and/or tracking and/or storing user health information. Sharing access to a location of a trackable object that is owned by a user with an entity that is associated with a time-bounded event via a user interface of a virtual wallet application enables the user to efficiently share the location of the trackable object during the time-bounded event, without requiring the user to manually define a start and an end of the location sharing for time-bounded events of varying durations, thereby improving user-device interaction and enabling a user or a delegated entity to more quickly and accurately determine the location of the physical item.

In some embodiments, the first input includes input directed to a system alert of the electronic device that is displayed via the display generation component (722), such as selection (e.g., via a tap of contact 603) of alert 634 as shown in FIG. 6E. For example, the system alert is a notification or similar element that is generated automatically by the electronic device for suggesting association of the trackable object (or additional or alternative trackable objects) with the time-bounded event. In some embodiments, the electronic device displays the system alert on a lock screen user interface of the electronic device (e.g., if the electronic device is in a locked/sleep state). In some embodiments, the electronic device displays the system alert in a predefined region of the display generation component (e.g., in a notification center of the electronic device, optionally while a home screen user interface is displayed via the display generation component). In some embodiments, the electronic device generates and displays the system alert in accordance with a determination that the time-bounded event is upcoming (e.g., is scheduled to occur within the next day, week, and/or month) and the user is going to be participating in the time-bounded event. For example, the user has added or created a calendar event for the time-bounded event in a calendar application of the electronic device and/or has added a digital pass for the time-bounded event to the virtual wallet application described above with reference to step 720. Generating a system alert to suggest sharing of access to a location of a trackable object that is owned by a user with an entity that is associated with a time-bounded event reduces the number of inputs needed to share the access and/or enables the user to efficiently share the location of the trackable object during the time-bounded event, without requiring the user to manually define a start and an end of the location sharing for time-bounded events of varying durations, thereby improving user-device interaction and enabling a user or a delegated entity to more quickly and accurately determine the location of the physical item.

In some embodiments, a beginning of the respective duration associated with the time-bounded event is determined based on a beginning of the time-bounded event (724), such as a beginning of Flight 822 as described with reference to FIG. 6D. For example, the entity is granted access to the location of the trackable object for tracking the trackable object when the time-bounded event begins (e.g., based on a scheduled start time, an actual start time of the time-bounded event as updated live by the entity, or a predetermined amount of time (e.g., 5, 10, 15, 20, 30, 45, 60, 75, 90, or 120 minutes before the time-bounded event is scheduled to start), as similarly described above with reference to steps 702a-702b. Sharing access to a location of a trackable object that is owned by a user with an entity that is associated with a time-bounded event based on when the time-bounded event begins enables the user to efficiently share the location of the trackable object during the time-bounded event, without requiring the user to manually define a start of the location sharing for the time-bounded event, thereby improving user-device interaction and enabling a user or a delegated entity to more quickly and accurately determine the location of the physical item.

In some embodiments, a beginning of the respective duration associated with the time-bounded event is determined based on a current location of the electronic device (726), such as electronic device 500 being located at Los Angeles International Airport as described with reference to FIG. 6D. For example, the entity is granted access to the location of the trackable object for tracking the trackable object when the electronic device (and thus the user) is located at or within a threshold distance of (e.g., 0.1, 0.2, 0.5, 0.8, 1, 1.2, 1.5, 2, 5, 10, 20, 40, 100, 300, 500 or 1000 m) a location associated with the time-bounded event (e.g., a location at which the time-bounded event is scheduled to occur, such as the airport for a scheduled flight), as similarly described above with reference to steps 702a-702b. Sharing access to a location of a trackable object that is owned by a user with an entity that is associated with a time-bounded event based on the location of the user enables the user to efficiently share the location of the trackable object during the time-bounded event, without requiring the user to manually define a start of the location sharing for the time-bounded event, thereby improving user-device interaction and enabling a user or a delegated entity to more quickly and accurately determine the location of the physical item.

In some embodiments, a beginning of the respective duration associated with the time-bounded event is determined based on detection that the location of the trackable object is more than a threshold distance (e.g., 0.1, 0.2, 0.5, 0.8, 1, 1.2, 1.5, 2, 5, 10, 20, 40, 100, 300, 500 or 1000 m) from a current location of the electronic device (728), such as electronic device 500 being more than the threshold distance from Frank's Suitcase as described with reference to FIG. 6D. For example, the entity is granted access to the location of the trackable object for tracking the trackable object when the electronic device detects that the trackable object is no longer located at or near the current location of the electronic device (and thus the user), as similarly described above with reference to steps 702a-702b. In some embodiments, the separation of the trackable object from the electronic device (and the user) occurs when the user drops off and/or checks in the personal item to which the trackable object is attached to the entity for the time-bounded event (e.g., baggage check at the airport before the user's flight or other travel). Sharing access to a location of a trackable object that is owned by a user with an entity that is associated with a time-bounded event when the trackable object is no longer with the user enables the user to efficiently share the location of the trackable object during the time-bounded event, without requiring the user to manually define a start of the location sharing for the time-bounded event, thereby improving user-device interaction and enabling a user or a delegated entity to more quickly and accurately determine the location of the physical item.

In some embodiments, an end of the respective duration associated with the time-bounded event is determined based on an anticipated end of the time-bounded event (730), such as an end of Flight 822 as described with reference to FIG. 6D. For example, the entity no longer has access to the location of the trackable object for tracking the trackable object when the time-bounded event ends or after a predetermined amount of time (e.g., 5, 10, 15, 20, 30, 45, 60, 75, 90, or 120 minutes) after the time-bounded event ends (e.g., based on a scheduled end time or an actual end time of the time-bounded event as updated live by the entity), as similarly described above with reference to steps 702a-702b. In some embodiments, in accordance with a determination that an end time of the time-bounded event is a first end time, the end of the respective duration is a second end time. In some embodiments, in accordance with a determination that the end time for the time-bounded event is a third end time, different from the first end time, the end of the respective duration is a fourth end time, different from the second end time. Sharing access to a location of a trackable object that is owned by a user with an entity that is associated with a time-bounded event until the time-bounded event ends enables the user to efficiently share the location of the trackable object during the time-bounded event, without requiring the user to manually define an end of the location sharing for the time-bounded event, thereby improving user-device interaction and enabling a user or a delegated entity to more quickly and accurately determine the location of the physical item.

In some embodiments, an end of the respective duration associated with the time-bounded event is determined based on detection that the location of the trackable object is within a threshold distance (e.g., 0.1, 0.2, 0.5, 0.8, 1, 1.2, 1.5, 2, 5, 10, 20 or 40 m) of a current location of the electronic device (732), such as the electronic device 500 being within the threshold distance of Frank's Suitcase as described with reference to FIG. 6D. For example, the entity no longer has access to the location of the trackable object for tracking the trackable object when the electronic device detects (e.g., after the time-bounded event has ended (e.g., determined based on an actual or anticipated end time of the time-bounded event) or independent of whether the time-bounded event has ended) that the trackable object is located at or near the current location of the electronic device (and thus the user), as similarly described above with reference to steps 702a-702b. In some embodiments, the threshold distance is less than, equal to, or greater than the separation distance described above with reference to step 728. In some embodiments, the trackable object is reunited with the electronic device (and the user) when the user retrieves the personal item to which the trackable object is attached from the entity after the time-bounded event (e.g., baggage claim at the airport after the user's flight). In some embodiments, in accordance with a determination that the trackable object is not within the threshold distance of the current location of the electronic device, the trackable object remains associated with the time-bounded event associated with the entity. In some embodiments, in accordance with a determination that the location of the trackable object is a first location that is within the threshold distance of the current location of the electronic device, the electronic device determines that the time-bounded event has ended. In some embodiments, in accordance with a determination that the location of the trackable object is a second location that is not within the threshold distance of the current location of the electronic device, the electronic device determines that the time-bounded event has not ended. Sharing access to a location of a trackable object that is owned by a user with an entity that is associated with a time-bounded event until the trackable object is located with the user enables the user to efficiently share the location of the trackable object during the time-bounded event, without requiring the user to manually define an end of the location sharing for the time-bounded event, thereby improving user-device interaction and enabling a user or a delegated entity to more quickly and accurately determine the location of the physical item.

In some embodiments, before receiving the first input, a current location of the trackable object is updated at the electronic device at a first frequency (734a) (e.g., location of Frank's Suitcase being updated in user interface 602 of FIG. 6A at the first frequency). For example, before the location of the trackable object is shared with entity, the electronic device (or a server in communication with the electronic device) tracks and updates the location of the trackable object every 5, 10, 20, 30, 45, 60, 75, 90, or 120 minutes. In some embodiments, the trackable object is reporting its location at the first frequency before receiving the first input. In some embodiments, information corresponding to the location of the trackable object is reported at the first frequency within a user interface of the item locating application described above with reference to steps 702a-702b.

In some embodiments, while sharing the information corresponding to the location of the trackable object with the entity associated with the time-bounded event, the current location of the trackable object is updated at the electronic device at a second frequency, greater than the first frequency (734b) (e.g., location of Frank's Suitcase being updated via status indicator 628 in user interface 612 of FIG. 6D at the second frequency). For example, after receiving the first input and while the entity has access to the location of the trackable object, the electronic device (or a server in communication with the electronic device) tracks and updates the location of the trackable object every 30 seconds, 1, 2, 3, 5, 10, 15, 20, 30, 40, or 60 minutes. In some embodiments, the trackable object updates its operation to report its location at the second frequency to enable its location to be tracked by the electronic device and/or the entity at the second frequency. In some embodiments, the information corresponding to the location of the trackable object is reported at the second frequency within the user interface of the item locating application as similarly discussed above and/or to the entity (e.g., to an electronic device operated by a user associated with the entity). Tracking a location of a trackable object that is owned by a user at a respective frequency after the location of the trackable object is shared with an entity that is associated with a time-bounded enables the user to efficiently track the location of the trackable object during the time-bounded event, and provides an indication of a location of a physical item with which the trackable object is attached, thereby improving user-device interaction and enabling a user or a delegated entity to more quickly and accurately determine the location of the physical item.

In some embodiments, while sharing the information corresponding to the location of the trackable object with the entity associated with the time-bounded event, the electronic device displays (736a), via the display generation component, information corresponding to a status of the trackable object relative to the time-bounded event (e.g., in the user interface associated with the trackable object or on a lock screen user interface of the electronic device), such as information 630 including status indicator 628 as shown in FIG. 6D, wherein the information is determined based on a current location of the trackable object (736b) (e.g., tracked by the electronic device and/or by the entity and/or by the server based on object-locating features of the trackable object, such as described in more detail with reference to method 900), and tracking updates for the trackable object provided by the entity (736c) (to the electronic device and optionally independent of the current location information reported by the trackable object). For example, the information corresponding to the status of the trackable object indicates the location of the trackable object and/or a state of the trackable object relative to the time-bounded event. As an example, if the time-bounded event is a flight that the user is participating in, while the location of the trackable object is shared with the entity, the information corresponding to the status of the trackable object indicates the status of the personal item to which the trackable object is attached in being loaded onto the airplane in cargo (e.g., the personal item has been dropped off at baggage check, the personal item has been processed to the luggage depot, and/or the personal item has been transported to the airplane for loading into cargo). In some embodiments, the information includes an indication of a time of the status update, such as a time at which the personal item was dropped off at baggage check at the airport. In some embodiments, the tracking updates for the trackable object are provided by the entity periodically (e.g., based on a progress of loading the personal item onto the airplane). In some embodiments, the entity provides such status information (e.g., checked-in, processed at luggage depot, or on airplane information) based on the location of the trackable object corresponding to the locations for those status designations (e.g., the location of the check-in counters, the location of the luggage depot, or the location of the airplane). Displaying status updates for a trackable object that is owned by a user while a location of the trackable object is shared with an entity that is associated with a time-bounded event enables the user to efficiently track the location of the trackable object during the time-bounded event and/or reduces the number of inputs needed to access status updates for the trackable object, thereby improving user-device interaction and enabling a user or a delegated entity to more quickly and accurately determine the location of the physical item.

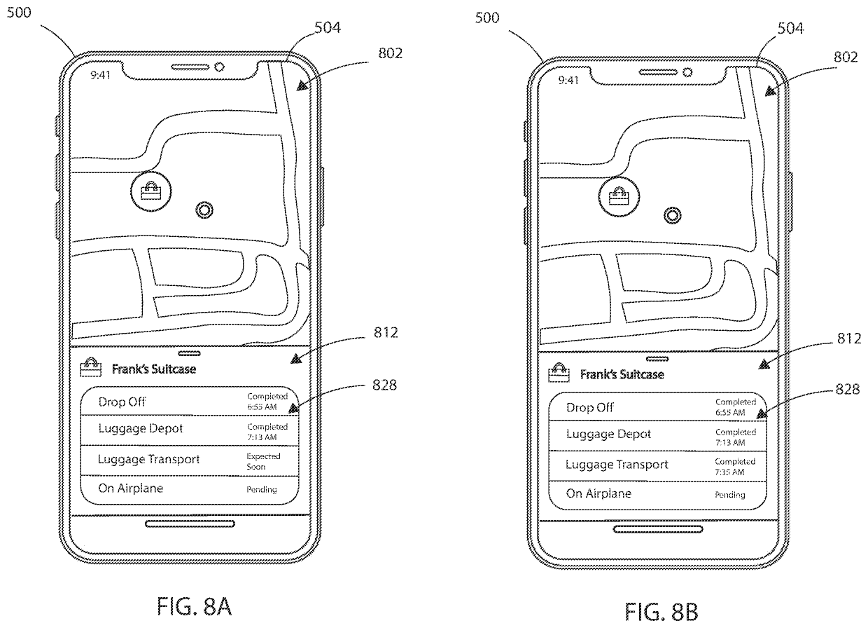

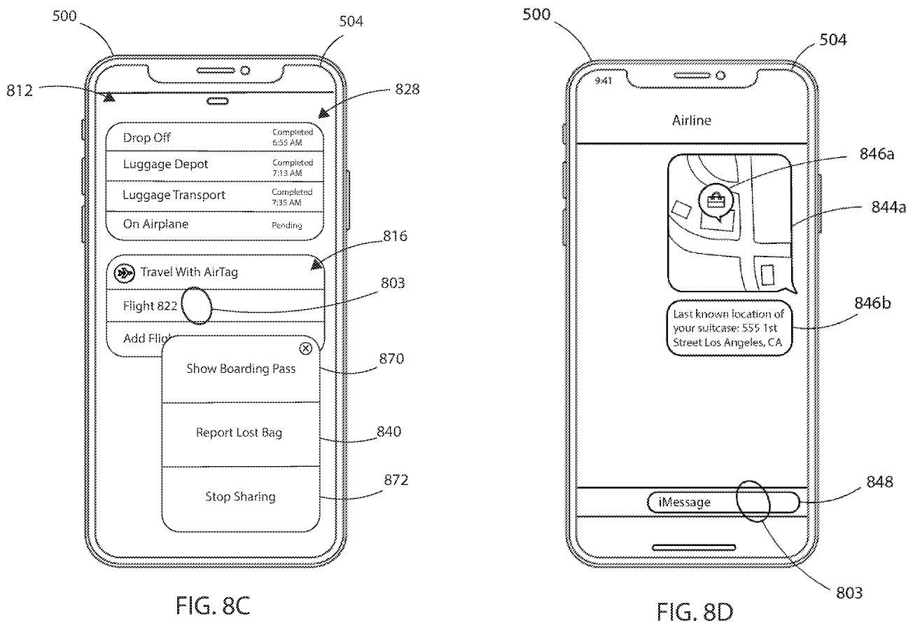

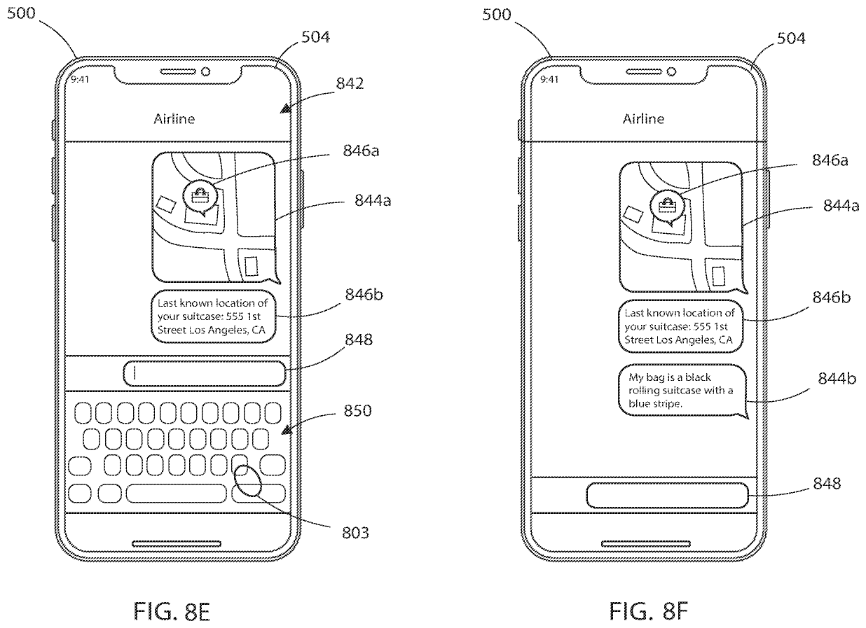

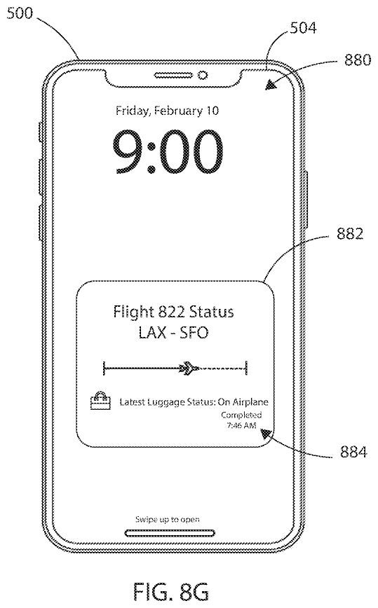

In some embodiments, initiating the process to share information corresponding to the location of the trackable object with the entity associated with the time-bounded event includes initiating a process to grant permission to the entity to access one or more features of the trackable object for enabling locating the trackable object based on signals transmitted by the trackable object (738) (e.g., as described with reference to FIGS. 8A-8F below). For example, when the location of the trackable object is shared with the entity, the electronic device grants permission to a location reporting feature, a sound generation feature, and/or proximity finding feature of the trackable object that enable the entity (e.g., one or more users associated with the entity) to locate the personal item to which the trackable object is attached. In some embodiments, the one or more features of the trackable object for enabling locating the trackable object have one or more characteristics of the one or more features of the trackable object described with reference to method 900. Granting access to one or more features of a trackable object that is owned by a user with an entity enables persons associated with the entity to efficiently track the location of the trackable object for locating the trackable object if the trackable object is reported as lost and/or alerts the entity that the trackable object has been lost, which reduces the need for user input to manually provide object-locating information to the entity and also provides an indication of a status of a recovery of the trackable object, thereby improving user-device interaction and reducing user concern regarding the location of the lost trackable object.

It should be understood that the particular order in which the operations in FIGS. 7A-7E have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900 and/or 1100) are also applicable in an analogous manner to method 700 described above with respect to FIGS. 7A-7E. For example, findable items, sharing access to locations of findable items with entities, displaying item locating applications, displaying user interfaces associated with findable items, and displaying user interfaces associated with entities described above with reference to method 700 optionally have one or more of the characteristics of remote locator objects, sharing access to one or more features of findable items, displaying item locating applications, displaying user interfaces associated with findable items, displaying status updates related to findable items, and displaying user interfaces associated with entities described herein with reference to other methods described herein (e.g., methods 900 and/or 1100). For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIGS. 7A-7E are, optionally, implemented by components depicted in FIGS. 1A-1B. For example, receiving operations 702a and displaying operations 702a, 714, and 736a are, optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Reporting of Lost Item Associated with a Remote Locator Object

Users interact with electronic devices in many different manners. In some embodiments, an electronic device is able to track the location of a trackable object such as a remote locator object. In some embodiments, access to such remote locator objects can be shared by an owner of the remote locator object with an entity (e.g., one or more persons associated with the entity) for a duration of time that is associated with a time-bounded event. The embodiments described below provide ways in which an electronic device reports a remote locator object as lost to an entity, including providing the entity with permission to access one or more finding features of the remote locator object for locating the remote locator object, thus enhancing the user's interactions with the electronic device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

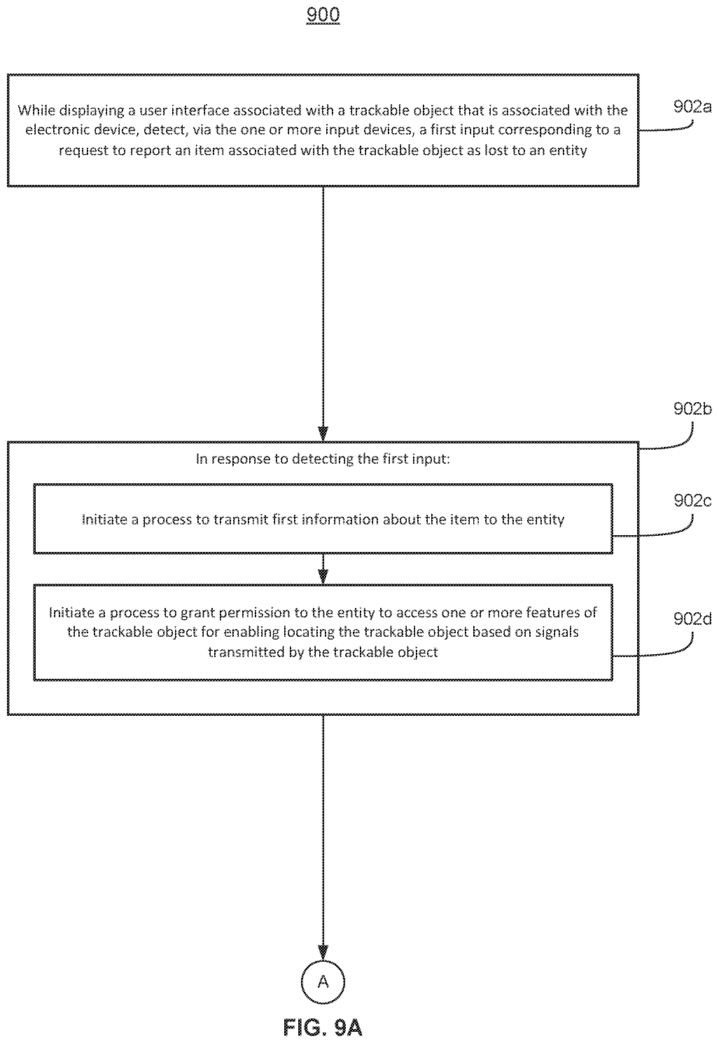

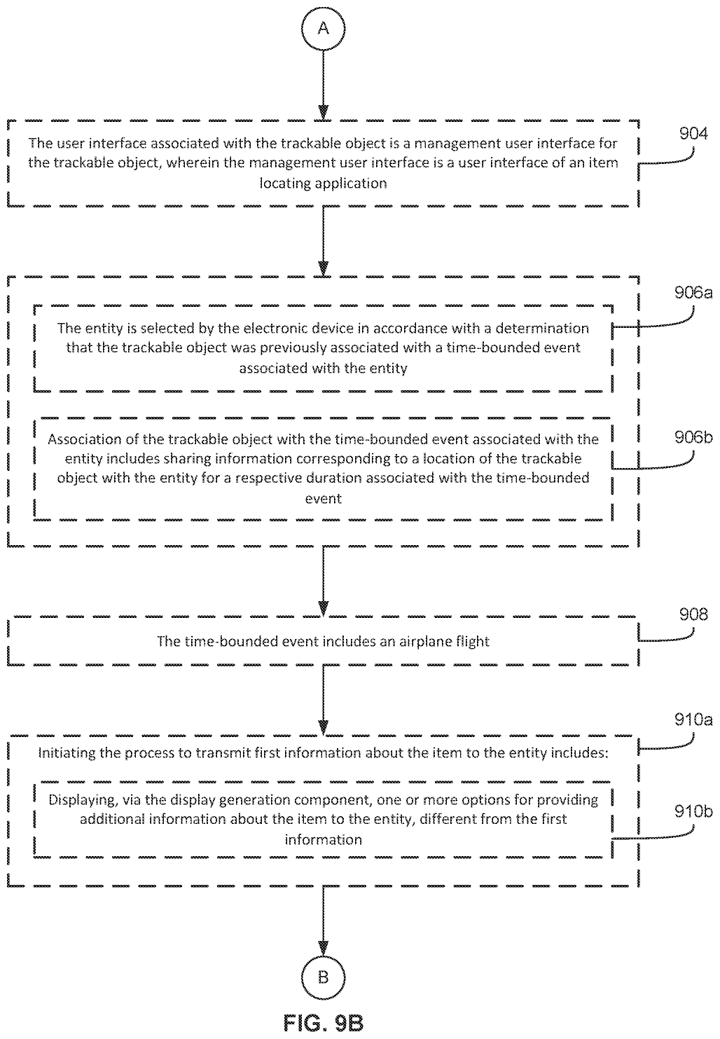

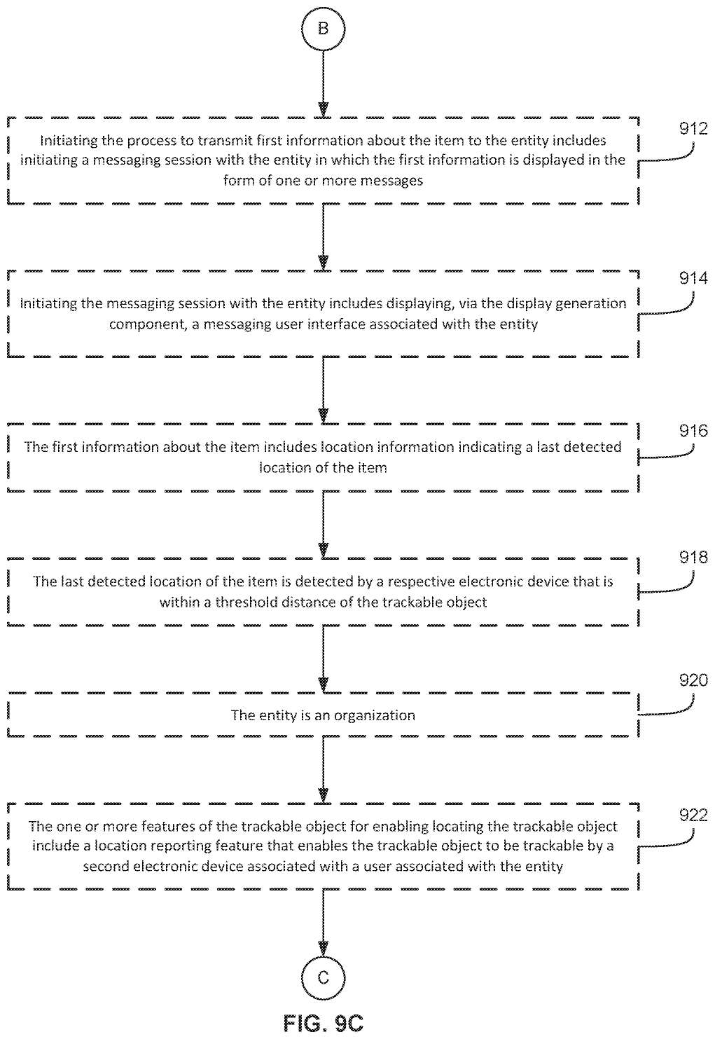

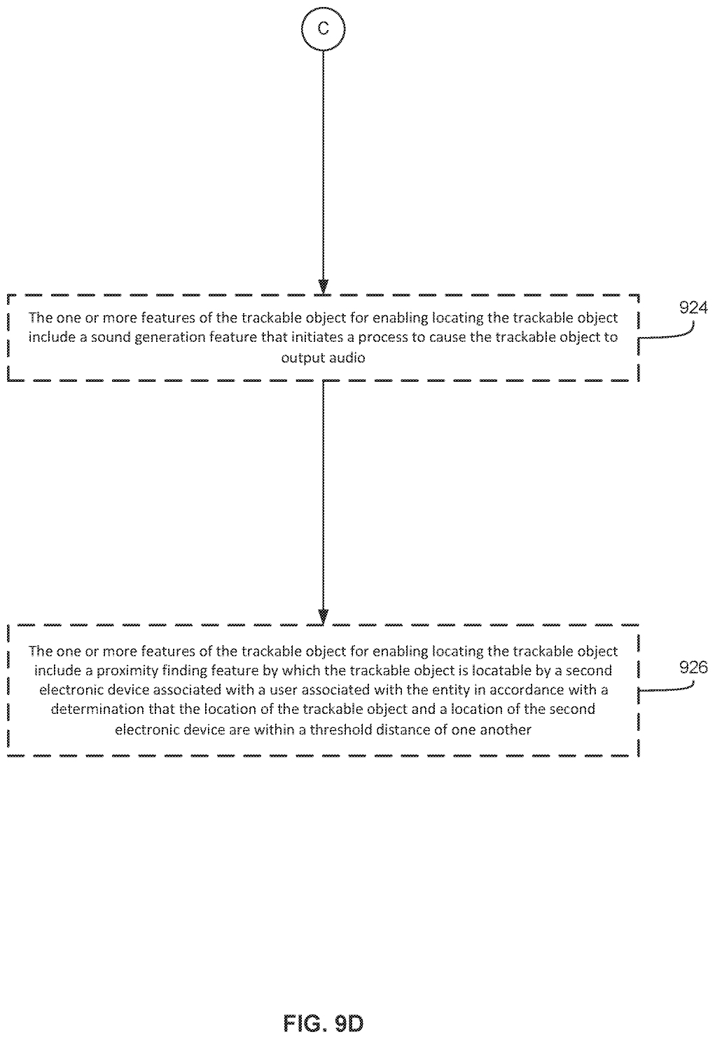

FIGS. 8A-8G illustrate exemplary ways in which an electronic device facilitates reporting of an item associated with a remote locator object as lost to an entity for aiding in the recovery of the item, in accordance with some embodiments of the disclosure. The embodiments in these figures are used to illustrate the processes described below, including the processes described with reference to FIGS. 9A-9D.

FIGS. 8A-8G illustrate an electronic device 500 associated with a user, including touch screen 504 displaying one or more aspects of reporting an item associated with a remote locator object as lost to an entity. In FIG. 8A, electronic device 500 represents a mobile electronic device belonging to a user. Furthermore, and as shown in FIG. 8A, electronic device 500 displays a user interface 802 of an item locating application operating on the electronic device 500. In some embodiments, the user interface 802 corresponds to user interface 602 described previously with reference to FIGS. 6A-6I. It should be understood that, as described below, the location of the electronic device 500 and the location of the user of the electronic device 500 are referred to herein interchangeably.

As shown in FIG. 8A, in some embodiments, the user interface 802 of the item locating application includes a representation of a map of a physical region surrounding and/or including the location of the user and/or the electronic device 500. In some embodiments, as described previously with reference to FIG. 6A above, the map indicates the location of the user and/or the electronic device 500 as a circle, the locations of findable items (e.g., personal items, such as a bag, suitcase, headphones, and the like, that are associated with a remote locator object (e.g., the remote locator object is attached to the personal item)) owned by the user, such as a representation of a first findable item Frank's Suitcase (icon 806) at a location on the map corresponding to the location of Frank's Suitcase in the physical region, and/or locations of additional users that share their location with the user (e.g., Frank). As shown in the example of FIG. 8A, no additional users are currently sharing their locations with Frank and thus, no additional user is displayed on the map in the user interface 802. As shown in FIG. 8A, and as noted above, the representation 806 indicate the corresponding findable item (e.g., a graphic of the corresponding findable item) such that the user (e.g., Frank) can visually identify the findable item on the map of the user interface 802.

In some embodiments, the first findable item (e.g., Frank's Suitcase) is associated with a time-bounded event (e.g., a travel event) that is associated with an entity (e.g., an organizer or provider of the time-bounded event), as similarly described above with reference to FIGS. 6A-6I. In the example of FIGS. 8A-8G, the time-bounded event is a flight (e.g., Flight 822, as indicated in FIG. 8C) that the user is participating or has participated in (e.g., the flight is ongoing, or the flight has ended and/or the user has arrived at the flight destination). Additionally, in some embodiments, while the first findable item (e.g., Frank's Suitcase) is associated with the time-bounded event (e.g., Flight 822), as described previously with reference to FIGS. 6A-6I, the entity (e.g., the airline) is granted access to location information for the first findable item for a respective duration associated with the time-bounded event.

In some embodiments, as shown in FIG. 8A, the user interface 802 further includes region 812 that is associated with the first findable item (e.g., Frank's Suitcase). As shown in FIG. 8A and as previously described above with reference to FIGS. 6A-6I, because the first findable item is associated with a time-bounded event, the region 812 of the user interface 802 includes information corresponding to a status of the first findable item relative to the time-bounded event (e.g., the flight). For example, in FIG. 8A, the information indicates, via status indicator 828, one or more updates for the first findable item during the flight, such as that the findable item has been dropped off at the baggage drop off at 6:55 AM, the first findable item has been processed to the luggage depot at 7:13 AM, the first findable item is expected to be processed for transporting to the airplane soon (e.g., within the next hour, half hour, 15 minutes, 10 minutes, or 5 minutes), and the first findable item has not yet been loaded onto the airplane. In some embodiments, the information including the status indicators 828 is updated by the electronic device 500 based on (e.g., real-time or periodic) status information received from the entity (e.g., the airline). For example, as shown in FIG. 8B, the status indicator 828 for Luggage Transport is updated from Expected Soon in FIG. 8A to Completed at 7:35 AM indicating that the findable item has been processed for transportation to the airplane (and thus the first findable item is in the process of being loaded onto the airplane). In some embodiments, the airline provides the electronic device 500 with the status updates for the first findable item based on a tracking of the location of the first findable item (e.g., during the flight). In some embodiments, if multiple findable items are concurrently associated with the time-bounded event (e.g., the flight) discussed above, the user interface 802 would include regions (e.g., similar to region 812) for the other findable items, which would each include information corresponding to a status of each findable item relative to the time-bounded event as similarly discussed above.

Additionally or alternatively, in some embodiments, the information corresponding to the status of the first findable item relative to the time-bounded event (e.g., the flight) is provided on a lock screen user interface of the electronic device 500. For example, as shown in FIG. 8G, while the electronic device 500 is displaying lock screen user interface 880 on the touch screen 504, the information corresponding to the status of the first findable item is presented as lock screen element 882 associated with the time-bounded event (e.g., Flight 882). As shown in FIG. 8G, the lock screen element 882 optionally includes status indicator 884 that provides a most recent or up-to-date status of the first findable item relative to the flight. For example, the status indicator 884 indicates that the first findable item has been successfully loaded onto the airplane at 7:48 AM. Additionally, as shown in FIG. 8G, in some embodiments, the lock screen element 882 includes a status of the time-bounded event (e.g., a live flight status, bounded by the flight start and end times), optionally provided in the form of a dynamic progress bar/bubble (e.g., the bar/bubble gradually progresses from left to right in accordance with a progression of the flight). In some embodiments, as similarly described above, the information corresponding to the status of the first findable item within the lock screen element 882 is updated by the electronic device 500 based on (e.g., real-time or periodic) status information received from the entity (e.g., the airline). In some embodiments, if multiple findable items (e.g., including the first findable item) are concurrently associated with the time-bounded event (or other time-bounded events), the electronic device 500 would display multiple lock screen elements (e.g., similar to lock screen element 882) associated with the time-bounded event(s) including information similar to that shown in FIG. 8G and discussed above for the multiple findable items.

In FIG. 8C, in response to a scroll or selection input directed to the region 812 in the user interface 802 of FIGS. 8A-8B, for example, the electronic device 500 displays an expanded view of the region 812 that is associated with the first findable item. In some embodiments, the region/user interface 812 displays additional information regarding the first findable item and provides for managing the first findable item. In some embodiments, the region/user interface 812 corresponds to user interface 612 described above with reference to FIGS. 6A-6I (e.g., user interface 812 is a partial view, including additional elements, of the user interface 612 described above).

In some embodiments, as shown in FIG. 8A and as similarly described above with reference to FIGS. 6A-6I, because the first findable item is associated with the time-bounded event (e.g., the flight) discussed above, the user interface 812 includes indication 816 that indicates the first findable item is associated with the time-bounded event (e.g., Flight 822). Additionally, as shown in FIG. 8C, the information including the status indicators 828 has optionally been updated by the electronic device 500 as similarly discussed above. For example, in FIG. 8C, the status indicator 828 for On Airplane is updated from Pending in FIG. 8B to Completed indicating that the findable item has been successfully loaded onto the airplane.

With reference to FIG. 8C, the time-bounded event has optionally concluded, and the user has attempted to retrieve the first findable item (e.g., the user has departed the plane and has gone to baggage claim to retrieve the personal item to which the remote locator object is attached). However, the user is optionally unable to locate and retrieve the first findable item despite confirmation in the user interface 812 (e.g., indication of Completed for On Airplane) that the first findable item made the trip to the destination (e.g., was successfully loaded onto the airplane). For example, the first findable item (e.g., Frank's Suitcase) is not at an expected pickup/retrieval location (e.g., baggage claim at the destination airport). Accordingly, in such an instance, it may be desirable to provide functionality to report the first findable item as lost or missing to the entity (e.g., the airline) that was responsible for transporting the first findable item during and offloading the first findable item at the conclusion of the time-bounded event (e.g., the flight).

As previously mentioned above, the user interface 812 provides for managing the first findable item. As shown in FIG. 8C, in response to a selection (e.g., tap, press, or click) or hover (e.g., tap and hold) by contact 803 directed to the indication 816, the electronic device 500 optionally displays a menu (e.g., a pop-up menu) overlaid over or below the indication 816 in the user interface 812. In some embodiments, as shown in FIG. 8C, the menu includes a plurality of selectable options for managing the time-bounded event (e.g., Flight 822). For example, in FIG. 8C, the menu includes a first option 870 that is selectable to display a digital boarding pass for the flight (e.g., as similarly discussed previously with reference to FIGS. 6A-6I), a second option 840 that is selectable to initiate a request to report the first findable item as lost to the entity (e.g., the airline), and a third option 872 that is selectable to disassociate the first findable item from the time-bounded event (e.g., revoke access for the entity to location information of the first findable item). In FIG. 8C, while displaying the menu in the user interface 812, the electronic device 500 detects a selection directed to the second option 840. For example, as shown in FIG. 8A, the electronic device 500 detects a tap of contact 803 on a location of the touch screen 504 that corresponds to the second option 840. In some embodiments, the electronic device 500 detects a click, tap, slide, and/or hover input on the touch screen 504.

In some embodiments, as shown in FIG. 8D, in response to detecting selection of the second option 840, the electronic device 500 transmits (e.g., directly or via a server (e.g., a wireless communications terminal) in communication with the electronic device 500) a request to report the first findable item as lost to the entity. In some embodiments, as shown in FIG. 8D, the electronic device 500 transmits the request to the entity via a messaging user interface 842. For example, as shown in FIG. 8D, the electronic device 500 replaces display of the user interface 812 and displays a messaging user interface 842 for initiating a messaging session with the entity (e.g., “Airline”). In some embodiments, the messaging user interface 842 is associated with a messaging application of the electronic device 500. For example, the messaging user interface 842 of FIG. 8D is a text messaging user interface (or similar user interface) of a system messaging application of the electronic device 500 via which the user is able to communicate with the entity (e.g., the airline), optionally transmitting messages to a contact phone number or email associated with the airline (e.g., that is known by the electronic device 500). Alternatively, in some embodiments, the messaging user interface 842 is associated with an application of the entity (e.g., an airline application) operating on the electronic device 500 (or running in a web-browsing application of the electronic device 500). For example, in response to detecting the selection of the selectable option 840, the electronic device 500 launches the application of the airline and displays the messaging user interface 842 (e.g., a chat or help line user interface of the entity application) of FIG. 8B that enables the user to communicate directly with the airline.

In some embodiments, as shown in FIG. 8D, when the messaging user interface 842 is displayed on the touch screen 504, the electronic device 500 transmits (e.g., directly or via a server (e.g., a wireless communications terminal) in communication with the electronic device 500) a request to report the first findable item as lost to the entity. In some embodiments, as shown in FIG. 8D, transmitting the request includes transmitting information regarding a last known location of the first findable item to the entity. For example, as shown in FIG. 8D, the electronic device 500 (e.g., automatically) transmits one or more messages via the messaging user interface 842 that include information corresponding to the last known location of the first findable item, such as a first message 844a that includes geographical information (e.g., GPS-enabled information) of the last known location of the first findable item represented by icon 846a (e.g., overlaid on a portion of a map). In some embodiments, the geographical information of the last known location of the first findable item is accessed and provided by the electronic device 500 using the item locating application described previously above with reference to FIGS. 6A-6I. In some embodiments, the geographical information of the last known location of the first findable item is accessed and provided by the entity (e.g., based on access to the location of the first findable item that was shared by the user). Additionally or alternatively, as shown in FIG. 8D, the information corresponding to the last known location of the first findable item optionally is transmitted via a second message 846b that includes an address of the last known location of the first findable item (e.g., as reported by the electronic device 500 or the entity as similarly discussed above).

In some embodiments, while the messaging session is active between the user and the entity (e.g., while the messaging user interface 842 of FIG. 8D is displayed), the user is able to provide (e.g., manually, by sending text messages that include additional information entered by the user) additional details regarding one or more characteristics/features of the findable item for helping the entity identify the first findable item. For example, in FIG. 8D, while the messaging user interface 842 is displayed, the electronic device 500 detects, via a tap of contact 803 on the touch screen 504, an input directed to text-entry field 848 of the messaging user interface 842.

In some embodiments, as shown in FIG. 8E, in response to detecting selection of the text-entry field 848, the electronic device 500 displays a (e.g., digital) keyboard 850 including a plurality of selectable keys in the messaging user interface 842. For example, as shown in FIG. 8E, the electronic device 500 shifts the text-entry field 848 upward in the messaging user interface 842 and displays the keyboard 850 below the text-entry field 848. In the example of FIG. 8E, the user of the electronic device 500 is able to provide additional details regarding one or more characteristics/features of the first findable item by composing (e.g., via the selectable keys of the keyboard 850) and transmitting a message to the entity in the messaging user interface 842. In FIG. 8E, while the keyboard 850 is displayed in the messaging user interface 842, the electronic device 500 detects a series of one or more inputs directed to the keyboard 850 for composing a message that includes details regarding one or more characteristics/features of the first findable item, such as an appearance (e.g., color, shape, pattern, and/or size) of the first findable item, a brand of the first findable item, a type of the first findable item, and/or adornments associated with the first findable item (e.g., keychains, charms, ribbons, stickers, and/or labels attached to the first findable item). As similarly discussed above, the electronic device 500 optionally detects the series of one or more inputs via a series of one or more taps of contact 803 on the touch screen 504 directed to one or more keys of the keyboard 850.

In some embodiments, after the message that includes additional details regarding one or more characteristics/features of the first findable item is composed, the user transmits the message to the entity via the messaging user interface 842, as shown in FIG. 8F. For example, the user selects a “send” option that is displayed in the messaging user interface 842 (e.g., in the text-entry field 848 or the keyboard 850) after the message has been composed. In some embodiments, as shown in FIG. 8F, after the message is transmitted to the entity (e.g., the airline), the electronic device 500 displays the message 844b in the messaging user interface 842. As discussed above, the content (e.g., text) in the message 844b describing visual characteristics (e.g., appearance, such as color and pattern) of the first findable item optionally helps the airline (e.g., one or more employees of the airline) identify the findable item for returning the first findable item back to the user.

In some embodiments, when the request to report the first findable item as lost to the entity is transmitted by the electronic device 500, the electronic device 500 initiates a process to grant permission to the entity to access one or more features of the trackable object that is associated with the lost item. For example, as discussed above, the first findable item (e.g., Frank's Suitcase) comprises a physical object/item (e.g., a suitcase) and a trackable object (e.g., a remote locator object) that is attached to (e.g., fixed to, clipped to, tied to, and/or buckled to) the physical object/item. Accordingly, when the request to report the first findable item as lost to the entity is transmitted by the electronic device 500, the electronic device 500 optionally permits the airline to access one or more features of the trackable object attached to the lost item for enabling locating the lost item.

In some embodiments, granting permission to the entity to access one or more features of the trackable object that is associated with the lost item includes sharing location information of the trackable object with the entity. In some embodiments, the entity does not have access to the location information of the trackable object when the request to report the first findable item as lost is transmitted. In some embodiments, the entity previously had access to the location information of the trackable object (e.g., because the trackable object was associated with a time-bounded event), but the entity lost access to the location information of the trackable object because a respective duration associated with the time-bounded event concluded (e.g., the flight on which the user travelled had ended), as previously described above with reference to FIGS. 6A-6I). In some embodiments, when the electronic device 500 grants the entity access to the location information of the trackable object, the entity (e.g., one or more employees of the airline) is able to track a location of the trackable object (e.g., using a second electronic device) for locating and retrieving the lost item.

In some embodiments, granting permission to the entity to access one or more features of the trackable object that is associated with the lost item includes enabling the entity (e.g., one or more users associated with the entity) to access a sound generation feature of the trackable object. In some embodiments the sound generation feature initiates a process to cause the trackable object to output audio. For example, when an employee or other user that is associated with the airline utilizes the sound generation feature, the trackable object outputs, via a speaker of the trackable object, a ring, tune, chime, song, or other sound that enables the employee or other user to locate the trackable object for retrieving the lost item.

In some embodiments, granting permission to the entity to access one or more features of the trackable object that is associated with the lost item includes enabling the entity (e.g., one or more users associated with the entity) to access a proximity locating feature of the trackable object. In some embodiments, the proximity locating feature enables the location of the trackable object to become viewable to one or more second electronic devices (e.g., devices associated with one or more users associated with the entity) in accordance with a determination that the location of the trackable object and locations of the one or more second electronic devices are within a threshold distance (e.g., 1, 2, 5, 10, 15, 20, 40, 50, 100, or 200 m) of one another. In some embodiments, while a second electronic device is within the threshold distance of the trackable object, the second electronic device displays (e.g., via a display generation component of the second electronic device) a visual indication (e.g., an arrow) that is configured to point in a direction of the trackable object relative to the location of the second electronic device. For example, while the proximity finding feature is enabled, the user of the second electronic device may travel in the direction that the visual indication is pointing to locate and retrieve the first findable item.

In some embodiments, the entity is able to provide updates regarding a status of locating and/or retrieving the first findable item via the messaging session between the user and the entity. For example, the entity (e.g., a person associated with the entity) provides the updates in the form of one or more messages (e.g., similar to messages 846/844) via the messaging user interface 842 of FIGS. 8D-8F. In some embodiments, the updates include an indication of whether the findable item has been located, where the findable item was located, an estimated time for returning the findable item to the user, and other indications related to the status of locating and/or retrieving the first findable item. In some embodiments, after the item is located and retrieved by the entity, the electronic device 500 (or a server in communication with the electronic device 500) revokes the access to the one or more features of the trackable object described above. In some embodiments, the access to the one or more features of the trackable object are revoked from the entity after a predetermined amount of time (e.g., 5, 10, 15, 20, 30, 45, 60, 75, 90, 120, or 180 minutes) elapses after the item is located and retrieved by the entity.

FIGS. 9A-9D are flow diagrams illustrating a method 900 of facilitating reporting of an item associated with a remote locator object as lost to an entity for aiding in the recovery of the item, in accordance with some embodiments of the disclosure, such as in FIGS. 8A-8G. The method 900 is optionally performed at an electronic device such as device 100, device 300, device 500 as described above with reference to FIGS. 1A-1B, 2-3, 4A-4B and 5A-5H. Some operations in method 900 are, optionally combined and/or order of some operations is, optionally, changed.

As described below, the method 900 provides ways of reporting of an item as lost to an entity. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed at an electronic device (e.g., electronic device 500) in communication with a display generation component (e.g., touch screen display 504) and one or more input devices. For example, the electronic device is a mobile device (e.g., a tablet, a smartphone, a media player, or a wearable device) including a touch screen and wireless communication circuitry, or a computer including one or more of a keyboard, mouse, trackpad, and touch screen and wireless communication circuitry. In some embodiments, the electronic device is in communication with a trackable object, and the trackable object has one or more characteristics of the trackable object in method 700. In some embodiments, the display generation component has one or more characteristics of the display generation component in method 700. In some embodiments, the one or more input devices have one or more characteristics of the one or more input devices in method 700.

In some embodiments, while displaying a user interface (e.g., user interface 812 in FIG. 8C) associated with a trackable object (e.g., Frank's Suitcase as indicated in FIG. 8A) that is associated with the electronic device, the electronic device detects (902a), via the one or more input devices, a first input (e.g., via a tap of contact 803 directed to option 840 in FIG. 8C) corresponding to a request to report an item (e.g., a physical object) associated with the trackable object as lost to an entity (e.g., an organization or business, as similarly described with reference to method 700), such as an airline as described with reference to FIG. 8A. In some embodiments, the user interface is an item finding user interface as similarly described with reference to method 700. In some embodiments, the user interface is a user interface of an application associated with the entity, as similarly described with reference to method 700. In some embodiments, the trackable object is associated with (e.g., attached to) the item, such as attached to a bag, backpack, suitcase, purse, wallet bag, or other personal item belonging to or otherwise associated with a user of the electronic device (e.g., and optionally the owner of the trackable object). In some embodiments, the user provides the first input at a conclusion of and/or after the end of a time-bounded event (e.g., a travel event), such as the time-bounded events described with reference to method 700. For example, at the conclusion of and/or after the time-bounded event (e.g., at the end of a flight, train ride, bus ride, or taxi ride), the user of the electronic device (e.g., and the owner of the item) discovers that the item cannot be found (e.g., the item is not at the baggage terminal that the item should be at). Additionally or alternatively, the user of the electronic device optionally discovers that the item has been lost based on a location of the trackable object (e.g., that is accessible to the user, such as via the item finding user interface discussed above). For example, the electronic device indicates, in the item finding user interface, that the trackable object and thus the item are located at a location that is different from the current location of the user and/or an expected location (e.g., and is optionally a location that the user cannot reach). In some embodiments, the item became lost while the item (and the trackable object attached to the item) was in the care of the entity. For example, the item became lost and/or unaccounted for during the time-bounded event for which the entity is responsible. In some embodiments, the first input includes selection of a selectable option for reporting the item as lost to the entity, wherein the selectable option is displayed in the user interface associated with the trackable object. For example, the first input includes a click, push, press, swipe, or the like detected, for example, via a touch-sensitive surface, a stylus, a keyboard or a mouse, that is directed to the selectable option. In some embodiments, the first input has one or more characteristics of inputs described with reference to method 700.

In some embodiments, in response to detecting the first input (902b), the electronic device initiates (902c) a process to transmit (e.g., from the electronic device or from a server (e.g., a wireless communications terminal) that is in communication with the electronic device) first information about the item to the entity (e.g., information that is descriptive of a physical appearance or state of the item or information that is descriptive of a recent status of the item such as a last known or last detected location), such as information in messages 846 as shown in FIG. 8D. For example, the electronic device displays, in the user interface associated with the trackable object, an asynchronous messaging user interface for communicating with (e.g., via text-based messaging) the entity. In some embodiments, the request is processed as a message in the messaging user interface. In some embodiments, in addition to or as part of the message, the electronic device transmits details of the item to the entity. For example, the first information includes details regarding an appearance (e.g., shape, color, and/or style) of the item, a size of the item, a brand of the item, and/or contents of the item, if applicable. In some embodiments, the first information includes details regarding a last known location of the trackable object (e.g., known by the electronic device via the item finding application and/or known by the user of the electronic device from memory). In some embodiments, the first information helps enable the entity (e.g., persons associated with the entity) to locate and/or identify the item. In some embodiments, the first information is provided manually by the user of the electronic device (e.g., the user, via the messaging user interface, fills/types in details corresponding to the one or more features of the item that is lost). In some embodiments, the first information was previously provided by the user and was stored in memory before the first input is detected and the first information is transmitted to the entity without the need for the user to provide the first information with the request. For example, the user provided details corresponding to the one or more features of the item when the trackable object with which the item is associated was first configured (e.g., operated and setup by the user).

In some embodiments, the electronic device initiates (902d) a process to grant permission to the entity to access one or more features of the trackable object for enabling locating the trackable object based on signals transmitted by the trackable object (e.g., to one or more nearby electronic devices that are being used to locate the trackable object or one or more nearby electronic devices that report the information to a location server that provides information about a recently detected location of the trackable object to one or more nearby electronic devices that are being used to locate the trackable object), as similarly described with reference to FIG. 8F. In some embodiments, when the item is reported as lost by the user in the manner discussed above, the entity optionally already has access to the location of the trackable object. In some embodiments, when the item is reported as lost by the user, the entity does not yet have access to the location of the trackable object. In some embodiments, if the entity has lost access to the location of the trackable object (e.g., for one of the reasons provided with reference to method 700), the entity is granted permission once again to access the location of the trackable object for locating the trackable object. In some embodiments, before the first input is detected, the entity has access to the location of the trackable object but does not have access to the one or more features of the trackable object for locating the trackable object. In some embodiments, granting permission to the entity to access one or more features of the trackable object includes allowing the entity (e.g., one or more persons associated with the entity) to cause the trackable object to emit sound (e.g., a ring, chime, or other audible sound) for locating the trackable object. In some embodiments, granting permission to the entity to access one or more features of the trackable object includes allowing the entity (e.g., one or more persons associated with the entity) to disable the trackable object (e.g., if the trackable object is unable to be located). In some embodiments, granting permission to the entity to access one or more features of the trackable object has one or more characteristics of the location sharing described with reference to method 700. In some embodiments, the electronic device revokes permission to the entity to access one or more features of the trackable object when the entity (e.g., one or more persons associated with the entity) successfully locate the trackable object and retrieve the item for returning the item to the user. For example, the revocation is performed automatically by the electronic device or in response to user input when the user receives an indication (e.g., a notification and/or message) that the item has been found. In some embodiments, the electronic device revokes permission to the entity to access the one or more features of the trackable object when the entity (e.g., one or more persons associated with the entity) are unable to locate the trackable object (and thus the item). For example, the revocation is performed automatically by the electronic device or in response to user input when the user receives an indication (e.g., a notification and/or message) that the lost item was unable to be found. Granting access to one or more features of a trackable object that is owned by a user with an entity when the trackable object is reported as lost alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user-device interaction.

In some embodiments, the user interface associated with the trackable object is a management user interface for the trackable object, such as user interface 812 in FIG. 8C, wherein the management user interface is a user interface of an item locating application (904), such as the item locating application described with reference to FIG. 8A. For example, the management user interface for the trackable object includes information corresponding to the trackable object, such as an identifier of the trackable object (e.g., name, title, and/or label optionally designated by the user), a location of the trackable object (e.g., a current location or a last detected location of the trackable object), and/or a graphical representation (e.g., an image or rendering) of the trackable object. In some embodiments, the management user interface includes one or more options for managing the trackable object, including a selectable option that is selectable for requesting to report the item associated with the trackable object as lost to the entity, as similarly described above with reference to steps 902a-902d. In some embodiments, the first input includes selection of the selectable option displayed in the management user interface. In some embodiments, the management user interface for the trackable object has one or more characteristics of the management user interface described with reference to method 700. Granting access to one or more features of a trackable object that is owned by a user with an entity when the trackable object is reported as lost via a management user interface for the trackable object alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user-device interaction.

In some embodiments, the entity is selected (e.g., automatically) by the electronic device in accordance with a determination that the trackable object was previously associated with a time-bounded event (e.g., a travel event that the user participated in and/or a travel event for which information, such as digital passes, was stored on the electronic device and/or the electronic device previously received input associating the trackable object with the time-bounded event, such as described with reference to method 700) associated with the entity (906a) (e.g., without the need for user input specifying the entity).

In some embodiments, association of the trackable object with the time-bounded event associated with the entity includes sharing information corresponding to a location of the trackable object with the entity for a respective duration associated with the time-bounded event (906b), as similarly described with reference to FIG. 8A. For example, access to location information for the trackable object has been shared with the entity, such that the trackable object is trackable by an electronic device associated with the entity. In some embodiments, associating the trackable object with the time-bounded event has one or more characteristics of associating the trackable objects with the time-bounded events in method 700. In some embodiments, if the trackable object was not previously associated with a time-bounded event associated with the entity, the electronic device provides a user interface for manually selecting the entity from a list of entities. Granting access to one or more features of a trackable object that is owned by a user with an entity when the trackable object that was previously associated with a time-bounded event is reported as lost alerts the entity that the trackable object has been lost and enables persons associated with the entity to efficiently track the location of the trackable object for locating the trackable object, which reduces the need for user input to manually provide object-locating information to the entity, which reduces the need for user input specifying the entity, thereby improving user-device interaction.

In some embodiments, the time-bounded event includes an airplane flight (908) (e.g., as similarly described above with reference to steps 902a-902d), such as Flight 822 as indicated by indication 816 in FIG. 8C. Granting access to one or more features of a trackable object that is owned by a user with an entity when the trackable object is reported as lost alerts the entity that the trackable object has been lost during an airplane flight and enables persons associated with the entity to efficiently track the location of the trackable object for locating the trackable object, which reduces the need for user input to manually provide object-locating information to the entity and also provides an indication of a status of a recovery of the trackable object, thereby improving user-device interaction.

In some embodiments, initiating the process to transmit first information about the item to the entity includes (910a) displaying, via the display generation component, one or more options for providing additional information about the item to the entity, different from the first information (910b), such as displaying keyboard 850 in messaging user interface 842 in FIG. 8E. For example, the one or more options enable the user to specify additional details about the lost item—separate from the trackable object, which is optionally attached to the item—for aiding the entity (e.g., one or more persons associated with the entity) in identifying and/or locating the lost item to which the trackable object is attached. In some embodiments, as similarly described above with reference to steps 902a-902d, the additional information about the item includes information regarding the appearance (e.g., color, shape, pattern, and/or size) of the item, brand of the item, style of the item, and/or adornments of the item (e.g., keychains, ribbons, charms, and/or other attachments). In some embodiments, the one or more options are provided by way of a messaging user interface with the entity, as described in more detail below with reference to step 912. For example, the additional information is provided via text in a message transmitted to the entity via the messaging user interface. Enabling providing additional information about an item to which a trackable object that is owned by a user is attached to an entity when the trackable object is reported as lost helps enable persons associated with the entity to efficiently locate and identify the item when locating the trackable object, thereby improving user-device interaction.

In some embodiments, initiating the process to transmit first information about the item to the entity includes initiating a (optionally asynchronous) messaging session with the entity in which the first information is displayed in the form of one or more messages (912) (e.g., messages including text), such as messages 846 and 844 in FIGS. 8D-8F. In some embodiments, the messaging session is initiated with the entity via a messaging application of the electronic device (e.g., a system messaging application or another messaging application operating on the electronic device). For example, the one or more messages that are displayed are transmitted to a contact phone number or email of the entity via the messaging session. In some embodiments, the messaging session is initiated with the entity via an application associated with the entity (e.g., an airline application) operating on the electronic device. In some embodiments, the one or more messages include images, video, or other content corresponding to the first information about the item. Granting access to one or more features of a trackable object that is owned by a user with an entity when the trackable object is reported as lost via a messaging session alerts the entity that the trackable object has been lost and enables persons associated with the entity to efficiently track the location of the trackable object for locating the trackable object, thereby improving user-device interaction.

In some embodiments, initiating the messaging session with the entity includes displaying, via the display generation component, a messaging user interface associated with the entity (914), such as messaging user interface 842 in FIGS. 8D-8F. For example, representations of the one or more messages are displayed in the messaging user interface. In some embodiments, the messaging user interface is displayed in the messaging application discussed above with reference to step 912. In some embodiments, the messaging user interface is displayed in the application associated with the entity discussed above with reference to step 912. For example, the messaging user interface is a chat or help line user interface for communicating directly with the entity within the application associated with the entity. In some embodiments, the messaging user interface is a user interface of a messaging application via which messaging conversations with non-entities (e.g., contacts of the user of the electronic device) are also conducted. Granting access to one or more features of a trackable object that is owned by a user with an entity when the trackable object is reported as lost via a messaging session alerts the entity that the trackable object has been lost and enables persons associated with the entity to efficiently track the location of the trackable object for locating the trackable object, thereby improving user-device interaction.

In some embodiments, the first information about the item includes location information indicating a last detected (e.g., known) location of the item (916) (e.g., as indicated in messages 844a and 846b in FIG. 8D). For example, the electronic device transmits geographical information (e.g., GPS information) of the last detected location of the item (e.g., specifically the trackable location) to the entity. In some embodiments, the location information indicating the last detected location of the item includes an address of the last detected location of the item (e.g., specifically the trackable object). In some embodiments, the location information indicating the last detected location of the item is not manually generated or provided by the user. For example, the electronic device (or a server in communication with the electronic device) automatically provides and transmits the information to the entity. Providing information indicating a last detected location of an item to which a trackable object that is owned by a user is attached to an entity when the trackable object is reported as lost enables persons associated with the entity to efficiently track the location of the trackable object for locating the trackable object, which reduces the need for user input to manually provide object-locating information, thereby improving user-device interaction.

In some embodiments, the last detected location of the item is detected by a respective electronic device (optionally the same as or different from the electronic device) that is within a threshold distance (e.g., 0.1, 0.2, 0.5, 0.8, 1, 1.2, 1.5, 2, 5, 10, 20 or 40 m, or within wireless communication range such as a WiFi or Bluetooth communication range, in which the respective electronic device can communicate directly with the trackable object) of the trackable object (918), such as a respective electronic device being within the threshold distance of the location indicated by icon 846a in message 844a in FIG. 8F. For example, the respective electronic device is operated by a user associated with the entity (e.g., an agent or worker of the airline), different from the user of the electronic device. In some embodiments, the respective electronic device is another electronic device owned and/or used by the user of the electronic device (e.g., configured with the same user account as the electronic device). Providing information indicating a last detected location of an item to which a trackable object that is owned by a user is attached to an entity when the trackable object is reported as lost enables persons associated with the entity to efficiently track the location of the trackable object for locating the trackable object, which reduces the need for user input to manually provide object-locating information, thereby improving user-device interaction.

In some embodiments, the entity is an organization (920) (e.g., as similarly described above with reference to steps 902a-902d), such as an airline as described with reference to FIG. 8A. Granting access to one or more features of a trackable object that is owned by a user with an organization when the trackable object is reported as lost alerts the organization that the trackable object has been lost and enables persons associated with the organization to efficiently track the location of the trackable object for locating the trackable object, which reduces the need for user input to manually provide object-locating information to the organization and also provides an indication of a status of a recovery of the trackable object, thereby improving user-device interaction.

In some embodiments, the one or more features of the trackable object for enabling locating the trackable object include a location reporting feature that enables the trackable object to be trackable by a second electronic device associated with a user associated with the entity (922), such as an electronic device of an airline worker as similarly described with reference to FIG. 8F. For example, as similarly described above with reference to steps 902a-902d, when the request to report the item as lost to the entity is transmitted by the electronic device, location information for the trackable object is not (or is no longer being) shared with the entity (e.g., the trackable object is no longer associated with the time-bounded event (e.g., the flight) on which the item was lost/misplaced. In some embodiments, the location reporting feature enables the entity to gain or regain access to the location of the trackable object such that the trackable object is locatable/trackable by the second electronic device (e.g., an electronic device that is operated by a user (e.g., an employee) associated with the entity (e.g., an airline agent or worker)). In some embodiments, the entity has access to the location of the trackable object until the lost item is retrieved and returned to the user. For example, the access is revoked automatically based on location information of the trackable object (e.g., when the trackable object is reunited with the user) and/or manually by the user (e.g., via a management user interface for the trackable object). In some embodiments, sharing the location of the trackable object with the entity has one or more characteristics of object location sharing in method 700. Granting access to a location reporting feature of a trackable object that is owned by a user with an entity when the trackable object is reported as lost alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user-device interaction.

In some embodiments, the one or more features of the trackable object for enabling locating the trackable object include a sound generation feature that initiates a process to cause the trackable object to output audio (924), as similarly described with reference to FIG. 8F. For example, the sound generation feature enables a second electronic device (different from the electronic device) that is operated by a user associated with the entity to communicate with the trackable object and cause the trackable object to generate a sound (e.g., output audio, such as a ring, a chime, or other audio, via a speaker in communication with the remote locator object) optionally via a management user interface for the trackable object. In some embodiments, causing the trackable object to generate a sound enables the user associated with the entity to locate and/or obtain the lost item to which the trackable object is attached. In some embodiments, the trackable object generates the sound a predetermined number of times, for a predetermined duration of time, and/or at a predetermined volume. For example, the trackable object generates a ring or a chime once at a respective volume and for a duration of 0.5, 0.75, 1, 1.5, 2, 3, 4, 5, 15, 30, 60 or 120 seconds. Granting access to a sound generation feature of a trackable object that is owned by a user with an entity when the trackable object is reported as lost alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user-device interaction.

In some embodiments, the one or more features of the trackable object for enabling locating the trackable object include a proximity finding feature by which the trackable object is locatable by a second electronic device associated with a user associated with the entity in accordance with a determination that the location of the trackable object and a location of the second electronic device are within a threshold distance (e.g., 0.1, 0.2, 0.5, 0.8, 1, 1.2, 1.5, 2, 5, 10, 20 or 40 m) of one another (926), such as a second electronic device associated with an airline worker being within the threshold distance of the trackable object as described with reference to FIG. 8E. In some embodiments, the second electronic device, while the proximity finding feature is active, displays a first visual indicator (e.g., an arrow) that indicates a direction in which the trackable object is located relative to the second electronic device (e.g., display an arrow pointed in the direction where the trackable object is determined to be located relative to the second electronic device). In some embodiments, a second indicator (e.g., a dot) is displayed that corresponds to the forward direction (e.g., relative to the front of the second electronic device). In some embodiments, the first indicator (e.g., an arrow) is displayed that corresponds to the direction of the trackable object (e.g., relative to the center of the display). In some embodiments, the arrow points from the center of the display towards the second indicator (e.g., thus pointing towards the trackable object). In some embodiments, an arc is displayed between the first and second indicator to indicate to the user the direction to turn the device to align the trackable object to device front (e.g., to rotate the device in the direction of the arc to cause alignment of the first indicator with the second indicator). In some embodiments, while displaying the first visual indicator, if the second electronic device detects (e.g., using one or more sensors, such as an accelerometer, a gyroscope, or a GPS sensor) a change in orientation of the electronic device (e.g., detect a rotation of the device towards or away from the remote locator object), the second electronic device changes an appearance of the first visual indicator (e.g., rotating the arrow) to indicate a direction in which the trackable object is located relative to the second electronic device (e.g., as the device is rotated towards or away from the direction of the trackable object, the display is updated to reflect the change in the direction of the trackable object relative to the device). For example, when the device rotates towards the trackable object (e.g., the front of the device is rotated towards the trackable object), the arrow rotates to point towards the top of the device (e.g., in accordance with the position of the trackable object) and/or the first indicator moves towards the first indicator (e.g., in accordance with the position of the trackable object). Thus, the arrow and/or the first indicator are updated “live” to be pointed towards the trackable object. Granting access to a proximity finding feature of a trackable object that is owned by a user with an entity when the trackable object is reported as lost alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user-device interaction.

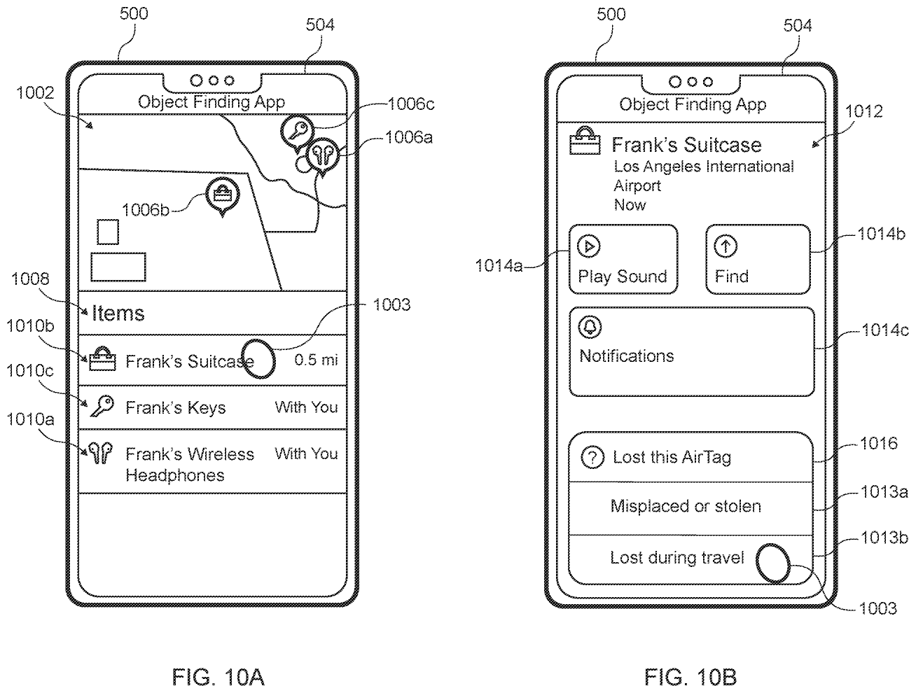

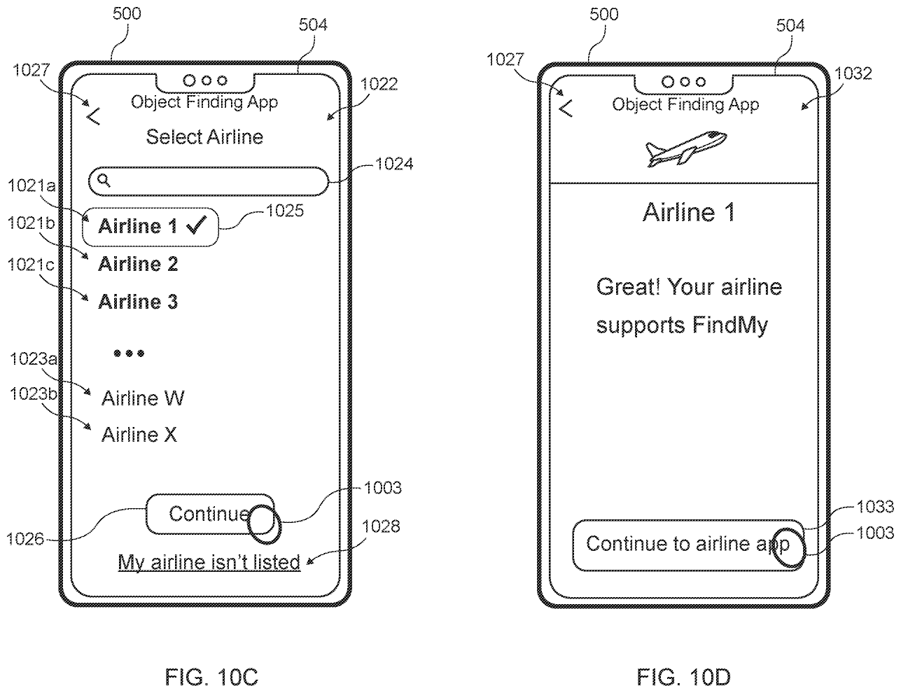

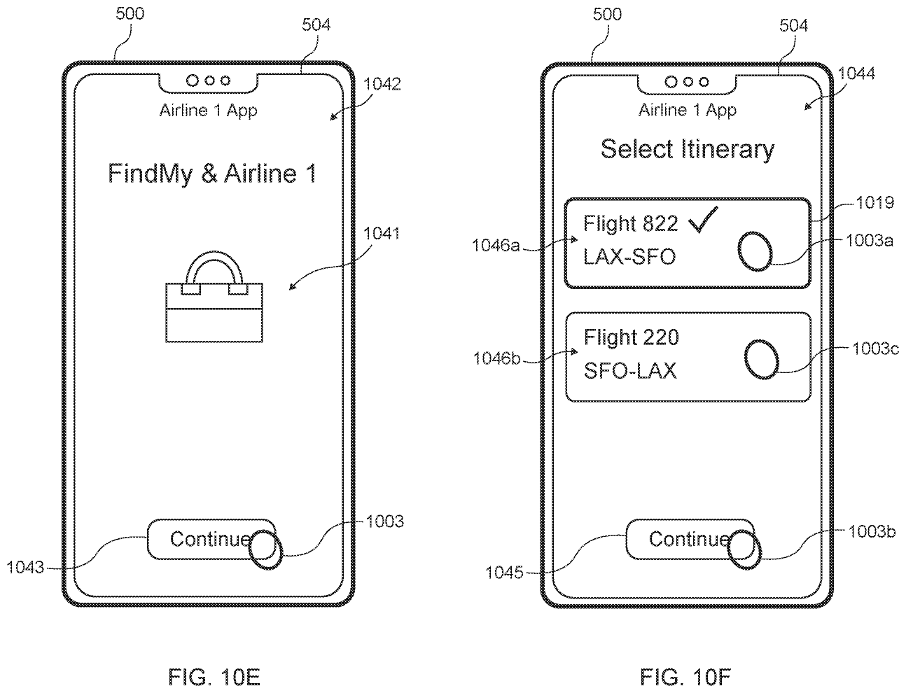

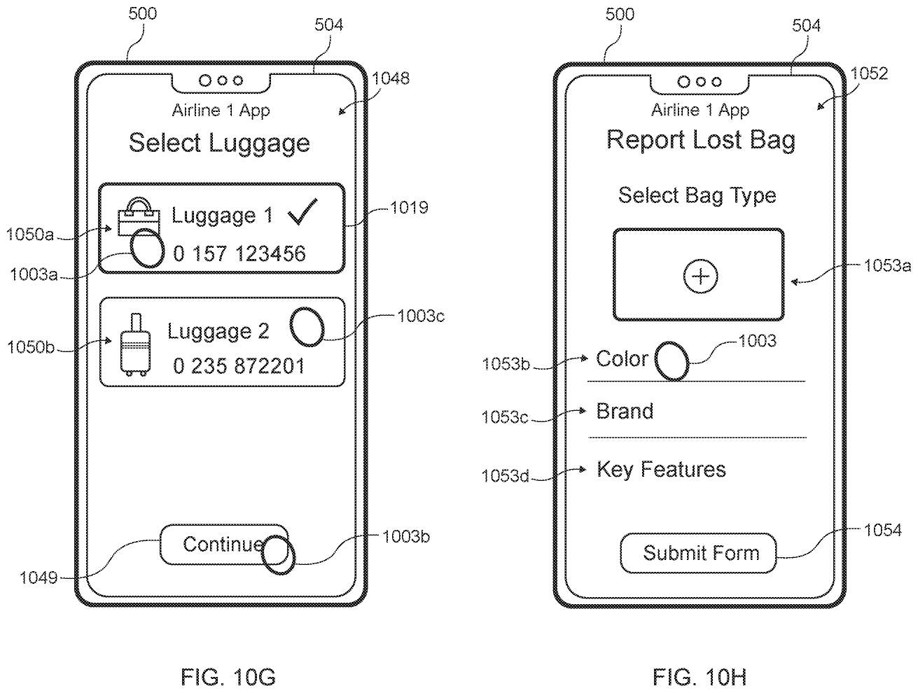

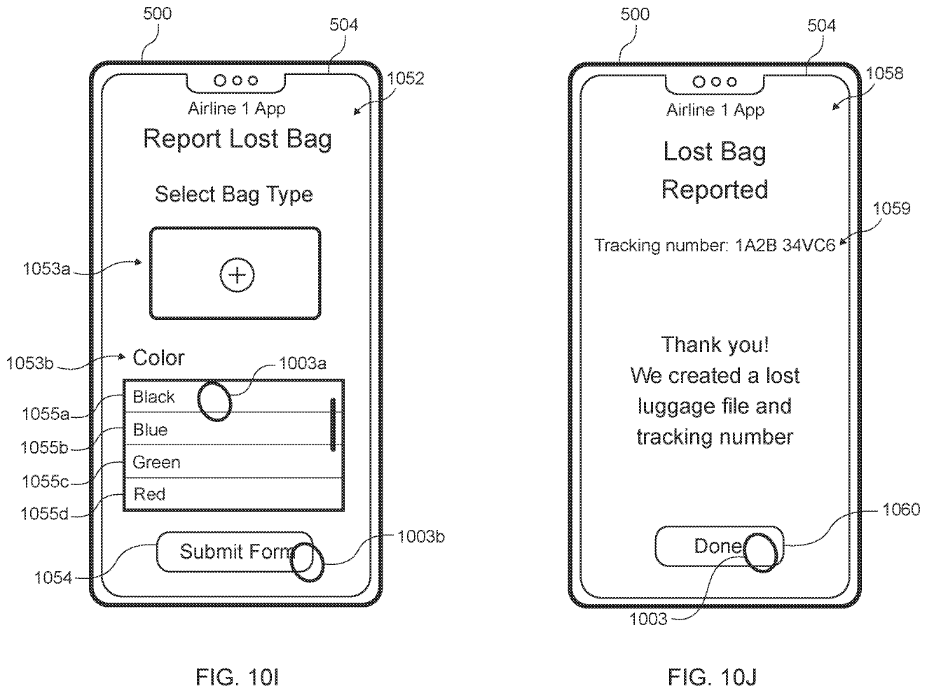

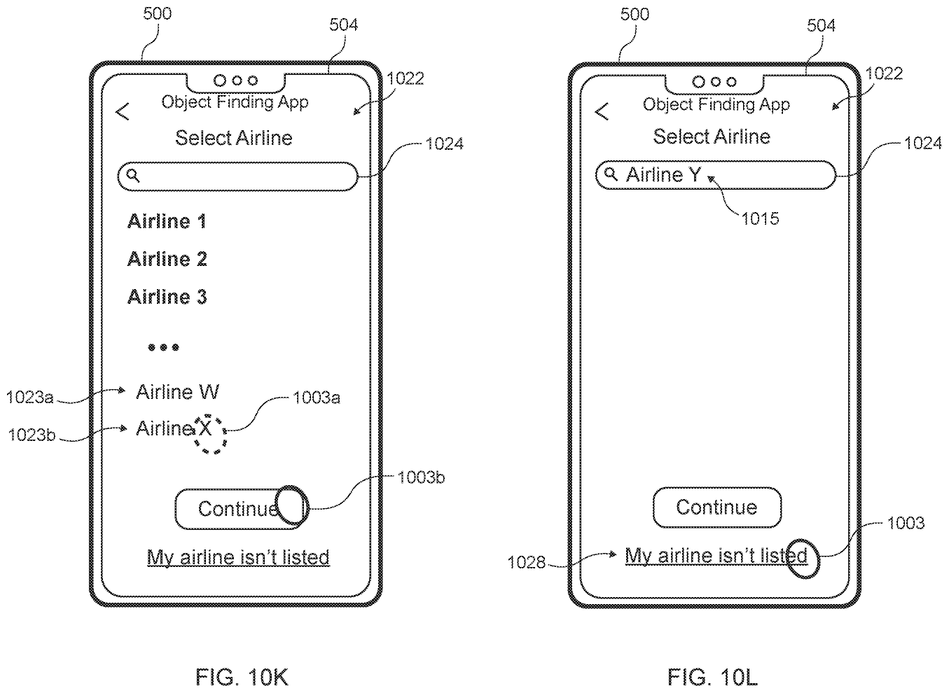

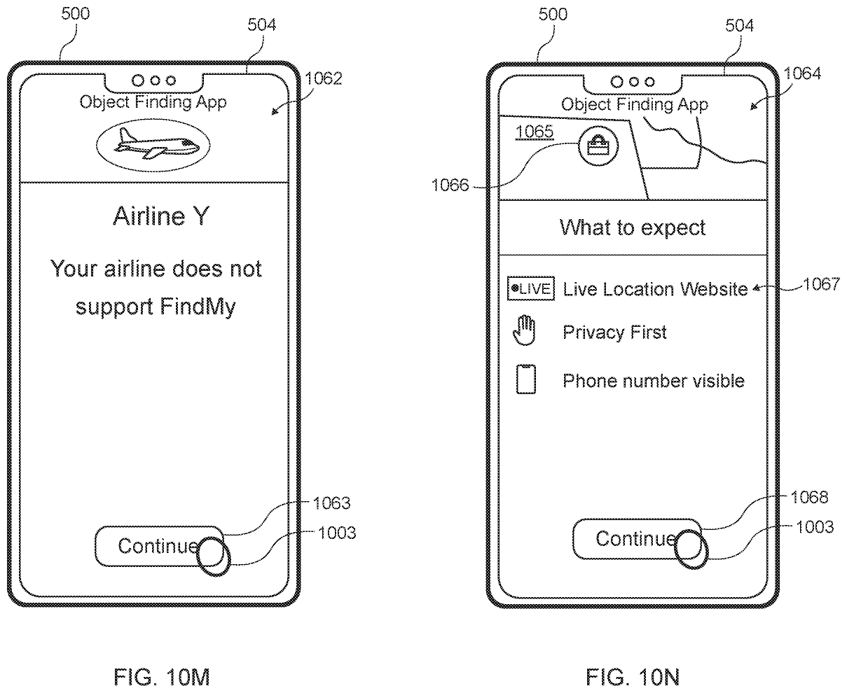

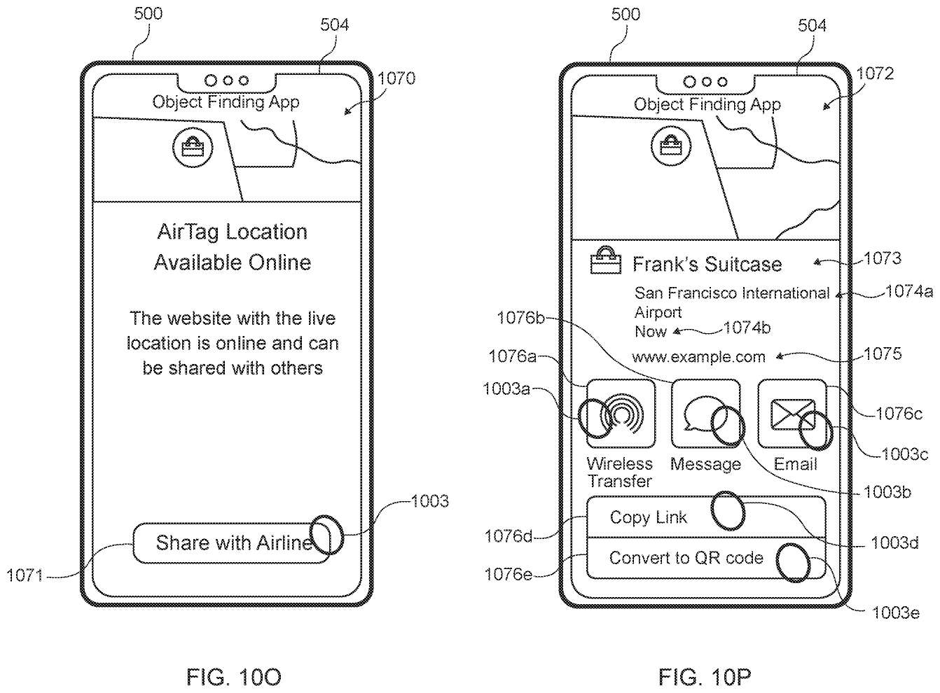

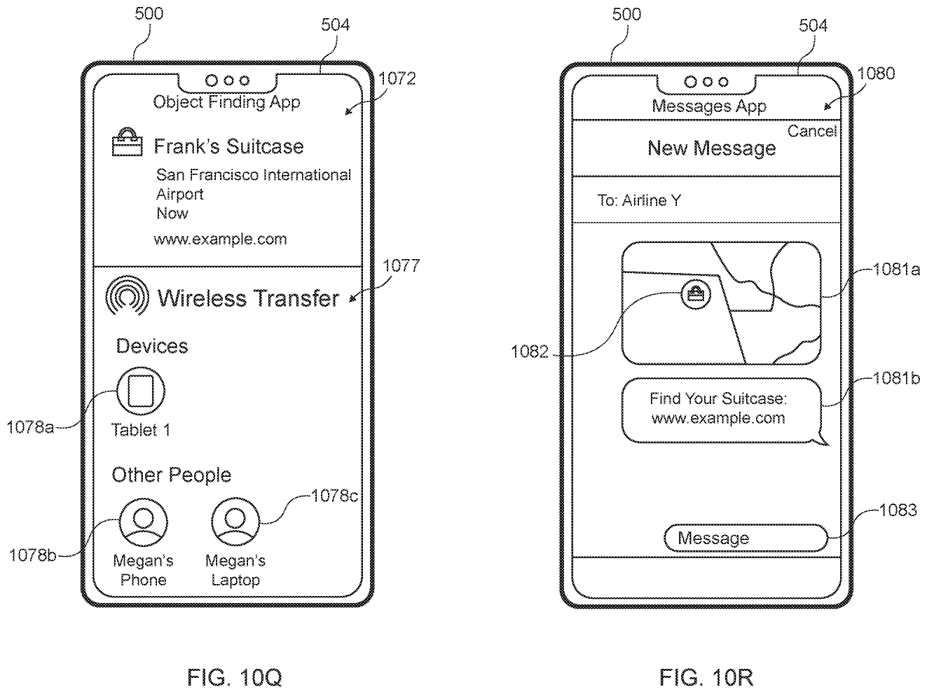

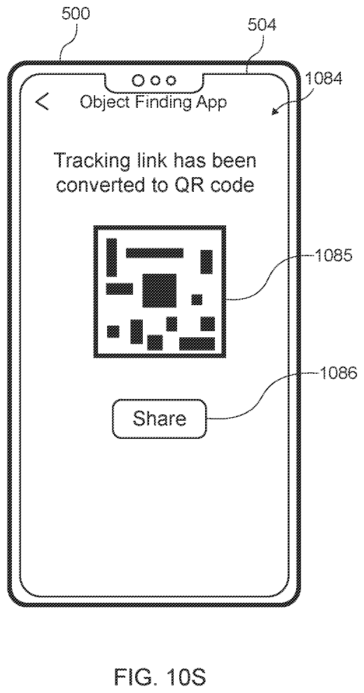

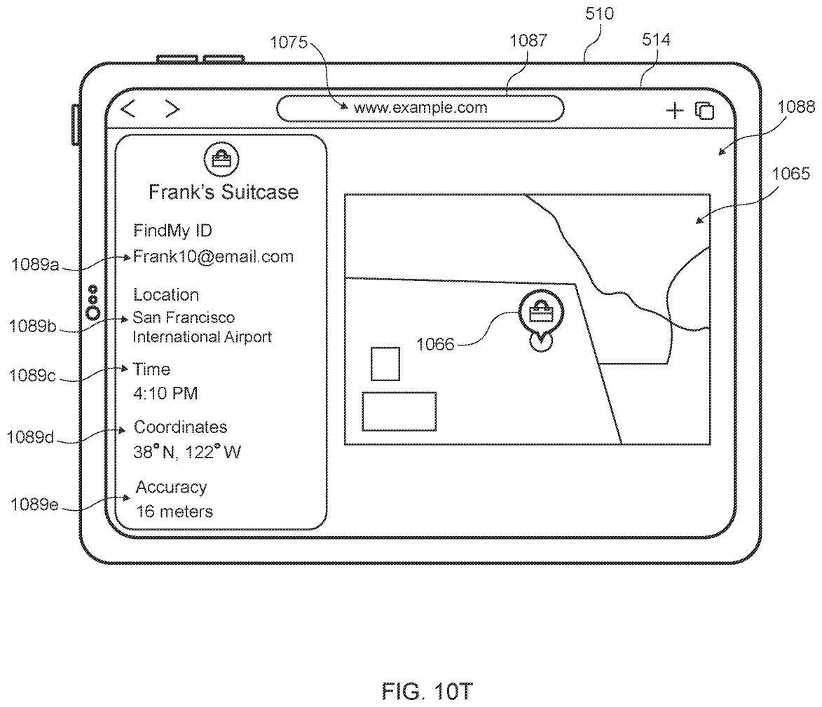

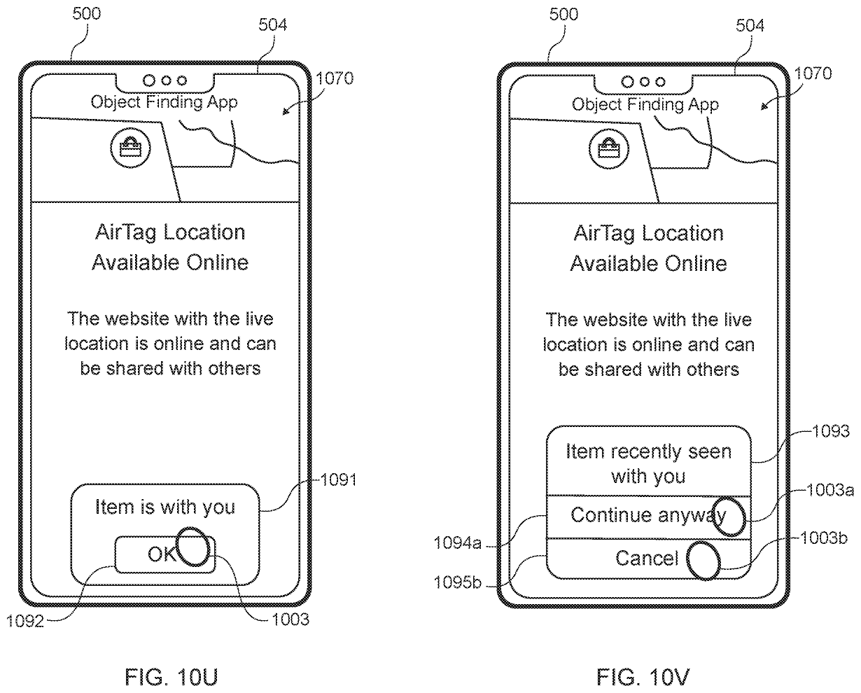

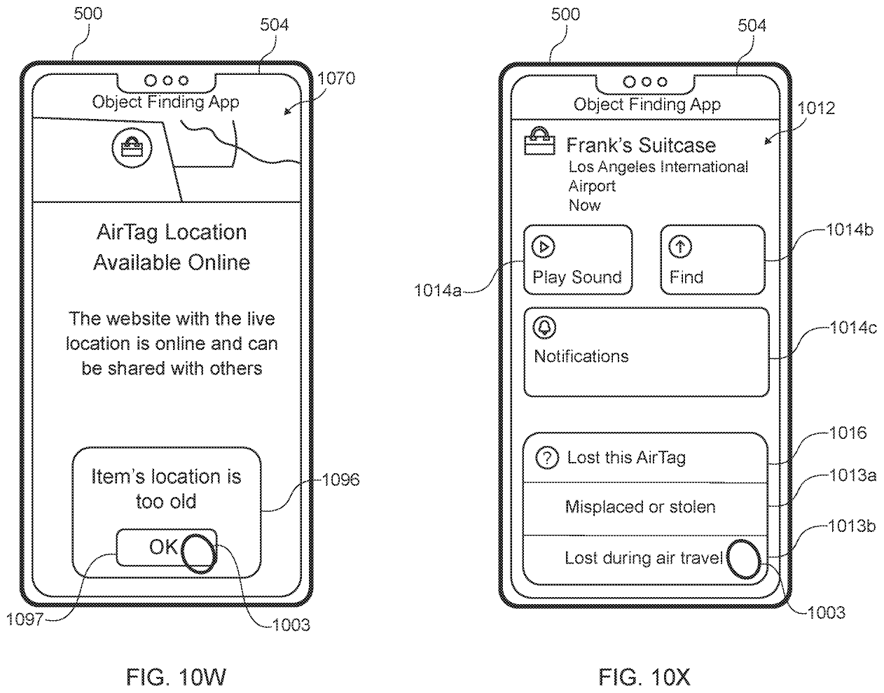

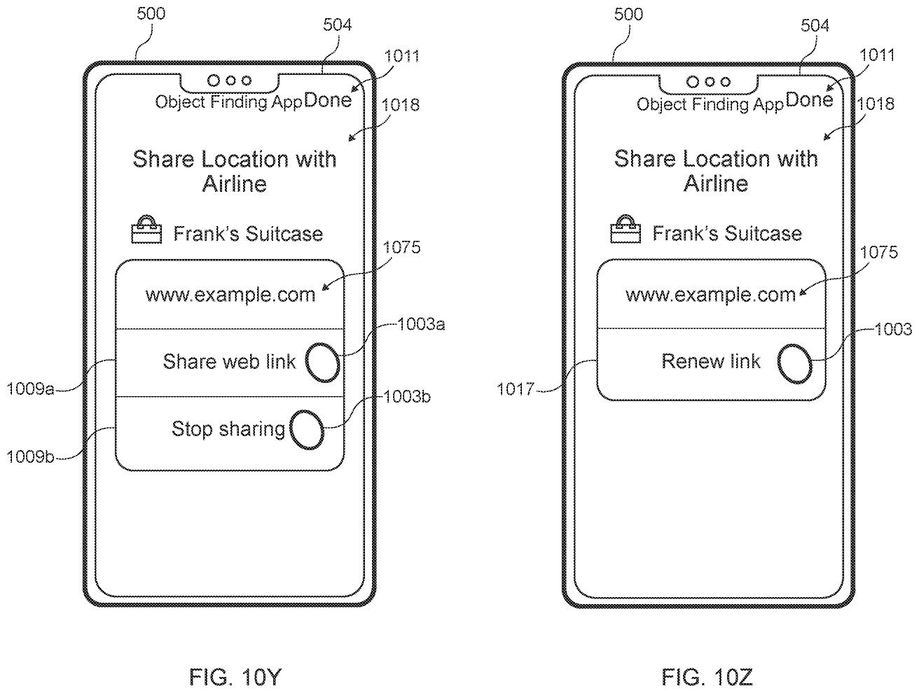

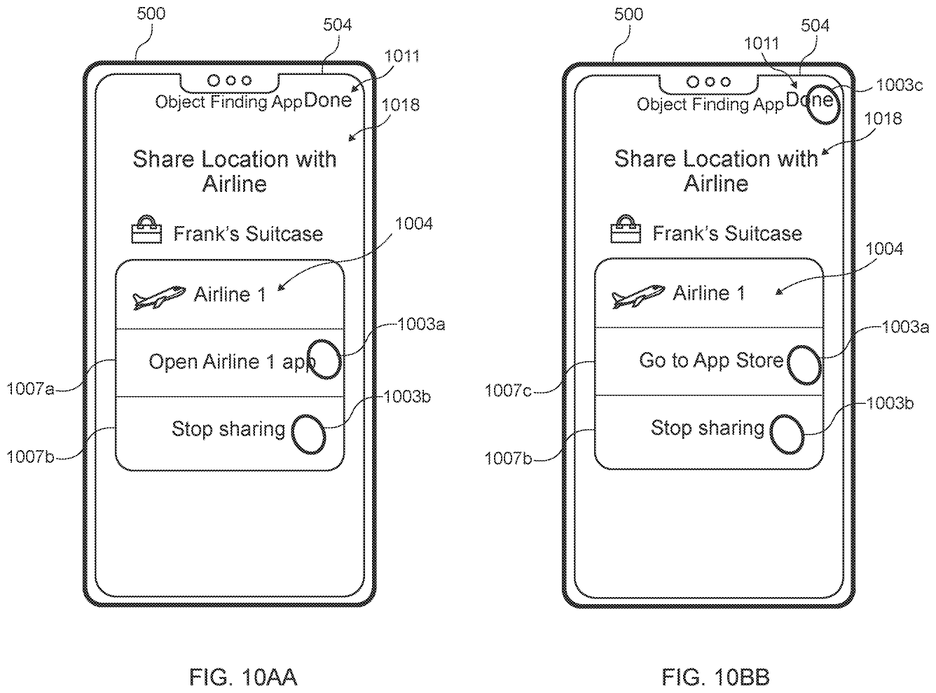

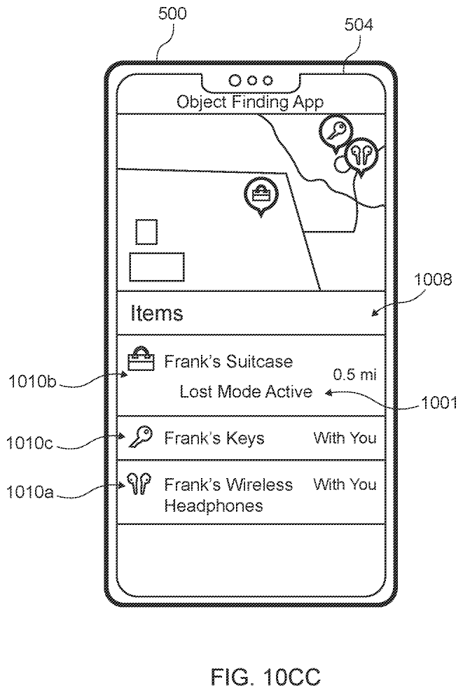

In some embodiments, while displaying the user interface associated with the trackable object that is associated with the electronic device, the electronic device detects, via the one or more input devices, a second input corresponding to a request to report an item (e.g., a physical object, such as the item discussed above) associated with the trackable object as lost to an entity (e.g., an organization or business, such as the entity discussed above, as similarly described with reference to method 700), such as the selection of the second option 1013b in FIG. 10B. In some embodiments, the second input has one or more characteristics of the first input discussed above.

In some embodiments, in response to detecting the second input, in accordance with a determination that the entity is configured to access one or more first and one or more second features associated with the trackable object (e.g., the entity corresponds to an integrated entity as described with reference to FIGS. 10C-10D), the electronic device initiates the process to transmit the first information about the item to the entity and initiates the process to grant permission to the entity to access the one or more features of the trackable object (e.g., one or more first features and one or more second features discussed with reference to method 1100) for enabling locating the trackable object based on signals transmitted by the trackable object, as similarly described with reference to FIGS. 10E-10J. In some embodiments, the electronic device initiates the process to transmit the first information about the item to the entity and initiates the process to grant permission to the entity to access the one or more features as part of an item location reporting process. For example, the electronic device initiates the item location reporting process if the entity is configured to and/or is capable of accessing the one or more features of the trackable object. In some embodiments, as discussed with reference to method 1100, the ability of the entity to access the one or more features of the trackable object is based on configuration of electronic devices or other computer systems associated with the entity and/or compatibility of the electronic devices or other computer systems associated with the entity with the one or more features of the trackable object, such as the features discussed previously above. In some embodiments, the ability of the entity to access the one or more features of the trackable object is based on operability authorization (e.g., whether the entity is a known or trusted entity to the electronic device, such as based on user preferences, user activity, and/or other permissions). In some embodiments, initiating the process to transmit the first information about the item to the entity and initiating the process to grant permission to the entity to access the one or more features of the trackable object in response to detecting the first input described previously above are similarly performed based on whether the entity is configured to access the one or more first and the one or more second features associated with the trackable object.

In some embodiments, in accordance with a determination that the entity is not configured to access the one or more first and the one or more second features associated with the trackable object (e.g., the entity corresponds to a non-integrated entity as described with reference to FIG. 10C and FIGS. 10K-10L), the electronic device provides access to a link (e.g., a web-based link that is selectable to initiate display of a website) that, such as the link represented at 1075 in FIG. 10P, if shared with the entity, would enable the entity to access the one or more first features of the one or more features of the trackable object for locating the trackable object (e.g., information corresponding to a location of the trackable object), without enabling the entity to access the one or more second features, different from the one or more first features, associated with the trackable object for locating the trackable object (e.g., as similarly described with reference to method 1100), as similarly described with reference to web page 1088 in FIG. 10T. In some embodiments, when the electronic device generates the link that enables the entity to access the one or more first features associated with the trackable object, the electronic device displays a visual indication of the link. For example, the electronic device displays all or a portion of the link, an image associated with the link, and/or a hyperlink associated with the link in the user interface discussed above or in a different user interface (e.g., a user interface dedicated to the generation of the link and/or a user interface of a web-browsing application), as described in method 1100. Generating a link that enables an entity to access a location of a trackable object that is owned by a user when the trackable object is reported as lost alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user privacy and user-device interaction and reducing user concern regarding the location of the lost trackable object.

In some embodiments, the user interface associated with the trackable object that is associated with the electronic device includes one or more visual representations corresponding to one or more respective entities, such as the plurality of representations described with reference to FIG. 10C. In some embodiments, as described above, the first input includes selection of a selectable option for reporting the item as lost to the entity, wherein the selectable option is displayed in the user interface associated with the trackable object. In some embodiments, when the electronic device detects the selection of the selectable option for reporting the item as lost to the entity, the electronic device displays, in the user interface, one or more visual representations corresponding to one or more respective entities to which the electronic device is able to report the item as lost. In some embodiments, the one or more visual representations are selectable to initiate the processes discussed above for enabling the locating of the lost item. In some embodiments, the first input includes selection of a first visual representation corresponding to the entity discussed above. In some embodiments, the one or more visual representations include a name of the corresponding respective entity, an image associated with the corresponding respective entity (e.g., a picture, photograph, cartoon, sketch, or logo of the entity), and/or an indication of whether the corresponding respective entity is configured to access the one or more features of the trackable object, as discussed below.

In some embodiments, in accordance with a determination that the entity is configured to access the one or more first and the one or more second features associated with the trackable object, the one or more visual representations include a first visual representation corresponding to the entity displayed with one or more first visual characteristics, such as representation 1021a shown in FIG. 10C. For example, the first visual representation corresponding to the entity discussed above includes an indication that the entity is configured to access the one or more first and the one or more second features of the trackable object. In some embodiments, displaying the first visual representation with the one or more first visual characteristics includes displaying a text indication that the entity is configured to access the one or more features of the trackable object (e.g., displaying the first visual representation with a first label and/or in a first region of the user interface). In some embodiments, displaying the first visual representation with the one or more first visual characteristics includes displaying the first visual representation with a first visual appearance (e.g., one or more first colors, a first visual pattern, a first brightness level, a first highlight/shading characteristic, and/or a first translucency level). In some embodiments, in accordance with a determination that a plurality of entities are configured to access the one or more first and the one or more second features associated with the trackable object, the user interface associated with the trackable object includes a plurality of visual representations corresponding to the plurality of entities that are displayed with the one or more first visual characteristics discussed above.

In some embodiments, in accordance with a determination that the entity is not configured to access the one or more first and the one or more second features associated with the trackable object, the first visual indication corresponding to the entity is displayed with one or more second visual characteristics, different from the one or more first visual characteristics, such as representation 1023a in FIG. 10C. For example, the first visual representation corresponding to the entity discussed above includes an indication that the entity is not configured to access the one or more features of the trackable object. In some embodiments, displaying the first visual representation with the one or more second visual characteristics includes displaying a text indication that the entity is not configured to access the one or more features of the trackable object (e.g., displaying the first visual representation with a second label and/or in a second region of the user interface). In some embodiments, displaying the first visual representation with the one or more second visual characteristics includes displaying the first visual representation with a second visual appearance, different from the first visual appearance (e.g., one or more second colors, a second visual pattern, a second brightness level, a second highlight/shading characteristic, and/or a second translucency level, optionally different from those discussed above). In some embodiments, in accordance with a determination that a plurality of entities are not configured to access the one or more first and the one or more second features associated with the trackable object, the user interface associated with the trackable object includes a plurality of visual representations corresponding to the plurality of entities that are displayed with the one or more second visual characteristics discussed above. Displaying a visual representation corresponding to an entity with visual characteristics that are based on whether the entity is configured to access one or more features of a trackable object when the trackable object is reported as lost to the entity facilitates user discovery of whether the entity is configured to access the one or more features, which helps inform user decision when reporting the trackable object as lost, thereby improving user-device interaction.

In some embodiments, the user interface associated with the trackable object is a management user interface for the trackable object of a first application (e.g., an item locating application as similarly discussed with reference to method 700), such as user interface 1012 in FIG. 10B. For example, the management user interface for the trackable object includes information corresponding to the trackable object, such as an identifier of the trackable object (e.g., name, title, and/or label optionally designated by the user), a location of the trackable object (e.g., a current location or a last detected location of the trackable object), and/or a graphical representation (e.g., an image or rendering) of the trackable object (e.g., displayed at a location on a map corresponding to the last detected location for the trackable object). In some embodiments, the management user interface includes one or more options for managing the trackable object, as similarly discussed with reference to method 700.

In some embodiments, initiating the process to transmit the first information about the item to the entity includes displaying, via the display generation component, a second user interface, different from the user interface associated with the trackable object, of a second application, different from the first application (e.g., an application associated with the entity), via which to designate the first information, such as user interface 1042 in FIG. 10E. For example, if the entity is configured to access the one or more features of the trackable object, the electronic device replaces display of the user interface associated with the trackable object (e.g., the management user interface) with the second user interface that is associated with the entity application. In some embodiments, the second user interface is a user interface of an application associated with the entity, as similarly discussed in method 700. In some embodiments, the second user interface includes one or more user interface elements via which to designate the first information to be transmitted to the entity to aid in the locating of the item. For example, the second user interface includes text-entry fields, selectable options, drop-down menus, and/or toggles/slider bars that enable the user of the electronic device to enter and/or select information about the item, such as the information described above. In some embodiments, the item locating application to which the user interface associated with the trackable object belongs is also associated with a plurality of entities (e.g., including the entity discussed above). In some such embodiments, the application to which the second user interface discussed above belongs is an application associated with one entity of the plurality of entities, and is not associated with others of the plurality of entities. For example, the entities of the plurality of entities are associated with a plurality of individual (e.g., unique) applications. Enabling designating information about an item to which a trackable object that is owned by a user is attached to an entity via an application associated with the entity when the trackable object is reported as lost helps enable persons associated with the entity to efficiently locate and identify the item when locating the trackable object, thereby improving user-device interaction.

In some embodiments, the process to transmit the first information about the item to the entity includes transmitting second information that enables the entity to associate the trackable object with an item identifier known by the entity, such as the baggage ID indicated in first representation 1050a in FIG. 10G. For example, when the item is reported as lost to the entity, the entity has previously generated an item identifier for the item. As an example, if the item was lost during a flight, as similarly discussed above, the entity (e.g., the airline) has already generated a baggage identification number for the item (e.g., a baggage identification number or code that is attached to the item when the item is checked in for the flight, as similarly discussed with reference to method 700). In some embodiments, when the electronic device initiates the process to transmit the first information about the item to the entity in accordance with the determination that the entity is configured to access the one or more features of the trackable object, the electronic device transmits the second information to the entity for linking the trackable object specifically with the baggage identification number for the lost item. For example, though the entity is configured to track the location of the item (e.g., the user's baggage/luggage) using the baggage identification number, such tracking is accomplished via the entity's internal tracking systems/methods, which can be delayed, outdated, and/or undermanaged, rather than via the (e.g., real-time) object-locating data provided by the trackable object. In some embodiments, the second information is included with the information about the item. In some embodiments, the second information is transmitted separately (e.g., following) the information about the item. Transmitting information that enables an entity to associate a trackable object that is owned by a user with item information that is known by the entity when the trackable object is reported as lost helps enable persons associated with the entity to efficiently locate and identify the item when locating the trackable object, without requiring the user to manually provide input associated with doing so, thereby improving user-device interaction.

In some embodiments, the granting of the permission to the entity to access the one or more features of the trackable object for enabling locating the trackable object based on signals transmitted by the trackable object occurs after a conclusion of the process to transmit the first information about the item to the entity, as similarly described with reference to selection of submit option 1054 in FIG. 10I. For example, the entity is granted access to information corresponding to the location of the trackable object at the conclusion of the item location reporting process described above (e.g., and after the entity receives the first information about the entity). Specifically, the granting of the permission to the entity to access the one or more features of the trackable object optionally does not happen during the item location reporting process described above. Additionally or alternatively, in some embodiments, the granting of the permission to the entity to access the one or more features of the trackable object has not happened before the conclusion of the item location reporting process described above. In some embodiments, the one or more features of the trackable object that enable the entity to access the location of the trackable object is thereby not generated until after the conclusion of the process to transmit the first information about the item to the entity. In some embodiments, the electronic device displays, via the display generation component, a visual indication (e.g., a notification or other visual alert) in the user interface that the item location reporting process has been completed and that the entity has been granted access to the location of the trackable object, as similarly discussed above. Waiting to grant permission to one or more features of a trackable object that enable an entity to access a location of the trackable object that is owned by a user when the trackable object is reported as lost until after information about the item is transmitted to the entity helps ensure the user intends to grant the entity access to the location of the trackable object, thereby improving user privacy and user-device interaction.

In some embodiments, the user interface associated with the trackable object is a management user interface for the trackable object, wherein the management user interface is a user interface of an item locating application, such as user interface 1012 in FIG. 10B. For example, the management user interface for the trackable object includes information corresponding to the trackable object, such as an identifier of the trackable object (e.g., name, title, and/or label optionally designated by the user), a location of the trackable object (e.g., a current location or a last detected location of the trackable object), and/or a graphical representation (e.g., an image or rendering) of the trackable object. In some embodiments, the management user interface includes one or more options for managing the trackable object, including a selectable option that is selectable for requesting to report the item associated with the trackable object as lost to the entity, which initiates the item location reporting process discussed above. In some embodiments, the first input includes selection of the selectable option displayed in the management user interface. In some embodiments, the management user interface for the trackable object has one or more characteristics of the management user interface described with reference to method 700. Granting permission to access one or more features of a trackable object that enable an entity to access a location of the trackable object that is owned by a user when the trackable object is reported as lost via a management user interface for the trackable object alerts the entity that the trackable object has been lost and enables persons associated with the entity to efficiently track the location of the trackable object for locating the trackable object, which reduces the need for user input to manually provide object-locating information to the entity and simplifies the input for reporting the item as lost to the entity, thereby improving user-device interaction.

In some embodiments, the user interface associated with the trackable object is a user interface of an application associated with the entity, such as user interface 640 in FIG. 6G. For example, the user interface is displayed in an application owned and/or operated by the entity and that is displayed and accessible via the electronic device, as similarly described with reference to method 700. In some embodiments, the user interface of the application associated with the entity does not correspond to the user interface of the item locating application discussed previously above. In some embodiments, the user interface of the application associated with the entity does not correspond to the management user interface for the trackable object discussed previously above. Granting permission to access one or more features of a trackable object that enable an entity to access a location of the trackable object that is owned by a user when the trackable object is reported as lost via a user interface of an application of the entity alerts the entity that the trackable object has been lost and enables persons associated with the entity to efficiently track the location of the trackable object for locating the trackable object, which reduces the need for user input to manually provide object-locating information to the entity and simplifies the input for reporting the item as lost to the entity, thereby improving user-device interaction.

In some embodiments, in response to detecting the first input, in accordance with a determination that a location of the trackable object was near a location associated with a user of the electronic device recently (e.g., less than a threshold amount of time ago relative to a current time and/or at a time when the first input was detected), the electronic device displays, via the display generation component, an alert user interface object (e.g., alert 1093 in FIG. 10V) that indicates the location of the trackable object was near the location associated with the user recently. For example, when the electronic device detects the first input and/or while the electronic device is detecting the first input, the electronic device determines that the user of the electronic device (and/or the electronic device) and the trackable object (and thus the item) have recently (e.g., within the past 1 minute, 3 minutes, 5 minutes, 10 minutes, 15 minutes, 25 minutes, 30 minutes, 1 hour, 3 hours, or 5 hours) been within a threshold distance (e.g., 0.1, 0.2, 0.5, 0.8, 1, 1.2, 1.5, 2, 5, 10, 20 or 40 m) of each other and have moved together (e.g., moved while not becoming farther than the threshold distance apart) a predefined distance (e.g., 1, 2, 5, 10, 15, 20, 30, 35, or 40 m) and/or have not been stationary for at least a threshold amount of time (e.g., 1 minute, 5 minutes, 15 minutes, 30 minutes, 1 hour, or 2 hours). In some embodiments, the electronic device detects that the user of the electronic device (and/or the electronic device) and the trackable object are within the threshold distance of each other without detecting movement of the electronic device and/or of the trackable object. In some embodiments, the electronic device detects that the trackable object has moved with the electronic device more than the predefined distance. In some embodiments, the electronic device determines that the location of the trackable object is near or was recently near the location associated with the user when and/or after initiating the process to transmit the information about the item to the entity (e.g., but before granting the entity access to the location of the trackable object). In some embodiments, in response to detecting that the trackable object and the user of the electronic device (and/or the electronic device) is near or were recently near each other, the electronic device displays and/or generates a notification or visual alert indicating that the trackable object is near and/or was recently near the user of the electronic device. In some embodiments, the alert user interface object is displayed in the user interface associated with the trackable object discussed previously above. In some embodiments, the alert user interface object is displayed on a home screen (e.g., such as described with reference to FIG. 4A) or a lock screen of the electronic device. In some embodiments, the display of the alert user interface object is accompanied by audible (e.g., ring or chime) and/or haptic (e.g., vibration) feedback. In some embodiments, the electronic device proceeds with the process for granting permission to the entity to access one or more features of the trackable object discussed above despite displaying the alert user interface object (e.g., without the need for additional user input after displaying the alert user interface object). Alternatively, in some embodiments, when the alert user interface object is displayed, the electronic device forgoes proceeding with the process to grant the entity access to one or more features of the trackable object until additional user input is detected for proceeding with the process (e.g., user input directed toward the alert user interface object or other selectable option). In some embodiments, when the alert user interface object is displayed, the electronic device forgoes proceeding with the process to grant the entity access to the one or more features of the trackable object and optionally does not provide an option (e.g., a selectable option) for proceeding with the process. In some embodiments, (optionally, in response to detecting the first input) in accordance with a determination that the location of the trackable object was not near the location associated with the user of the electronic device recently (and/or is not currently near the location associated with the user of the electronic device), the electronic device forgoes displaying the alert user interface object discussed above. For example, the electronic device proceeds with initiating the process to grant the entity access to the location of the trackable object. Generating an alert at an electronic device when a location associated with a user of the electronic device and a location of a trackable object associated with the user are or have recently been near each other when the trackable object is reported as lost to an entity facilitates discovery that the user of the electronic device is in possession of the trackable object and/or helps the user avoid unintentionally and/or undesirably granting the entity access to the location of the trackable object, thereby improving user-device interaction and improving user privacy.

In some embodiments, in response to detecting the first input, in accordance with a determination that a location of the trackable object was updated (e.g., or otherwise known) more than a threshold amount of time ago (e.g., 5 minutes, 15 minutes, 30 minutes, 1 hour, 2 hours, 5 hours, 10 hours, 1 day, 3 days, or 1 week) (e.g., relative to a current time and/or at a time when the first input was detected), the electronic device displays, via the display generation component, an alert user interface object (e.g., alert 1096 in FIG. 10W) that indicates the location of the trackable object was updated more than the threshold amount of time ago (e.g., an alert that the location of the trackable object is outdated and/or would otherwise not assist the entity in locating the item). For example, when the electronic device detects the first input and/or while the electronic device is detecting the first input, the electronic device determines that a last-known location of the trackable object (and thus the item) is known based on location data reported by the trackable object more than the threshold amount of time ago. In some embodiments, the location of the trackable object is known and/or has been updated more than the threshold amount of time ago due to a break in wireless communication between the trackable object and the electronic device. For example, the trackable object and/or the electronic device are located at a respective location that does not currently permit the electronic device to communicate with the trackable object wirelessly (e.g., via Wi-Fi, Bluetooth, or other wireless communication). In some embodiments, the determination that the location of the trackable object was updated more than the threshold amount of time ago is based on a determination that the location of the trackable object cannot currently be detected by the electronic device (e.g., due to one or more of the above reasons). In some embodiments, the threshold amount of time is determined based on the time-bounded event during which the trackable object was lost, as similarly discussed above. For example, if the last-known location of the trackable object is prior to the time-bounded event and/or prior to the trackable object (and thus the item) being in the care of the entity, the electronic device determines that the location of the trackable object was updated more than the threshold amount of time ago. In some embodiments, the electronic device determines that the location of the trackable object was updated and/or otherwise known more than the threshold amount of time ago when and/or after initiating the process to transmit the information about the item to the entity (e.g., but before granting the entity access to the location of the trackable object). In some embodiments, in response to detecting that the location of the trackable object is outdated, the electronic device displays and/or generates a notification or visual alert indicating that the location of the trackable object is outdated. In some embodiments, the alert user interface object is displayed in the user interface associated with the trackable object discussed previously above. In some embodiments, the alert user interface object is displayed on a home screen (e.g., such as described with reference to FIG. 4A) or a lock screen of the electronic device. In some embodiments, the display of the alert user interface object is accompanied by audible (e.g., ring or chime) and/or haptic (e.g., vibration) feedback. In some embodiments, the electronic device proceeds with the process for granting permission to the entity to access one or more features of the trackable object discussed above despite displaying the alert user interface object (e.g., without the need for additional user input after displaying the alert user interface object). Alternatively, in some embodiments, when the alert user interface object is displayed, the electronic device forgoes proceeding with the process to grant the entity access to one or more features of the trackable object until additional user input is detected for proceeding with the process (e.g., user input directed toward the alert user interface object or other selectable option). In some embodiments, when the alert user interface object is displayed, the electronic device forgoes proceeding with the process to grant the entity access to the one or more features of the trackable object and optionally does not provide an option (e.g., a selectable option) for proceeding with the process. In some embodiments, (optionally, in response to detecting the first input) in accordance with a determination that the location of the trackable object was not updated more than the threshold amount of time ago (e.g., the location of the trackable object is currently known and/or was recently updated by the electronic device), the electronic device forgoes displaying the alert user interface object discussed above. For example, the electronic device proceeds with initiating the process to grant the entity access to the location of the trackable object. Generating an alert at an electronic device when a location of a trackable object associated with the user of the electronic device is outdated when the trackable object is reported as lost to an entity facilitates discovery that the location of the trackable object will not assist the entity in locating the trackable object and/or helps the user avoid unintentionally and/or undesirably granting the entity access to the location of the trackable object, thereby improving user-device interaction and improving user privacy.

In some embodiments, in response to detecting the first input, in accordance with a determination that a location of the trackable object corresponds to a respective location of one or more user-specified locations (e.g., at a current time and/or at a time when the first input was detected), the electronic device displays, via the display generation component, an alert user interface object (e.g., similar to alert 1091 in FIG. 10U) that indicates presence of the trackable object at the respective location. For example, when the electronic device detects the first input and/or while the electronic device is detecting the first input, the electronic device determines that the trackable object (and thus the item) is located at a location that is known to the user of the electronic device (e.g., a “safe” or “trusted” location), such as one or more locations saved in memory of the electronic device. In some embodiments, the one or more locations are associated with a maps or other navigation application on the electronic device. For example, the one or more user-specified locations include one or more user-favorited destinations/locations (e.g., home address, work address, and/or school address) or previous destinations within the application (e.g., destinations the user has previously or recently traveled to, such as within the past 30 minutes, 1 hour, 3 hours, 5 hours, 10 hours, 1 day, 3 days, or 1 week) that satisfy one or more criteria (e.g., previous destinations that are frequently traveled to, such as more than 3, 4, 5, 8, 10, 15, 20 times). In some embodiments, the one or more user-specified locations correspond to one or more locations saved in memory of the electronic device and associated with a contacts application on the electronic device. For example, the one or more user-specified locations include one or more addresses associated with one or more contacts of the user (e.g., entered and saved by the user). In some embodiments, the one or more user-specified locations correspond to any locations, destinations, and/or addresses associated with any one or combination of applications running on the electronic device, such as messaging (e.g., text and/or email) applications, web-browsing applications, and/or social media applications, or other data saved in memory or otherwise accessible by the electronic device. In some embodiments, a safe/trusted location is defined for the trackable object (e.g., via user input in the user interface associated with the trackable object, such as the management user interface discussed above). In some embodiments, a trusted location is designated for the trackable object in response to detecting user input directed to a selectable option for such that is displayed in and/or with a separation alert displayed by the electronic device (e.g., a notification or other alert indicating that the trackable object is no longer with the user and/or the electronic device and/or that the trackable object has been separated from the user and/or the electronic device). In some embodiments, defining a trusted location (e.g., home, work, school, or other location) for a trackable object allows the electronic device to determine whether the trackable object and the user left the trusted location together, and therefore indicates whether the trackable object was likely intentionally left behind at the trusted location. In some embodiments, a trusted location is a trusted person. For example, when the trackable object is determined to be with a trusted person (e.g., is following the trusted person's location or is within a threshold distance (e.g., 0.1, 0.2, 0.5, 0.8, 1, 1.2, 1.5, 2, 5, 10, 20, or 40 m of the trusted person), the electronic device determines that the location of the trackable object corresponds to the respective location. In some embodiments, the determination that the location of the trackable object corresponds to a respective location of the one or more user-specified locations is in accordance with a determination that the location of the trackable object is within a threshold distance (e.g., 0.1, 0.2, 0.5, 0.8, 1, 1.2, 1.5, 2, 5, 10, 20 or 40 m) of the safe location. In some embodiments, when the trackable object is separated (e.g., more than the threshold distance) from the electronic device, if the trackable object is not in a trusted location (e.g., the respective location above), the electronic device displays an alert (e.g., a separation alert) indicating that the object is separated from the electronic device. In some embodiments, if the trackable object is in a trusted location when the trackable object is separated from the electronic device, the electronic device forgoes displaying the separation alert.

In some embodiments, the electronic device determines that the location of the trackable object corresponds to the respective location when and/or after initiating the process to transmit the information about the item to the entity (e.g., but before granting the entity access to the location of the trackable object). In some embodiments, in response to detecting that the trackable object is located at the respective location, the electronic device displays and/or generates a notification or visual alert indicating that the trackable object is at the respective location and/or is otherwise in a safe/user-known location. In some embodiments, the alert user interface object is displayed in the user interface associated with the trackable object discussed previously above. In some embodiments, the alert user interface object is displayed on a home screen (e.g., such as described with reference to FIG. 4A) or a lock screen of the electronic device. In some embodiments, the display of the alert user interface object is accompanied by audible (e.g., ring or chime) and/or haptic (e.g., vibration) feedback. In some embodiments, the electronic device proceeds with the process for granting permission to the entity to access one or more features of the trackable object discussed above despite displaying the alert user interface object (e.g., without the need for additional user input after displaying the alert user interface object). Alternatively, in some embodiments, when the alert user interface object is displayed, the electronic device forgoes proceeding with the process to grant the entity access to one or more features of the trackable object until additional user input is detected for proceeding with the process (e.g., user input directed toward the alert user interface object or other selectable option). In some embodiments, when the alert user interface object is displayed, the electronic device forgoes proceeding with the process to grant the entity access to the one or more features of the trackable object and optionally does not provide an option (e.g., a selectable option) for proceeding with the process. In some embodiments, (optionally, in response to detecting the first input) in accordance with a determination that the location of the trackable object does not correspond to the respective location (e.g., or any location of the one or more user-specified locations), the electronic device forgoes displaying the alert user interface object discussed above. For example, the electronic device proceeds with initiating the process to grant the entity access to the location of the trackable object. Generating an alert at an electronic device when a location of a trackable object associated with the user of the electronic device corresponds to a safe location when the trackable object is reported as lost to an entity facilitates discovery that the trackable object is located at the safe location and/or helps the user avoid unintentionally and/or undesirably granting the entity access to the location of the trackable object, thereby improving user-device interaction and improving user privacy.

It should be understood that the particular order in which the operations in FIGS. 9A-9D have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and/or 1100) are also applicable in an analogous manner to method 900 described above with respect to FIGS. 9A-9D. For example, remote locator objects, sharing access to one or more features of findable items, displaying item locating applications, displaying user interfaces associated with findable items, displaying status updates related to findable items, and displaying user interfaces associated with entities findable items described above with reference to method 900 optionally have one or more of the characteristics of findable items, sharing access to locations of findable items with entities, displaying item locating applications, displaying user interfaces associated with findable items, and displaying user interfaces associated with entities described herein with reference to other methods described herein (e.g., methods 700 and/or 1100). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIGS. 9A-9D are, optionally, implemented by components depicted in FIGS. 1A-1B. For example, displaying operation 902a and detecting operation 902b are optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Providing Access to Features of a Remote Locator Object

Users interact with electronic devices in many different manners. In some embodiments, an electronic device is able to track the location of a trackable object such as a remote locator object. In some embodiments, access to such remote locator objects can be shared by an owner of the remote locator object with an entity (e.g., one or more persons associated with the entity). The embodiments described below provide ways in which an electronic device provides access to one or more features associated with a remote locator object, including location information of the remote locator object, with an entity, thus enhancing the user's interactions with the electronic device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

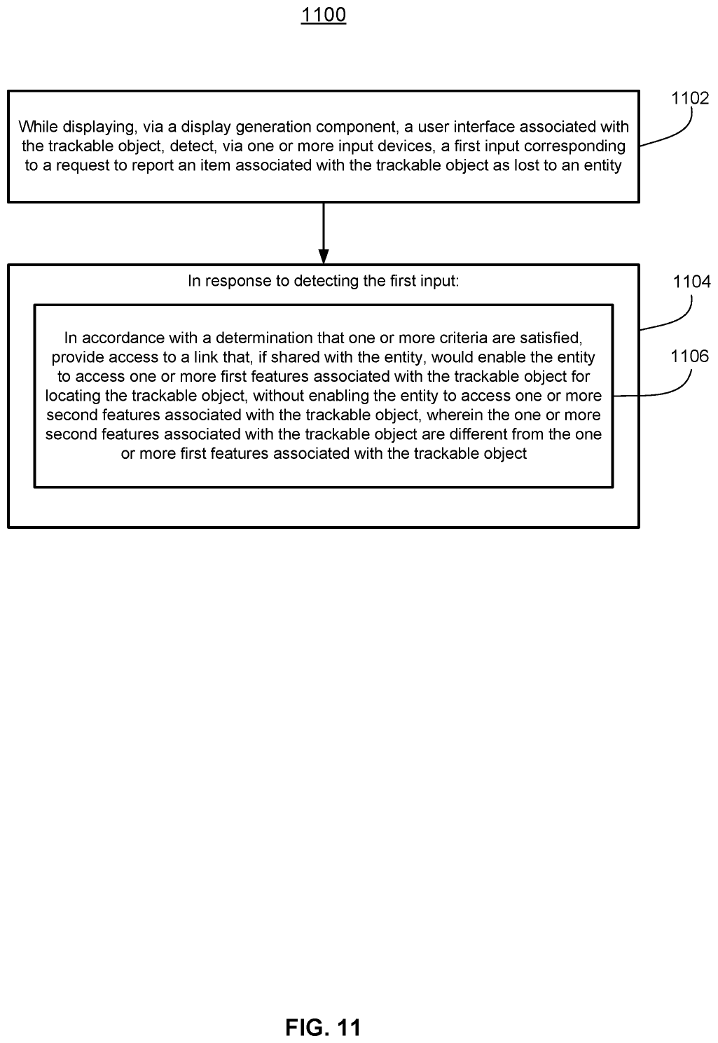

FIGS. 10A-10CC illustrate exemplary ways in which an electronic device facilitates providing access to one or more features associated with a remote locator object to an entity, in accordance with some embodiments of the disclosure. The embodiments in these figures are used to illustrate the processes described below, including the processes described with reference to FIG. 11.

FIGS. 10A-10CC illustrate an electronic device 500 associated with a user, including touch screen 504 displaying one or more aspects of providing access to one or more features associated with a remote locator object to an entity. In FIG. 10A, electronic device 500 represents a mobile electronic device belonging to Frank, as described below. Furthermore, and as shown in FIG. 10A, electronic device 500 displays a user interface 1002 of an item locating application (e.g., Object Finding App) that displays information regarding one or more findable items the locations to which the user (e.g., Frank) has access. In some embodiments, the user interface 1002 has one or more characteristics of user interface 602 described above with reference to the FIG. 6 series. It should be understood that, as described below, the location of the electronic device 500 and the location of the user of the electronic device 500 are referred to herein interchangeably.

As shown in FIG. 10A, in some embodiments, the user interface 1002 of the item locating application includes a list 1008 of findable items to which the user (e.g., Frank) has access to the locations thereof. For example, and as shown in FIG. 10A, the list 1008 (titled “Items”) includes findable items (e.g., remote locator objects or other trackable objects) that are owned by the user, such as Frank's Suitcase in first item 1010b, Frank's Keys in second item 1010d, and Frank's Wireless Headphones in third item 1010a. As shown in FIG. 10A, the findable items of the list 1008 optionally include graphical representations corresponding to the particular findable item, such as graphical representation of a suitcase for Frank's Suitcase in 1010b and graphical representation of a key for Frank's Keys in 1010d.

In some embodiments, the user interface 1002 of the item locating application includes one or more distance indications that indicate the distance the items of list 1008 are from the electronic device 500 (e.g., and thus from the user). In some embodiments, the one or more distance indications are optionally accompanied by a time indication (e.g., Now, 2 seconds ago, 1 minute ago, 1 hour ago, or 5 hours ago) that indicates when a particular distance indication was last updated. For example, as shown in FIG. 10A, in the user interface 1002, first item 1010b of list 1008 indicates that findable item Frank's Suitcase is approximately 0.5 miles from the current location of the electronic device 500. Further, in FIG. 10A, second item 1010b of list 1008 indicates that findable item Frank's Keys and third item 1010a indicates that findable item Frank's Wireless Headphones are “With You” (e.g., at the current location of the user). In some embodiments, a given item in list 1008 does not include an indication of a distance of the corresponding findable item relative to a location associated with the user when that findable item is indicated as being “With You” (e.g., is within a threshold distance of device 500, such as 0.1, 0.5, 1, 5, 10, or 100 meters).

In some embodiments, the user interface 1002 of the item locating application in FIG. 10A includes a representation of a map of a physical region surrounding and/or including the location of the user (e.g., Frank) and/or the electronic device 500. In some embodiments, the map indicates the location of the user (e.g., Frank) and/or the electronic device 500 as a circle, the locations of the findable items (e.g., including remote locator objects) of list 1008, such as a representation of Frank's Suitcase (e.g., icon 1006b) at a location on the map corresponding to the location of Frank's Suitcase in the physical region, a representation of Frank's Keys (e.g., icon 1006c) at a location on the map corresponding to the location of Frank's Keys, and a representation of Frank's Wireless Headphones (e.g., icon 1006a) at a location on the map corresponding to the location of Frank's Wireless Headphones, and/or locations of additional users that share their location with the user (e.g., Frank). As shown in the example of FIG. 10A, no additional users are currently sharing their locations with Frank and thus, no additional user is displayed on the map in the user interface 1002. As further shown in FIG. 10A, and as noted above, the representations 1006a, 1006b, and 1006c indicate the corresponding findable item (e.g., a graphic of the corresponding findable item) such that the user (e.g., Frank) can visually identify the findable item on the map of the user interface 1002. In some embodiments, and as shown in FIG. 10A, the representations of the findable items on the map of the user interface 1002 are bubbles and/or circles including the graphics discussed above. However, it should be understood that the representations are optionally any shape and/or size. In some embodiments, and as shown in FIG. 10A, the representation 1006a of the findable item Frank's Wireless Headphones, the representation 1006c of the findable item Frank's Keys, and the current location of the user/electronic device 500 are stacked on map of the user interface 1002 because the current location of the user and the findable items Frank's Wireless Headphones and Frank's Keys are in close proximity.

In FIG. 10A, while the user interface 1002 of the item locating application is displayed via the touch screen 504, the electronic device 500 detects a selection, via contact 1003, directed to the first item 1010b of the list 1008 in the user interface 1002. For example, the electronic device 500 detects a click, tap, slide, and/or hover input on the touch screen 504 over a location corresponding to the first item 1010b.

In some embodiments, as shown in FIG. 10B, in response to detecting the selection of the first item 1010b, the electronic device 500 displays, via the touch screen 504, user interface 1012 associated with the findable item Frank's Suitcase. For example, as shown in FIG. 10B, the electronic device 500 replaces display of the user interface 1002 with the user interface 1012. In some embodiments, the user interface 1012 corresponds to an expansion of the first item 1010b in the list 1008 of the user interface 1002. For example, as shown in FIG. 10B, the user interface 1012 includes the name of the selected findable item (e.g., Frank's Suitcase) and the current location of the selected findable item (e.g., Los Angeles International Airport, which is located in Los Angeles, California). In some embodiments, the user interface 1012 has one or more characteristics of user interface 612 in the FIG. 6 series.

In some embodiments, the user interface 1012 associated with the findable item Frank's Suitcase provides for management of the findable item Frank's Suitcase. For example, as shown in FIG. 10B, the user interface 1012 includes a first selectable option 1014a, a second selectable option 1014b, and a third selectable option 1014c for accessing one or more features associated with the findable item (e.g., the remote locator object). In some embodiments, the first selectable option 1014a is selectable to cause the findable item (e.g., the remote locator object) named Frank's Suitcase to emit sound (e.g., a ring, chime, tone, song, or other tune) that enables the user to locate the findable item. In some embodiments, the second selectable option 1014b is selectable to initiate a process for navigating to the findable item Frank's Suitcase. For example, in response to detecting a selection of the second selectable option 1014b, the electronic device displays, via the touch screen 504, a user interface of a navigation application that provides instructions (e.g., route details and/or overview) for travelling to the location of the findable item. In some embodiments, the third selectable option 1014c is selectable to initiate a process to control generation of one or more notifications or other alerts related to the findable item (e.g., notifications related to separation of the findable item from the electronic device 500). Additional details regarding the one or more features associated with the findable item are provided with reference to methods 700, 900, and/or 1100.

Additionally, as shown in FIG. 10B, the user interface 1012 includes region 1016 that is associated with configuring and/or reporting the findable item as lost (e.g., as no longer being in possession of the user). In some embodiments, as shown in FIG. 10B, the region 1016 includes a first option 1013a and a second option 1013b. In some embodiments, the first option 1013a is selectable to configure the findable item (e.g., Frank's Suitcase) as having been misplaced or stolen (e.g., or is otherwise not in the possession of the user). For example, in response to detecting a selection of the first option 1013a, the electronic device 500 initiates a process to activate a lost mode for the findable item (e.g., including facilitating return of the lost findable item, such as causing a respective electronic device that is proximate to the lost findable item to display a message). In some embodiments, the second option 1013b is selectable to report the findable item as lost during a time-bounded event. For example, the time-bounded event is a travel event that the user (e.g., Frank) is going to be participating in. In the example of FIGS. 10A-10CC, the time-bounded event is a flight, though, it should be understood, other time-bounded events are possible (e.g., as described below with reference to methods 700, 900, and/or 1100). As discussed below, in some embodiments, the second option 1013b is selectable to initiate a process for associating the findable item Frank's Suitcase with a particular time-bounded event (e.g., flight).

In FIG. 10B, the electronic device 500 detects a selection directed to the second option 1013b. For example, as shown in FIG. 10B, the electronic device 500 detects a tap of contact 1003 on a location of the touch screen 504 that corresponds to the second option 1013b. In some embodiments, as shown in FIG. 10C, in response to detecting the selection of the second option 1013b, the electronic device 500 initiates a process for providing an entity (e.g., an airline) associated with the time-bounded event (e.g., flight) access to one or more features associated with the findable item Frank's Suitcase (e.g., a location of the findable item Frank's Suitcase). For example, as shown in FIG. 10C, the electronic device 500 displays, via the touch screen 504, a user interface 1022 for selecting one or more airlines to which to report the findable item Frank's Suitcase as lost, as discussed below. It should be understood that, though entities are discussed as referring to airlines in the examples of FIGS. 10A-10CC, in some embodiments, the entities include additional or alternative organizations or companies, such as those discussed in methods 700, 900, and/or 1100, including a bus company, a train company, a ride-share company, a police organization, a hotel company, a tour company, an ocean cruise company, a shipping company, a moving company, a resort operator, or another entity responsible for moving or transporting belongings.

In some embodiments, as shown in FIG. 10C, the user interface 1022 enables the user to select one or more entities (e.g., airlines) to which to report the findable item Frank's Suitcase as lost, thereby initiating a process to provide a respective entity access to one or more features associated with the findable item (e.g., the remote locator object). For example, as shown in FIG. 10C, the user interface 1022 includes a plurality of representations corresponding to a plurality of entities (e.g., airlines). In some embodiments, a respective representation of the plurality of representations corresponding to the plurality of entities is selectable to initiate a process to provide the selected entity access to one or more features associated with the findable item, including location information of the findable item. In some embodiments, the plurality of representations corresponding to the plurality of entities is scrollable (e.g., vertically and/or horizontally) within the user interface 1022. Additionally, in some embodiments, the plurality of entities included in the plurality of representations is searchable, such as via search field 1024, in the user interface 1022.

In some embodiments, the plurality of entities (e.g., airlines) includes integrated entities (e.g., integrated airlines) and non-integrated entities (e.g., non-integrated airlines). In some embodiments, an integrated entity corresponds to an entity that is configured to access the one or more features associated with the findable item (e.g., as determined by device and/or system capability and/or accessibility of the entity, as discussed in more detail in method 1100). In some embodiments, a non-integrated entity corresponds to an entity that is not configured to access the one or more features associated with the findable item, as discussed in more detail in method 1100. In some embodiments, the plurality of representations corresponding to the plurality of entities is displayed with a respective visual appearance that is based on whether the entity is integrated or non-integrated. For example, as shown in FIG. 10C, the plurality of representations includes a first plurality of representations 1021a-1021c that is displayed with and/or has a first visual appearance indicating that the plurality of entities corresponding to the first plurality of representations 1021a-1021c is integrated. As an example, Airline 1 (e.g., corresponding to representation 1021a), Airline 2 (e.g., corresponding to representation 1021b) and Airline 3 (e.g., corresponding to representation 1021c) in FIG. 10C correspond to integrated airlines, and are therefore displayed with a first visual appearance (e.g., represented by bold font, though other visual delineations are possible, such as those discussed with reference to method 1100). In some embodiments, as shown in FIG. 10C, the plurality of representations includes a second plurality of representations 1023a-1023b that is displayed with and/or has a second visual appearance, different from the first visual appearance, indicating that the plurality of entities corresponding to the second plurality of representations 1023a-1023b is non-integrated. For example, in FIG. 10C, Airline W (e.g., corresponding to representation 1023a) and Airline X (e.g., corresponding to representation 1023b) correspond to non-integrated airlines, and are therefore displayed with a second visual appearance (e.g., represented by non-bold font, though other visual delineations are possible, such as those discussed with reference to method 1100).

In some embodiments, the plurality of entities included in the user interface 1022 correspond to entities known by the electronic device 500. For example, the plurality of representations of the plurality of entities is generated based on accessing memory or an online database of known entities (e.g., airlines). In some embodiments, the plurality of entities included in the user interface 1022 is included based on user activity and/or user behavior (e.g., based on prior and/or upcoming flights). In some embodiments, the determination that a respective entity is integrated or non-integrated is based on data provided by the respective entity.

In some embodiments, as shown in FIG. 10C, the user interface 1022 includes selectable option 1026 and selectable option 1028. In some embodiments, the selectable option 1026 is selectable to initiate the process to provide access to one or more features associated with the findable item to a selected entity, as discussed below. In some embodiments, the selectable option 1028 is selectable to initiate a process to provide access to one or more features associated with the findable item to an entity that is not included in the plurality of entities of the user interface 1022 (e.g., an entity (e.g., airline) that is not known to the electronic device 500).

In FIG. 10C, the user has selected Airline 1 in the user interface 1022, as indicated by selection indicator 1025 (e.g., checkmark and/or boxed outline). For example, in FIG. 10C, the electronic device 500 has detected a selection (e.g., such as via a tap or touch of a contact) on the touchscreen 504 directed to the representation 1021a corresponding to Airline 1 in the user interface 1022. In FIG. 10C, after Airline 1 has been selected, the electronic device 500 detects a selection of the selectable option 1026 in the user interface 1022. For example, as shown in FIG. 10C, the electronic device 500 detects a tap of contact 1003 on a location of the touchscreen 504 corresponding to the selectable option 1026.

In some embodiments, as shown in FIG. 10D, in response to detecting the selection of the selectable option 1026, the electronic device 500 displays user interface 1032 confirming the selection of Airline 1. In some embodiments, as shown in FIG. 10D, the user interface 1032 includes an indication that the selected entity (e.g., Airline 1) is an integrated entity (e.g., the airline is configured to access the one or more features associated with the findable item, such as the location of the findable item). In some embodiments, as shown in FIG. 10D, the user interface 1032 includes selectable option 1033 that is selectable to navigate away from the item locating application (e.g., Object Finding App) and launch an application associated with the entity (e.g., an application associated with Airline 1). For example, selection of the selectable option 1033 causes the electronic device 500 to continue the process of providing access to the one or more features associated with the findable item Frank's Suitcase, which is continued within the application of Airline 1.

In FIG. 10D, while displaying the user interface 1032, the electronic device 500 detects a selection of the selectable option 1033. For example, as shown in FIG. 10D, the electronic device 500 detects a tap of contact 1003 on a location of the touchscreen 504 corresponding to the selectable option 1033.

In some embodiments, as shown in FIG. 10E, in response to detecting the selection of the selectable option 1033, the electronic device 500 navigates away from (e.g., closes) the item locating application (e.g., thereby ceasing display of the user interface 1032) and launches an application associated with the selected entity (e.g., Airline 1 App). For example, as shown in FIG. 10E, the electronic device 500 displays user interface 1042 that is associated with the Airline 1 application running on the electronic device 500. In some embodiments, the application associated with the selected entity (e.g., Airline 1 App) is downloaded and stored on the electronic device 500. In some embodiments, the application associated with the selected entity is launched on the electronic device 500 after initiating a process to download the application to the electronic device 500 (e.g., within an applications marketplace/store, as discussed in more detail later).

In some embodiments, as shown in FIG. 10E, the user interface 1042 includes a visual indication 1041 that the entity (e.g., Airline 1) is configured to access the one or more features associated with the findable item Frank's Suitcase (e.g., that the airline is an integrated airline, as discussed above). In some embodiments, as shown in FIG. 10E, the user interface 1042 includes selectable option 1043 that is selectable to initiate a process to associate the findable item with a particular time-bounded event operated by the entity, as discussed below.

In FIG. 10E, while displaying the user interface 1042, the electronic device 500 detects a selection of the selectable option 1043. For example, as shown in FIG. 10E, the electronic device 500 detects a tap of contact 1003 on the touchscreen 504 at a location corresponding to the selectable option 1043.

In some embodiments, as shown in FIG. 10F, in response to detecting the selection of the selectable option 1043, the electronic device 500 displays user interface 1044 for associating the findable item Frank's Suitcase with a particular time-bounded event operated by the entity (e.g., a particular flight operated by Airline 1). For example, as shown in FIG. 10F, the user interface 1044 includes a first representation 1046a corresponding to a first time-bounded event (e.g., a first flight “Flight 822”) and a second representation 1046b corresponding to a second time-bounded event (e.g., a second flight “Flight 220”) operated by the entity (e.g., Airline 1). In some embodiments, the first representation 1046a and the second representation 1046b are selectable to associate the findable item Frank's Suitcase with the corresponding time-bounded event. In some embodiments, the first time-bounded event (e.g., Flight 822) and the second time-bounded event (e.g., Flight 220) correspond to time-bounded events in which the user previously participated (e.g., or was scheduled to participate in). For example, the user traveled from Los Angeles to San Francisco via Flight 822 and traveled from San Francisco to Los Angeles via Flight 220.

In FIG. 10F, the electronic device 500 has detected a selection of the first representation 1046a in the user interface 1044. For example, as shown in FIG. 10F, the electronic device 500 has detected a tap of contact 1003a on the touchscreen 504 at a location corresponding to the first representation 1046a. In some embodiments, as shown in FIG. 10F, in response to detecting the selection of the first representation 1046a, the electronic device 500 associates the findable item Frank's Suitcase with the first time-bounded event (e.g., Flight 822), indicating that the findable item was lost during the first time-bounded event (e.g., prior to and/or after a conclusion of Flight 822, but while the findable item Frank's Suitcase was in the care of Airline 1 (e.g., employees of Airline 1)). Additionally, in some embodiments, as shown in FIG. 10F, the electronic device 500 displays the first representation 1046a with selection indicator 1019 (e.g., checkmark and/or box outline) indicating the selection discussed above. In some embodiments, if the electronic device 500 additionally or alternatively detects a selection of the second representation 1046b (e.g., such as via a tap of the contact 1003c) in the user interface 1044, the electronic device 500 associates the findable item with the second time-bounded event (e.g., Flight 220) in addition to or alternatively to associating the findable item with the first time-bounded event as discussed above. Additionally, in some embodiments, the electronic device 500 displays the second representation 1046b with the selection indicator 1019 discussed above.

In FIG. 10F, after associating the findable item with the first time-bounded event (e.g., Flight 822), the electronic device 500 detects a selection of selectable option 1045 in the user interface 1044, such as via a tap of contact 1003b. In some embodiments, the selectable option 1045 is selectable to initiate a process to associate the findable item Frank's Suitcase with baggage information known by the entity (e.g., Airline 1), as discussed below.

In some embodiments, as shown in FIG. 10G, in response to detecting the selection of the selectable option 1045, the electronic device 500 displays user interface 1048 for associating the findable item with baggage/luggage information known by the entity. For example, as shown in FIG. 10G, the user interface 1048 includes first representation 1050a corresponding to first luggage (e.g. Luggage 1) and second representation 1050b corresponding to second luggage (e.g., Luggage 2). In some embodiments, the first luggage and the second luggage correspond to luggage (e.g., bags, suitcases, briefcases, backpacks, and/or duffle bags) known to the entity (e.g., Airline 1). For example, Luggage 1 and Luggage 2 correspond to luggage checked in to Airline 1 on Flight 822 (e.g., selected previously in FIG. 10F). Accordingly, in some embodiments, the first representation 1050a and the second representation 1050b include baggage information, such as the baggage identification codes/numbers assigned to the first luggage and the second luggage by the entity.

In FIG. 10G, the electronic device 500 has detected a selection of the first representation 1050a in the user interface 1048. For example, as shown in FIG. 10G, the electronic device 500 has detected a tap of contact 1003a on the touchscreen 504 at a location corresponding to the first representation 1050a. In some embodiments, as shown in FIG. 10G, in response to detecting the selection of the first representation 1050a, the electronic device 500 associates the findable item Frank's Suitcase with the first luggage (e.g., Luggage 1), indicating that the findable item (e.g., the remote locator object) is attached or fixed to the first luggage that was checked in to the entity (e.g., Airline 1) for the first time-bounded event (e.g., Flight 822) discussed above. In other words, Frank's Suitcase corresponds to Luggage 1 in the example of FIG. 10G. Additionally, in some embodiments, as shown in FIG. 10G, as similarly described herein, the electronic device 500 displays the first representation 1050a with selection indicator 1019 (e.g., checkmark and/or box outline) indicating the selection discussed above. In some embodiments, if the electronic device 500 additionally or alternatively detects a selection of the second representation 1050b (e.g., such as via a tap of the contact 1003c) in the user interface 1048, the electronic device 500 associates the findable item with the second luggage (e.g., Luggage 2) in addition to or alternatively to associating the findable item with the first luggage as discussed above. Additionally, in some embodiments, the electronic device 500 displays the second representation 1050b with the selection indicator 1019 discussed above.

In FIG. 10G, after associating the findable item with the first luggage (e.g., Luggage 1), the electronic device 500 detects a selection of selectable option 1049 in the user interface 1048, such as via a tap of contact 1003b. In some embodiments, the selectable option 1049 is selectable to initiate a process to submit additional details regarding the lost item with which the findable item is attached (e.g., descriptive details of Luggage 1) for enabling the entity (e.g., Airline 1) in retrieving the lost item, as discussed below.

In some embodiments, as shown in FIG. 10H, in response to detecting the selection of the selectable option 1049, the electronic device 500 displays user interface 1052 for providing additional details corresponding to the findable item Frank's Suitcase (e.g., particularly the luggage/bag to which the remote locator object is attached or affixed). In some embodiments, as shown in FIG. 10H, the user interface 1052 includes a first option 1053a that is selectable to enable the user to provide a bag type associated with the first luggage (e.g., Luggage 1 selected in FIG. 10G). For example, selection of the first option 1053a enables the user to upload a photo or video of the first luggage and/or enables the user to select from a dropdown list of bag types (e.g., rolling suitcase, briefcase, duffel bag, and/or backpack). In some embodiments, the user interface 1052 includes second option 1053b that is selectable to enable the user to select a color of the first luggage, as discussed below. In some embodiments, the user interface 1052 includes third option 1053c that is selectable to enable the user to select a brand of the first luggage. For example, selection of the third option 1053c, causes the electronic device 500 to display a dropdown list or menu of selectable luggage brands, a text-entry field into which to enter the name of the brand, and/or a search field via which to search the brand of the first luggage. In some embodiments, as shown in FIG. 10H, the user interface 1052 includes fourth option 1053d that is selectable to enable the user to specify additional key features of the first luggage, such as adornments, ribbon, tags, or other decorative pieces attached to the first luggage. For example, selection of the fourth option 1053d causes the electronic device 500 to display a text-entry field into which to enter the additional key features.

In FIG. 10H, while displaying the user interface 1052, the electronic device 500 detects a selection of the second option 1053b. For example, as shown in FIG. 10H, the electronic device 500 detects a tap of contact 1003 on the touchscreen 504 at a location corresponding to the second option 1053b.

In some embodiments, as shown in FIG. 10I, in response to detecting the selection of the second option 1053b, the electronic device 500 displays a plurality of colors 1055a-1055d from which to select the color of the first luggage in the user interface 1052. For example, as illustrated in FIG. 10I, the electronic device 500 displays a drop-down menu/list of colors that are selectable to indicate the color of the lost item (e.g., optionally as a scrollable list). In FIG. 10I, while displaying the plurality of colors 1055a-1055d, the electronic device 500 detects a selection of first color 1055a (e.g., Black) in the user interface 1052. For example, as shown in FIG. 10I, the electronic device 500 detects a tap of contact 1003a on the touchscreen 504 at a location corresponding to the first color 1055a, which designates the first luggage as having a black color to the entity (e.g., Airline 1).

In some embodiments, as shown in FIG. 10I, the user interface 1052 includes submit option 1054. In some embodiments, the submit option 1054 is selectable to provide the entity (e.g., Airline 1) access to the one or more features associated with the findable item. For example, the one or more features include the details associated with the findable item discussed above with reference to FIGS. 10F-101, such as the name, type, color, and/or brand of the lost luggage, the flight during which the luggage was lost, and/or the baggage information for the luggage. In FIG. 101, the electronic device detects a selection of the submit option 1054, such as via a tap of contact 1003b.

In some embodiments, as shown in FIG. 10J, in response to detecting the selection of the submit option 1054, the electronic device 500 provides the entity (e.g., Airline 1) access to the one or more features associated with the findable item Frank's Suitcase. For example, the details associated with the findable item are submitted as a form or other document to Airline 1 for aiding Airline 1 in retrieving the findable item. In some embodiments, as shown in FIG. 10J, when the entity is provided access to the one or more features associated with the findable item, the electronic device 500 displays user interface 1058 confirming the findable item as being reported as lost to the entity. In some embodiments, as shown in FIG. 10J, the user interface 1058 includes tracking information 1059, such as a tracking number or code, for the findable item Frank's Suitcase. In some embodiments, the tracking information 1059 enables the user to easily track a progress of the retrieval of the findable item by the entity. For example, the tracking information 1059 is presented as a selectable link or option in the user interface 1058 (e.g., and/or shared with the user via email or text). In some embodiments, the user is able to track the progress of the retrieval of the findable item via a tracking page within the entity application (e.g., Airline 1 App).

In FIG. 10J, after providing the entity access to the one or more features associated with the findable item, the electronic device 500 detects selection of option 1060 in the user interface 1058. For example, as shown in FIG. 10J, the electronic device 500 detects a tap of contact 1003 on the touchscreen 504 at a location corresponding to the option 1060. In some embodiments, the option 1060 is selectable to cause the electronic device 500 to redisplay the user interface 1002 or 1012 associated with the item locating application (e.g., Object Finding App) in FIG. 10A or 10B. In some embodiments, the option 1060 is selectable to cause the electronic device 500 to navigate to a landing page or home page within the entity application (e.g., Airline 1 App). For example, in response to detecting the selection of the option 1060 in the user interface 1058, the electronic device 500 displays user interface 650 in FIG. 6H.

As described previously above with reference to FIG. 10C, a respective entity is integrated or non-integrated (e.g., with respect to accessibility of the one or more features associated with the findable item). In some embodiments, rather than provide the entity access to the one or more features associated with the findable item via an application associated with the entity in the manner discussed above, if a respective entity is non-integrated, the electronic device 500 provides access to a subset of the one or more features associated with the findable item via a shareable link, as discussed below. For example, in FIG. 10K, while displaying the user interface 1022 associated with the item locating application (e.g., Object Finding App), the electronic device 500 detects a selection of representation 1023a corresponding to a non-integrated entity (e.g., Airline X). In some embodiments, after selecting the non-integrated entity (e.g., Airline X), the electronic device 500 detects a selection of the selectable option 1026 discussed previously above. Alternatively, in FIG. 10L, while displaying the user interface 1022 associated with the item locating application, the electronic device 500 receives a query for Airline Y, indicated by text 1015 in search field 1024. As illustrated in FIG. 10L by the absence of search results, the Airline Y does not correspond to an integrated entity (e.g., an integrated airline), and does not correspond to a known non-integrated entity (e.g., a non-integrated airline). Accordingly, as shown in FIG. 10L, the electronic device 500 detects a selection of the selectable option 1028, such as via a tap of contact 1003, in the user interface 1022.

In some embodiments, in response to the selection of a non-integrated entity as illustrated by way of example in FIG. 10K and FIG. 10L, the electronic device 500 initiates a process to provide access to a sharable link via which to access a subset of the one or more features associated with the findable item discussed above. For example, as discussed below, the link, if shared with the non-integrated entity, enables the entity to access one or more first features associated with the findable item Frank's Suitcase, such as the location of the findable item, but not one or more second features associated with the findable item Frank's Suitcase, such as the name of the findable item or the name of the user.

In some embodiments, as shown in FIG. 10M, in response to detecting the selection of non-integrated Airline Y, for example, the electronic device 500 displays user interface 1062 informing the user that the selected airline corresponds to a non-integrated airline as discussed above. In FIG. 10M, the electronic device 500 detects a selection of selectable option 1063 in the user interface, such as via a tap of contact 1003, which is selectable to continue with the process of providing access to the sharable link described above.

In some embodiments, as shown in FIG. 10N, the process of providing access to the sharable link includes displaying user interface 1064. In some embodiments, as indicated in FIG. 10N, the user interface 1064 is associated with the item locating application (e.g., Object Finding App) and is optionally not associated with an application of the non-integrated entity (e.g., an application of Airline Y). As shown in FIG. 10N, the user interface 1064 includes a summary 1067 of information that will become visible and/or accessible to the non-integrated entity (e.g., Airline Y) if the link is generated and shared with the entity. For example, as indicated in FIG. 10N, the one or more first features associated with the findable item Frank's Suitcase that will become accessible to Airline Y via the shared link include a location of the findable item and contact information (e.g., phone number) of the user (e.g., the owner of the findable item). Additionally, in some embodiments, as shown in FIG. 10N, the user interface 1064 includes an indication of the location of the findable item. For example, the user interface 1064 includes a representation of a map 1065 that includes the current location of the findable item, indicated by location of indication 1066 corresponding to the findable item Frank's Suitcase.

In FIG. 10N, while displaying the user interface 1064, the electronic device 500 detects a selection of selectable option 1068, such as via a tap of contact 1003. In some embodiments, selection of the selectable option 1068 corresponds to a confirmation of proceeding with generation of the sharable link.

In some embodiments, as shown in FIG. 10O, in response to detecting the selection of the selectable option 1068, the electronic device 500 displays user interface 1070 confirming generation of the link. In some embodiments, as indicated in FIG. 10O, the one or more first features associated with the findable item Frank's Suitcase are accessible to the non-integrated entity within a website corresponding to the link, as discussed below. In some embodiments, as shown in FIG. 10O, after the link has been generated, the link is not shared with the non-integrated entity (e.g., Airline Y) until input is detected for sharing the link with the non-integrated entity. For example, as shown in FIG. 10O, the user interface 1070 includes share option 1071 that is selectable to share the link with the non-integrated entity (e.g., Airline Y).

In FIG. 10O, while displaying the user interface 1070, the electronic device 500 detects a selection of the share option 1071. For example, as shown in FIG. 10O, the electronic device 500 detects a tap of contact 1003 on the touchscreen 504 at a location corresponding to the share option 1071. In some embodiments, as mentioned above, in response to detecting the selection of the share option 1071 in the user interface 1070, the electronic device 500 shares the link with the entity that enables the entity to access the one or more first features associated with the findable item Frank's Suitcase.

In some embodiments, sharing the link with the entity (e.g., Airline Y) includes displaying user interface 1072, as shown in FIG. 10P. For example, as shown in FIG. 10P, when sharing the link with the entity (e.g., in response to detecting the selection of the share option 1071 in FIG. 10O), the electronic device 500 displays a plurality of options that is selectable to share the link with a designated recipient, such as Airline Y. In some embodiments, the plurality of options includes a first option 1076a, a second option 1076b, a third option 1076c, a fourth option 1076d, and a fifth option 1076c. Additionally, in some embodiments, as shown in FIG. 10P, the user interface 1072 includes an indication 1073 (e.g., name) of the findable item with which the link is associated, an indication of a current location of the findable item 1074a (e.g., San Francisco International Airport), an indication of when the location of the findable item was last updated 1074b (e.g., Now), and a representation of the link 1075.

It should be noted that, in response to detecting the selection of the selectable option 1063 in FIG. 10M, the electronic device 500 need not display the user interfaces illustrated in FIGS. 10N-100. For example, in response to detecting the selection of the selectable option 1063 in FIG. 10M, the electronic device 500 displays the user interface 1072 shown in FIG. 10P (e.g., without requiring the user to provide the inputs selecting the selectable option 1068 in FIG. 10N and the share option 1071 in FIG. 10O). Accordingly, the display of the user interfaces 1064 and 1070 discussed above is optional.

In some embodiments, the first option 1076a in the user interface 1072 is selectable to share the link with one or more recipients (e.g., such as Airline Y) via wireless file/data sharing. For example, in FIG. 10P, in response to detecting a selection of the first option 1076a, such as via a tap of contact 1003a, the electronic device 500 displays wireless transfer region 1077 in the user interface 1072, as shown in FIG. 10Q. In some embodiments, as shown in FIG. 10Q, the wireless transfer region 1077 includes a plurality of icons that is selectable to wirelessly share the file with a respective electronic device that is in close range to the electronic device 500. For example, in FIG. 10Q, the wireless transfer region 1077 includes a first icon 1078 corresponding to a first electronic device (e.g., Tablet 1) that is selectable to share the link wirelessly with the first electronic device. In some embodiments, the first electronic device is associated with the user of the electronic device 500 (e.g., is also owned by the user). In some embodiments, the wireless transfer region 1077 includes a second icon 1078b and a third icon 1078c corresponding to respective electronic devices that are proximate to the electronic device 500 (e.g., Megan's Phone and Megan's Laptop) and that have wireless transfer enabled. In some embodiments, the second icon 1078b and the third icon 1078c are selectable to share the link wirelessly with the respective electronic devices belonging to Megan.

In some embodiments, returning to FIG. 10P, the second option 1076b in the user interface 1072 is selectable to share the link with one or more recipients (e.g., such as Airline Y) via a messaging application on the electronic device 500. For example, in FIG. 10P, in response to detecting a selection of the second option 1076b, such as via a tap of contact 1003b, the electronic device 500 initiates sharing of the link via one or more messages within the messaging application, as shown in FIG. 10R. In some embodiments, as shown in FIG. 10R, the electronic device 500 displays messaging user interface 1080 associated with the messaging application (e.g., Messages App). For example, as shown in FIG. 10R, an indication 1082 of a current location of the findable item and the link are transmitted to the non-integrated entity (e.g., Airline Y) in a first message 1081a and a second message 1081b.

In some embodiments, returning to FIG. 10P, the third option 1076c in the user interface 1072 is selectable to share the link with one or more recipients (e.g., such as Airline Y) via an email application on the electronic device 500. For example, in FIG. 10P, in response to detecting a selection of the third option 1076c, such as via a tap of contact 1003c, the electronic device 500 initiates sharing of the link via an email (e.g., displays the link in a body of the email) within the email application, as discussed in more detail with reference to method 1100. In some embodiments, in FIG. 10P, the fourth option 1076d is selectable to copy the link for pasting the link into a text-entry field of a separate application. For example, in FIG. 10P, in response to detecting a selection of the fourth option 1076d, such as via a tap of contact 1003d, the electronic device 500 (e.g., temporarily) stores the link in memory of the electronic device 500, as discussed in more detail with reference to method 1100. In some embodiments, in FIG. 10P, the fifth option 1076e is selectable convert the link (e.g., represented at 1075) to a scannable and/or machine-readable code or image (e.g., barcode, quick-response (QR) code, and/or other matrix code). For example, in FIG. 10P, in response to detecting a selection of the fifth option 1076c, such as via a tap of contact 1003c, the electronic device 500 converts the sharable link to a QR code that is able to be shared with one or more recipients (e.g., such as Airline Y), as shown in FIG. 10S. In some embodiments, as shown in FIG. 10S, the electronic device 500 displays user interface 1084 that includes QR code 1085 (or other scannable code or image) and share option 1086 that is selectable to initiate a process to share the QR code in one or more of the manners discussed above.

In some embodiments, as described herein, the link, when shared with the non-integrated entity (e.g., Airline Y), provides access to one or more first features associated with the findable item Frank's Suitcase. Particularly, in some embodiments, the access to the one or more first features is provided within a webpage corresponding to the link. For example, when the non-integrated entity or other recipient receives the link after the link has been shared in one or more of the manners discussed above, the link is selectable to navigate to a dedicated webpage (e.g., within a web browsing application) for the findable item Frank's Suitcase. As shown in FIG. 10T, as an example, electronic device 510 (e.g., different from the electronic device 500) is displaying, via display 514, web page 1088 (e.g., within a web browsing application) corresponding to the findable item Frank's Suitcase. As mentioned above, the web page 1088 optionally includes information corresponding to the one or more features associated with the findable item Frank's Suitcase. For example, as shown in FIG. 10T, the web page 1088 includes a representation of a map 1065 corresponding to a physical region of the findable item and an indication 1066 of the current location of the findable item within the physical region. In some embodiments, as shown in FIG. 10T, the web page 1088 includes a user ID 1089a (e.g., email address) associated with the user (e.g., the owner of the findable item Frank's Suitcase), without including a name or other personally identifiable information of the user (e.g., user's address). In some embodiments, as shown in FIG. 10T, the web page 1088 includes the current and/or last known location of the findable item (1089b), which is optionally San Francisco International Airport in the example of FIG. 10T. In some embodiments, in FIG. 10T, the web page 1088 includes a time at which the location of the findable item was last updated (1089c), coordinates corresponding to the location of the findable item (1089d), and/or an indication of the accuracy of the coordinates (1089c). It should be understood that the information illustrated in FIG. 10T is exemplary and that additional and/or alternative information corresponding to the findable item is provided in the web page 1088, such as the information described in method 1100.

In some embodiments, access to the one or more first features associated with the findable item via the link discussed above is limited to a respective access request threshold. For example, the link, when shared with the non-integrated entity (e.g., Airline Y), is able to be selected/activated a certain number of times and/or by a certain number or group of individuals associated with the entity (e.g., employees of Airline Y). Additionally, in some embodiments, access to the information in the web page 1088 in FIG. 10T requires authentication of a user access credential. For example, prior to displaying the web page 1088, the electronic device 510 prompts a respective user to enter a username and password or to provide a valid email address or other identifier.

In some embodiments, when sharing the link with the non-integrated entity (e.g., Airline Y) that provides the non-integrated entity access to the one or more first features associated with the findable item Frank's Suitcase, the electronic device 500 generates an alert (e.g., a notification) prior to the sharing of the link in accordance with a determination that the location of the findable item corresponds to the current location of the electronic device 500. For example, in FIG. 10U, in accordance with a determination that the user is in possession of the findable item Frank's Suitcase (e.g., the findable item is within a threshold distance (e.g., 0.05, 0.1, 0.5, 0.75, 1, 2, 3, 5, 10 or 20 meters) of the electronic device 500), the electronic device 500 displays alert 1091 informing the user that the findable item is detected as being with the user (e.g., and before sharing the link with the non-integrated entity). In some embodiments, as shown in FIG. 10U, the alert 1091 includes selectable option 1092 that is selectable to cease display of the alert 1091 and optionally forgo sharing the link with the non-integrated entity. For example, in FIG. 10U, in response to detecting a selection of the selectable option 1092, such as via a tap of contact 1003, the electronic device 500 ceases display of the alert 1091 and redisplays user interface 1070 in FIG. 10O.

In some embodiments, when sharing the link with the non-integrated entity (e.g., Airline Y) that provides the non-integrated entity access to the one or more first features associated with the findable item Frank's Suitcase, the electronic device 500 generates an alert (e.g., a notification) prior to the sharing of the link in accordance with a determination that the location of the findable item recently corresponded to the current location of the electronic device 500. For example, in FIG. 10V, in accordance with a determination that the user was in possession of the findable item recently (e.g., within a threshold amount of time, such as within the last 1, 2, 5, 10, 15, or 30 minutes, or 1, 2, 6, 12, or 24 hours), the electronic device 500 displays alert 1093 informing the user that the findable item was detected as having recently been with the user (e.g., and before sharing the link with the non-integrated entity). In some embodiments, as shown in FIG. 10V, the alert 1093 includes first option 1094a that is selectable to continue with sharing the link with the non-integrated entity. For example, in FIG. 10V, in response to detecting a selection of the first option 1094a, such as via a tap of contact 1003a, the electronic device 500 proceeds with sharing the link with Airline Y (e.g., optionally displaying user interface 1072 in FIG. 10P). In some embodiments, the alert 1093 includes second option 1095b that is selectable to cease display of the alert 1093 and optionally forgo sharing the link with the non-integrated entity. For example, in FIG. 10V, in response to detecting a selection of the second option 1095b, such as via a tap of contact 1003b, the electronic device 500 ceases display of the alert 1093 and redisplays user interface 1070 in FIG. 10O.

In some embodiments, when sharing the link with the non-integrated entity (e.g., Airline Y) that provides the non-integrated entity access to the one or more first features associated with the findable item Frank's Suitcase, the electronic device 500 generates an alert (e.g., a notification) prior to the sharing of the link in accordance with a determination that the last known location of the findable item is from more than a threshold time ago (e.g., longer than 1, 2, 6, 12, 24, 48, 72, or 96 hours). For example, in FIG. 10W, in accordance with a determination that the last known location of the findable item is from more than the threshold time ago, the electronic device 500 displays alert 1096 informing the user that the last known location of the findable item is too old (e.g., and before sharing the link with the non-integrated entity). In some embodiments, as shown in FIG. 10W, the alert 1096 includes selectable option 1097 that is selectable to cease display of the alert 1096 and optionally forgo sharing the link with the non-integrated entity (e.g., Airline Y). For example, in FIG. 10W, in response to detecting a selection of the selectable option 1097, such as via a tap of contact 1003, the electronic device 500 ceases display of the alert 1096 and redisplays user interface 1070 in FIG. 10O.

In some embodiments, after providing access to the integrated entity (e.g., Airline 1) to the one or more features associated with the findable item Frank's Suitcase or after sharing the link with the non-integrated entity (e.g., Airline Y) that provides the non-integrated entity access to a subset of the one or more features associated with the findable item, the electronic device 500 detects an input to redisplay the user interface 1012 described previously above, such as the selection of option 1060 in FIG. 10J. In FIG. 10X, while displaying the user interface 1012, the electronic device 500 detects a selection of the second option 1013b. For example, as shown in FIG. 10X, the electronic device 500 detects a tap of contact 1003 on the touchscreen 504 at a location corresponding to the second option 1013b.

As discussed above, the input directed to the second option 1013b in the user interface 1012 is detected after at least the one or more first features associated with the findable item are made accessible to the entity. Accordingly, as shown in FIG. 10Y, in response to detecting the selection of the second option 1013b, the electronic device 500 displays user interface 1018. In some embodiments, as shown in FIG. 10Y, in accordance with a determination that the entity is the non-integrated entity (e.g., Airline Y), the user interface 1018 includes a representation of the link 1075 that has been shared with the non-integrated entity. Additionally, as shown in FIG. 10Y, the user interface 1018 includes first option 1009a and second option 1009b. In some embodiments, the first option 1009a is selectable to initiate a process to share the link represented at 1075. For example, in response to detecting a selection of the first option 1009a, such as via a tap of contact 1003a, the electronic device 500 displays one or more of the share options of user interface 1072 in FIG. 10P. In some embodiments, the second option 1009b is selectable to cease providing access to the one or more first features associated with the findable item. For example, in FIG. 10Y, in response to detecting a selection of the second option 1009b, such as via a tap of contact 1003b, the electronic device 500 causes the link to become expired and/or otherwise causes the access to the one or more first features associated with the findable item to be revoked.

In some embodiments, as shown in FIG. 10Z, in accordance with a determination that the access to the one or more first features associated with the findable item is terminated, the user interface 1018 includes selectable option 1017 (e.g., in place of the first option 1009a and the second option 1009b in FIG. 10Y). In some embodiments, the access to the one or more first features associated with the findable item is terminated in response to receiving user input, such as the selection of the second option 1009b in FIG. 10Y. In some embodiments, the access to the one or more first features associated with the findable item is terminated after detecting that a threshold amount of time (e.g., 1 hour, 2 hours, 5 hours, 12 hours, 24 hours, 48 hours, 72 hours, or 1 week) has elapsed since the access was first provided. Additionally examples of criteria for terminating access to the one or more first features associated with the findable item are provided in method 1100. In some embodiments, the selectable option 1017 is selectable to initiate a process to renew access to the one or more first features associated with the findable item via the link. For example, in FIG. 10Z, in response to detecting a selection of the selectable option 1017, such as via a tap of contact 1003, the electronic device 500 renews access for the non-integrated entity to the one or more first features associated with the findable item via the link, as discussed in method 1100.

In some embodiments, as shown in FIG. 10AA, in accordance with a determination that the entity is the integrated entity (e.g., Airline 1), the user interface 1018 includes a visual indication (e.g., name and/or logo) of the integrated entity 1004 that has been granted access to the one or more features associated with the findable item. Additionally, in some embodiments, as shown in FIG. 10AA, the user interface 1018 includes first option 1007a and second option 1007b. In some embodiments, the first option 1007a is selectable to navigate to a user interface of an application associated with the entity (e.g., Airline 1 App above), such as via tap of contact 1003a. In some embodiments, the second option 1007b is selectable to terminate the access to the one or more features associated with the findable item for the entity, as similarly discussed above.

In some embodiments, in accordance with a determination that the application associated with the integrated entity is not downloaded to the electronic device 500 (e.g., but is available to download), the user interface 1018 includes third option 1007c (e.g., in place of the first option 1007a in FIG. 10AA). In some embodiments, the third option 1007c is selectable (e.g., via a tap of contact 1003a) to launch an application marketplace/store from which to download the application associated with the integrated entity (e.g., Airline 1 App).

In FIG. 10BB, the electronic device 500 detects a selection of done option 1011 in the user interface 1018. For example, as shown in FIG. 10BB, the electronic device 500 detects a tap of contact 1003c on the touchscreen 504 at a location corresponding to the done option 1011. In some embodiments, in response to detecting the selection of the done option 1011, the electronic device 500 redisplays the user interface 1012 in FIG. 10X.

FIG. 10CC illustrates the user interface 1002 of the item locating application (e.g., Object Finding App), described previously above with reference to FIG. 10A. In some embodiments, after providing access to the one or more features associated with the findable item Frank's Suitcase to the integrated entity or after providing access to the one or more first features associated with the findable item to the non-integrated entity via the link, the electronic device 500 updates display of the first item 1010b corresponding to Frank's Suitcase in the list 1008. Particularly, as shown in FIG. 10CC, the first item 1010b includes visual indication 1001 indicating that lost mode has been activated for the findable item Frank's Suitcase (e.g., because the findable item has been reported as lost to the integrated entity or the non-integrated entity in the manners discussed previously herein). As shown in FIG. 10CC, because the second item 1010c (e.g., Frank's Keys) and the third item 1010a (e.g., Frank's Wireless Headphones) have not been reported as lost, the second item 1010c and the third item 1010a are not displayed with the visual indication 1001 in the list 1008.

It should be understood that, in some embodiments, the above-described approaches of providing access to one or more features associated with the findable item Frank's Suitcase may be similarly applied for one or more of the other findable items owned by the user (e.g., the findable items represented in FIGS. 10A and 10CC) and/or for other time-bounded events (e.g., train rides, bus rides, and/or rideshare events).

FIG. 11 is a flow diagram illustrating a method 1100 of facilitating providing access to one or more features associated with a remote locator object to an entity, in accordance with some embodiments of the disclosure, such as in FIGS. 10A-10CC. The method 1100 is optionally performed at an electronic device such as device 100, device 300, device 500 as described above with reference to FIGS. 1A-1B, 2-3, 4A-4B and 5A-5H. Some operations in method 1100 are, optionally combined and/or order of some operations is, optionally, changed.

As described below, the method 1100 provides ways to provide access to one or more features associated with a remote locator object to an entity for locating a lost item that is associated with the remote locator object. The method reduces the cognitive burden on a user when interaction with a user interface of the device of the disclosure, thereby creating a more efficient human-machine interface. For battery-operated electronic devices, increasing the efficiency of the user's interaction with the user interface conserves power and increases the time between battery charges.

In some embodiments, method 1100 is performed at an electronic device (e.g., electronic device 500) in communication with a trackable object, a display generation component (e.g., touch screen display 504), and one or more input devices. For example, the electronic device is a mobile device (e.g., a tablet, a smartphone, a media player, or a wearable device) including a touch screen and wireless communication circuitry, or a computer including one or more of a keyboard, mouse, trackpad, and touch screen and wireless communication circuitry. In some embodiments, the electronic device has one or more characteristics of the electronic device in methods 700 and/or 900. In some embodiments, the trackable object has one or more characteristics of the trackable object in methods 700 and/or 900. In some embodiments, the display generation component has one or more characteristics of the display generation component in methods 700 and/or 900. In some embodiments, the one or more input devices have one or more characteristics of the one or more input devices in methods 700 and/or 900.

In some embodiments, while displaying, via the display generation component, a user interface associated with the trackable object, the electronic device detects (1102), via the one or more input devices, a first input corresponding to a request to report an item (e.g., a physical object) associated with the trackable object as lost to an entity (e.g., an organization or business, as similarly described with reference to methods 700 and/or 900), such as selection of second option 1013b in FIG. 10B. In some embodiments, the user interface associated with the trackable object has one or more characteristics of the user interfaces discussed with references to methods 700 and/or 900. For example, the user interface is an item finding user interface or a user interface of an application associated with the entity. In some embodiments, the trackable object is associated with (e.g., attached to) the item, such as attached to a bag, backpack, suitcase, purse, wallet bag, or other personal item belonging to or otherwise associated with a user of the electronic device (e.g., and optionally the owner of the trackable object), as similarly discussed with reference to methods 700 and/or 900. In some embodiments, the user provides the first input at a conclusion of and/or after the end of a time-bounded event (e.g., a travel event), such as the time-bounded events described with reference to methods 700 and/or 900. For example, at the conclusion of and/or after the time-bounded event (e.g., at the end of a flight, train ride, bus ride, or taxi ride), the user of the electronic device (e.g., and the owner of the item) discovers that the item cannot be found (e.g., the item is not at the baggage terminal that the item should be at). Additionally or alternatively, the user of the electronic device optionally discovers that the item has been lost based on a location of the trackable object (e.g., that is accessible to the user, such as via the item finding user interface discussed above). For example, the electronic device indicates, in the item finding user interface, that the trackable object and thus the item are located at a location that is different from the current location of the user and/or an expected location (e.g., and is optionally a location that the user cannot reach). In some embodiments, the item became lost while the item (and the trackable object attached to the item) was in the care of the entity (e.g., personnel associated with the entity). For example, the item became lost and/or unaccounted for during the time-bounded event for which the entity is responsible. In some embodiments, the first input includes selection of a selectable option for reporting the item as lost to the entity, wherein the selectable option is displayed in the user interface associated with the trackable object. For example, the first input includes a click, push, press, swipe, or the like detected, for example, via a touch-sensitive surface, a stylus, a keyboard or a mouse, that is directed to the selectable option. In some embodiments, the first input has one or more characteristics of inputs described with reference to methods 700 and/or 900.

In some embodiments, in response to detecting the first input (1104), in accordance with a determination that one or more criteria are satisfied, the electronic device provides (1106) access to a link (e.g., a web-based link that is selectable to initiate display of a website that includes information that can be used to locate the trackable object) that, such as the link represented at 1075 in FIG. 10P, if shared with the entity, would enable (e.g., grant permission to) the entity to access one or more first features associated with the trackable object for locating the trackable object (e.g., information corresponding to a location of the trackable object), without enabling (e.g., granting permission to) the entity to access one or more second features associated with the trackable object, wherein the one or more second features associated with the trackable object are different from the one or more first features associated with the trackable object, as similarly described with reference to web page 1088 in FIG. 10T. In some embodiments, when the electronic device provides access to the link that enables the entity to access the one or more first features associated with the trackable object, the electronic device displays a visual indication of the link. For example, the electronic device displays all or a portion of the link, an image associated with the link, and/or a hyperlink associated with the link in the user interface discussed above or in a different user interface (e.g., a user interface dedicated to the generation of the link and/or a user interface of a web-browsing application). In some embodiments, the link is generated by the electronic device. In some embodiments, the link is generated by and/or at a server (e.g., a wireless communications terminal) in communication with the electronic device and the entity (e.g., in response to receiving a signal or other instruction from the electronic device to generate the link). In some embodiments, the link is generated and/or updated periodically (e.g., every 30 seconds, every minute, every 5 minutes, every 15 minutes, every 30 minutes, every hour, every 6 hours, and/or every 1 day). In some embodiments, the electronic device generates the link that enables the entity to access the one or more first features associated with the trackable object without transmitting (e.g., from the electronic device or from a server that is in communication with the electronic device) the link to the entity. For example, as discussed in more detail below, when the electronic device generates the link, the electronic device displays one or more options that are selectable to initiate a process to transmit (e.g., share) the link with the entity or other user-designated recipient(s). In some embodiments, as discussed in more detail below, after the link has been shared with (e.g., transmitted to) the entity, access to the link (e.g., and subsequently the one or more first features associated with the trackable object) is provided based on access credentials. For example, the generated link is accessible to the entity via a unique username and/or password and/or to a predetermined number of personnel associated with the entity (e.g., the access is rate limited). In some embodiments, as discussed in more detail below, the one or more criteria are based on and/or are related to a current or last known location of the trackable object and/or a status of recovery of the trackable object. For example, the one or more criteria are not satisfied if the trackable object has been located (e.g., by the user or by the entity). As another example, the one or more criteria are not satisfied if a last known location (e.g., known by the electronic device, according to tracking information determined by the electronic device) of the trackable object was known more than a threshold amount of time ago, such as more than 1 hour ago, more than 6 hours ago, more than 12 hours ago, more than 1 day ago, and/or more than 3 days ago. In some embodiments, the one or more criteria are based on the entity's ability to access the one or more first features and/or the one or more second features associated with the trackable object for locating the trackable object. For example, the one or more criteria are satisfied if the entity is not configured to and/or is incapable of accessing the features associated with the trackable object (e.g., the second features of the trackable object). In some embodiments, the ability of the entity to access the features of the trackable object is based on configuration of electronic devices or other computer systems associated with the entity and/or compatibility of the electronic devices or other computer systems associated with the entity with the features associated with the trackable object, such as the features discussed below. In some embodiments, the ability of the entity to access the features associated with the trackable object is based on operability authorization (e.g., whether the entity is a known or trusted entity to the electronic device, such as based on user preferences, user activity, and/or other permissions).

In some embodiments, as discussed in more detail below, after the link has been generated and/or after the link has been shared with the entity, the link remains active for a predetermined amount of time and/or for a user-defined amount of time (e.g., until the user reports the item as found to the entity). In some embodiments, enabling the entity to access one or more first features associated with the trackable object includes enabling the entity to access the location of the trackable object. For example, the location of the trackable object is a physical location of the trackable object within a physical environment (e.g., the physical environment surrounding the user of the electronic device and/or the physical environment associated with a time-bounded event, as discussed with reference to method 700). In some embodiments, enabling the entity to access the one or more first features associated with the trackable object includes enabling the entity (e.g., users or other personnel associated with the entity, such as employees of the entity) to gain access to the location of the trackable object (e.g., via one or more electronic devices associated with the entity), and thus the personal item to which the trackable object is attached. In some embodiments, enabling the entity to access one or more first features associated with the trackable object includes enabling the entity to access an image associated with the trackable object (or other unique device identifier associated with the trackable object). In some embodiments, the one or more second features associated with the trackable object have one or more characteristics of the one or more features of the trackable object discussed with reference to methods 700 and/or 900. For example, the one or more second features associated with the trackable object include a sound emission feature (e.g., outputting of a ring, chime, or other audible sound) for locating the trackable object and/or a disablement feature (e.g., disabling the trackable object if the trackable object is unable to be located). In some embodiments, the one or more second features associated with the trackable object include a naming/renaming feature (e.g., selecting and/or designating a name or other identifier for the trackable object, such as based on the item to which the trackable object is affixed). In some embodiments, the one or more second features associated with the trackable object include a permissions feature (e.g., adjusting and/or changing one or more permissions associated with the trackable object, such as access to the location of the trackable object, access to the name of the trackable object, and/or access to alerts associated with the trackable object). In some embodiments, the electronic device is able to later (e.g., separately) grant permission to the entity to access the one or more second features associated with the trackable object, as similarly described above with reference to method 900. In some embodiments, in response to detecting the first input, in accordance with a determination that the one or more criteria are not satisfied, the electronic device forgoes providing access to the link that, if shared with the entity, would enable the entity to access the one or more first features associated with the trackable object. For example, the entity is not granted access to the one or more first features associated with the trackable object and the one or more second features associated with the trackable object for locating the trackable object. In some embodiments, in accordance with the determination that the one or more criteria are not satisfied (e.g., because the entity corresponds to an entity that is configured to access the features of the trackable object), the electronic device initiates a process for granting the entity access to the one or more first features and the one or more second features associated with the trackable object, as similarly discussed with reference to method 900. Generating a link that enables an entity to access a location of a trackable object that is owned by a user when the trackable object is reported as lost alerts the entity that the trackable object has been lost and enables persons associated with the entity to efficiently track the location of the trackable object for locating the trackable object, which reduces the need for user input to manually provide object-locating information to the entity and also provides an indication of a status of a recovery of the trackable object, thereby improving user privacy and user-device interaction and reducing user concern regarding the location of the lost trackable object.

In some embodiments, the one or more first features associated with the trackable object provide first information corresponding to the trackable object, without providing second information corresponding to the trackable object that is provided by the one or more second features associated with the trackable object, such as map 1065 that includes the current location of the findable item, user ID 1089a associated with the user, the current and/or last known location of the findable item 1089b, a time at which the location of the findable item was last updated 1089c, and/or coordinates corresponding to the location of the findable item 1089d in FIG. 10T. For example, the information that is accessible via the one or more first features associated with the trackable object (e.g., when/if the link is shared) is more limited than the information that is accessible via the one or more second features associated with the trackable object. In some embodiments, as discussed in more detail below, the information provided via the link does not include and/or includes less personally identifiable information (e.g., identifying the trackable object and/or the owner of the trackable object, such as the user of the electronic device) than would otherwise be provided (e.g., via the one or more second features associated with the trackable object). Generating a link that enables an entity to access a location of a trackable object that is owned by a user when the trackable object is reported as lost, without providing personal information corresponding to the user, alerts the entity that the trackable object has been lost while promoting and/or helping preserve user privacy, thereby improving user-device interaction and reducing user concern regarding the location of the lost trackable object.

In some embodiments, the second information corresponding to the trackable object includes identification information associated with the trackable object, such as the name Frank's Suitcase of the findable item as shown in FIG. 10T. For example, as mentioned above, the identification information associated with the trackable object includes a name, label, image, and/or other information identifying the trackable object (e.g., and/or the item to which the trackable object is affixed) and/or a name, contact information, address(es), and/or other information identifying the owner of the trackable object (e.g., and thus the owner of the item), such as the name of the user of the electronic device. In some embodiments, the first information includes a subset of the second information. For example, the first information corresponding to the trackable object that is provided via the link includes the location of the trackable object and/or an image of the trackable object, without including the name of the trackable object. Additionally, as an example, the first information corresponding to the trackable object includes contact information for the owner of the trackable object (e.g., an email address and/or phone number of the user of the electronic device), without including the name and/or address of the owner of the trackable object. Generating a link that enables an entity to access a location of a trackable object that is owned by a user when the trackable object is reported as lost, without providing personal information corresponding to the user, alerts the entity that the trackable object has been lost while promoting and/or helping preserve user privacy, thereby improving user-device interaction and reducing user concern regarding the location of the lost trackable object.

In some embodiments, after providing the entity with access to the link that enables the entity to access the one or more first features associated with the trackable object, the electronic device detects that one or more second criteria are satisfied. In some embodiments, in response to detecting that the one or more second criteria are satisfied (e.g., different from the one or more criteria discussed above), the electronic device terminates access to the one or more first features associated with the trackable object via the link (e.g., such that the link is expired and/or access to the one or more first features associated with the trackable object via the link is revoked for the entity or other recipient(s)), as visually indicated by selectable option 1017 in FIG. 10Z. For example, access to the one or more first features associated with the trackable object via the link is limited according to the one or more second criteria, as outlined below. In some embodiments, the satisfaction of the one or more second criteria is independent of whether the link is actually shared with the entity (e.g., and/or other recipient). In some embodiments, the electronic device provides a visual indication that the access to the link has been terminated when the one or more second criteria are satisfied. For example, the electronic device displays a notification or other alert that notifies the user that access to the link has been terminated and/or updates the user interface associated with the trackable object discussed above to include an indication (e.g., status update) that the access to the link has been terminated (e.g., that the link is expired). In some embodiments, access to the link is maintained/provided until the one or more second criteria are satisfied. In some embodiments, as discussed in more detail below, the satisfaction of the one or more second criteria is not necessarily dependent on (e.g., is independent of) user input detected at the electronic device. Terminating access to a link that enables an entity to access a location of a trackable object that is owned by a user when one or more criteria are satisfied helps ensure that access to the location of the trackable object is not provided to the entity for longer than necessary for locating the trackable object and/or enables the access to the link to be terminated automatically, which reduces the need for user input to manually terminate the access to the link, thereby improving user privacy and user-device interaction.

In some embodiments, the one or more second criteria include a criterion that is satisfied when a location associated with the electronic device (e.g., the location of the electronic device and/or the location of the user that is associated with the electronic device) is within a threshold distance (e.g., 0.1, 0.2, 0.5, 0.8, 1, 1.2, 1.5, 2, 5, 10, 20 or 40 m) of a location of the trackable object, as similarly described with reference to FIG. 10U. For example, the electronic device terminates access to the one or more first features associated with the trackable object via the link for the entity (e.g., and/or other recipients) in accordance with a determination that the user of the electronic device (e.g., the owner of the trackable object) and the trackable object are within the threshold distance of each other. In some embodiments, the determination that the location associated with the user of the electronic device and the location of the trackable object are within the threshold distance of each other is in accordance with a determination that a second electronic device, different from the electronic device, that is associated with the user is within the threshold distance of the trackable object. Terminating access to a link that enables an entity to access a location of a trackable object that is owned by a user when the user is within a threshold distance of the trackable object helps ensure that access to the location of the trackable object is not provided to the entity for longer than necessary for locating the trackable object and/or enables the access to the link to be terminated automatically, which reduces the need for user input to manually terminate the access to the link, thereby improving user privacy and user-device interaction.

In some embodiments, the one or more second criteria include a criterion that is satisfied when a location associated with a respective user (e.g., the location of a respective electronic device associated with the respective user), other than a user of the electronic device, who has access to a location of the trackable object is within a threshold distance (e.g., 0.1, 0.2, 0.5, 0.8, 1, 1.2, 1.5, 2, 5, 10, 20 or 40 m) of the location of the trackable object, such as the location of the respective user being close to findable item Frank's Suitcase as visually represented on the map in user interface 1002 in FIG. 10A. For example, the electronic device terminates access to the one or more first features associated with the trackable object via the link for the entity (e.g., and/or other recipients) in accordance with a determination that a respective user with which the location of the trackable object has been shared and the trackable object are within the threshold distance of each other. In some embodiments, the respective user has access to the one or more first features and the one or more second features associated with the trackable object described above. In some embodiments, the respective user has been provided access to the location of the trackable object by the user of the electronic device (e.g., the owner of the trackable object), optionally prior to the trackable object being reported as lost to the entity by the user of the electronic device. In some embodiments, the respective user receives a notification or other alert (e.g., via a respective electronic device associated with the respective user) that informs the respective user that the trackable object is near their location. In some embodiments, the user of the electronic device (e.g., the owner of the trackable object) receives a notification or other alert, via the electronic device, that informs the user that the trackable object is near the location of the respective user (e.g., that the trackable object is in the respective user's possession). In some embodiments, in accordance with a determination that a second user (e.g., different from the respective user) who does not have access to the location of the trackable object (e.g., because the second user has not been granted access to the location of the trackable object by the user of the electronic device) is within the threshold distance of the location of the trackable object, the one or more second criteria are not satisfied. Terminating access to a link that enables an entity to access a location of a trackable object that is owned by a user when a person who has access to the location of the trackable object is within a threshold distance of the trackable object helps ensure that access to the location of the trackable object is not provided to the entity for longer than necessary for locating the trackable object and/or enables the access to the link to be terminated automatically, which reduces the need for user input to manually terminate the access to the link, thereby improving user privacy and user-device interaction.

In some embodiments, the one or more second criteria include a criterion that is satisfied when a threshold amount of time (e.g., 15 minutes, 30 minutes, 1 hour, 2 hours, 6 hours, 12 hours, 1 day, 5 days, 1 week, two weeks, and/or 1 month) has elapsed since providing access to the link (e.g., to the entity), as similarly described with reference to FIG. 10Z. For example, the electronic device terminates access to the one or more first features associated with the trackable object via the link for the entity (e.g., and/or other recipients) in accordance with a determination that the threshold amount of time has elapsed since the electronic device provided access to the link. In some embodiments, determining whether the threshold amount of time has elapsed is independent of whether the link is actually shared with the entity (e.g., and/or other recipients). In some embodiments, the threshold amount of time is determined based on when the link is actually shared with the entity (e.g., and/or other recipients). In some embodiments, the threshold amount of time is determined based on when the entity (e.g., or other recipient) accesses the one or more first features associated with the trackable object via the link (e.g., when the link is selected and/or otherwise activated by the entity). Terminating access to a link that enables an entity to access a location of a trackable object that is owned by a user when a threshold amount of time has elapsed since providing access to the link helps ensure that access to the location of the trackable object is not provided to the entity for longer than necessary for locating the trackable object and/or enables the access to the link to be terminated automatically, which reduces the need for user input to manually terminate the access to the link, thereby improving user privacy and user-device interaction.

In some embodiments, after terminating access to the link that enabled the entity to access the one or more first features associated with the trackable object in response to detecting that the one or more second criteria are satisfied, the electronic device displays, via the display generation component, a selectable option (e.g., selectable option 1017 in FIG. 10Z) that is selectable to initiate a process for renewing access to the link (e.g., in the user interface associated with the trackable object). For example, after the access to the one or more first features associated with the trackable object via the link has expired (e.g., according to any one or combination of criteria discussed above), the electronic device provides an option for renewing access to the link and thus the one or more first features associated with the trackable object. In some embodiments, the selectable option is displayed in the user interface associated with the trackable object discussed above. For example, the electronic device displays the selectable option in the management user interface for the trackable object (e.g., associated with the item locating application described previously above). In some embodiments, the selectable option is provided within an alert user interface object (e.g., a notification) that is presented to the user (e.g., on the electronic device) after the access to the link is terminated that notifies the user that the access to the link has been terminated. For example, the selectable option is displayed with and/or within the notification that is displayed on a lock screen user interface of the electronic device, a home screen user interface of the electronic device, the user interface associated with the trackable object, or a different user interface associated with an application running on the electronic device. In some embodiments, if the electronic device detects, via the one or more input devices, selection of the selectable option, the electronic device initiates the process to renew access to the link (e.g., displays a confirmation page prompting the user of the electronic device to renew access to the link for the entity or other recipient(s)). In some embodiments, initiating the process to renew access to the link includes providing/generating a new link (e.g., a second link, different from the link discussed above). In some embodiments, initiating the process to new access to the link includes re-enabling the same (e.g., existing) link that, when re-enabled, provides the entity access to the one or more first features associated with the trackable object. Providing an option for renewing access to a link that enables an entity to access a location of a trackable object that is owned by a user after the link has expired reduces the number of inputs needed to regrant the entity access to the location of the trackable object and/or helps ensure that access to the location of the trackable object can easily be regranted to the entity in the event that the access was prematurely or unintentionally terminated, thereby improving user privacy and user-device interaction and reducing user concern regarding the location of the lost trackable object.

In some embodiments, after providing access to the link that, if shared with the entity, would enable the entity to access the one or more first features associated with the trackable object (e.g., after detecting the first input and/or while access to the link is being provided by the electronic device), the electronic device detects, via the one or more input devices, a second input corresponding to a request to display a management user interface for the trackable object, such as selection of second option 1013b in FIG. 10X. In some embodiments, the management user interface for the trackable object is associated with an item locating application as discussed with reference to method 700. In some embodiments, the second input includes a selection of an icon (e.g., on a home screen of the electronic device) that is associated with the item locating application, such as via a tap of a contact (e.g., finger or stylus) on a touchscreen of the electronic device or selection via an input device such as a mouse or touchpad in communication with the electronic device. In some embodiments, the second input includes navigation to the management user interface for the trackable object within the item locating application. For example, the second input includes a selection of a representation of the trackable object on a home user interface of the item locating application (e.g., within a list of trackable objects owned by the user of the electronic device) that causes the electronic device to display the management user interface.

In some embodiments, in response to detecting the second input, the electronic device displays, via the display generation component, a management user interface for the trackable object, wherein the management user interface includes one or more options for managing the trackable object, including a first option that is selectable to initiate a process to terminate access to the link, such as second option 1009b in FIG. 10Y. For example, the management user interface for the trackable object includes information corresponding to the trackable object, such as an identifier of the trackable object (e.g., name, title, and/or label optionally designated by the user), a location of the trackable object (e.g., a current location or a last detected location of the trackable object), and/or a graphical representation (e.g., an image or rendering) of the trackable object (e.g., displayed at a location on a map corresponding to the last detected location for the trackable object), as described with reference to method 900. In some embodiments, the management user interface includes one or more options for managing the trackable object, including a selectable option that is selectable for requesting associating the trackable object with a time-bounded event, as similarly described with reference to methods 700 and/or 900, a selectable option for causing the trackable object to emit audio, a selectable option for initiating a mode for finding the trackable object, and/or the first option that is selectable to terminate access to the link for the entity (e.g., and/or other recipients). In some embodiments, if the electronic device detects, via the one or more input devices, selection of the first option, the electronic device initiates the process to terminate access to the link (e.g., displays a confirmation page prompting the user of the electronic device to confirm revoking access to the link and/or causing expiration of the link for the entity or other recipient(s)). Providing an option for terminating access to a link that enables an entity to access a location of a trackable object that is owned by a user after access to the link has been granted reduces the number of inputs needed to manually terminate the access to the location of the trackable object and/or helps ensure that access to the location of the trackable object can easily be terminated by the user at any time, thereby improving user privacy and user-device interaction and reducing user concern regarding the access to location of the trackable object.

In some embodiments, the one or more options further include a second option that is selectable to initiate a process to display a user interface associated with the entity (e.g., a user interface associated with an application of the entity), such as first option 1007a in FIG. 10AA or third option 1007c in FIG. 10BB. In some embodiments, the second option is displayed in the management user interface after the item with which the trackable object is associated has been reported as lost to the entity (e.g., in the manner described with reference to methods 700 and/or 900). In some embodiments, the electronic device detects, via the one or more input devices, a selection input directed to the second option. For example, the electronic device detects a tap or touch on a touch-sensitive surface (e.g., touchscreen) of the electronic device directed to the second option in the management user interface for the trackable object. In some embodiments, in response to detecting the selection of the second option, the electronic device initiates the process to display the user interface associated with the entity. In some embodiments, the process to display the user interface associated with the entity is based on whether the application of the entity is downloaded and/or running on the electronic device or is available to be downloaded onto the electronic device. For example, if the application of the entity (e.g., an airline application) is downloaded on the electronic device, the electronic device launches the application and displays the user interface associated with the entity in response to detecting a selection of the second option. In some embodiments, if the application of the entity is not downloaded on the electronic device and is available from an application store, the electronic device navigates to the application store and initiates downloading of the application of the entity in response to detecting a selection of the second option. In some embodiments, if an application of the entity is not available to be downloaded on the electronic device (e.g., such an application does not exist), the electronic device navigates to a website associated with the entity (e.g., in a web browsing application) in response to detecting a selection of the second option. In some embodiments, a visual appearance of the second option indicates whether the application of the entity is downloaded on the electronic device or is available to be downloaded onto the electronic device. For example, the first option includes a text indication that selecting the first option will launch the application of the entity or will navigate to the application store from which to download the application of the entity. In some embodiments, in accordance with a determination that a second entity, different from the entity discussed above, also has been provided access to the one or more first features associated with the trackable object via the link, the one or more options further include a third option that is selectable to initiate a process to display a user interface associated with the second entity in a similar manner as discussed above. In some embodiments, the one or more options further include a fourth option that is selectable to initiate a process to display a user interface associated with a second entity, different from the entity discussed above, for other trackable object, different from the trackable object discussed above (e.g., because the trackable objects are associated with (e.g., affixed to) other lost items that have been reported to the second entity). Providing an option for initiating a process to display a user interface associated with an entity within an item locating application via which the trackable object is managed reduces the number of inputs needed to access the user interface associated with the entity and/or facilitates discovery that the trackable object has been reported as lost to the entity, thereby improving user-device interaction and reducing user concern regarding the access to the location of the trackable object.

In some embodiments, providing access to the link that, if shared with the entity, would enable the entity to access the one or more first features associated with the trackable object includes displaying, via the display generation component, a visual indication of information associated with the trackable object that would be shared with the entity upon sharing of the link (and/or upon providing the entity access to the one or more first features), such as indication 1067 in FIG. 10N. For example, before sharing the link with the entity (e.g., in response to user input corresponding to a request to share the link with the entity), the electronic device displays a list of information corresponding to the trackable object that will become known to the entity upon sharing of the link. In some embodiments, as discussed below, the information associated with the trackable object includes identifying information for the trackable object and/or a current (e.g., or last-known) location of the trackable object. In some embodiments, the visual indication of information associated with the trackable object is displayed with a confirmation option that is selectable to continue with the process of sharing the link with the entity (e.g., and/or other recipients), as discussed in more detail below. In some embodiments, the visual indication of the information is displayed after the link has been generated (e.g., at the electronic device or at a server). In some embodiments, the visual indication of the information is displayed before the link has been generated. Providing an indication of the information that will become known to an entity via a link before the link is shared with the entity facilitates user understanding of the information that will be accessible by the entity and/or facilitates user input for confirming or forgoing the sharing of the link with the entity, thereby improving user privacy and user-device interaction.

In some embodiments, the visual indication of the information associated with the trackable object includes an identifier of the trackable object that distinguishes the trackable object from other trackable objects (e.g., other trackable objects owned by the user and/or other trackable objects known to the entity), such as indicator 1066 in FIG. 10N. For example, if the link is shared with the entity, the entity will have access to descriptive information that enables the entity to identify the trackable object. In some embodiments, the identifier of the trackable object includes an item type of the item with which the trackable object is associated (e.g., the lost item to which the trackable object is affixed). For example, the information associated with the trackable object includes a type of bag or luggage that has been reported as lost, including other descriptive details of the item. In some embodiments, the identifier of the trackable object includes an image of the trackable object. For example, the image corresponds to a stock image, a cartoon or other drawing representation, or other computer-generated image, rather than an actual photograph of the trackable object and/or the item. In some embodiments, if a second item has been reported as lost to the entity, and the second item is also associated with the trackable object discussed above, the visual indication of the information associated with the trackable object includes an item type of the second item with which the trackable object is associated, as similarly discussed above. In some embodiments, if a second trackable object (e.g., owned by the user of the electronic device) that is associated with a second item has been reported as lost to the same entity discussed above, the electronic device also displays an identifier of the second trackable object, optionally different from the identifier of the trackable object. Providing an indication of the information that will become known to an entity, including an identifier of the trackable object, via a link before the link is shared with the entity facilitates user understanding of the information that will be accessible by the entity and/or facilitates user input for confirming or forgoing the sharing of the link with the entity, thereby improving user privacy and user-device interaction.

In some embodiments, the visual indication of the information associated with the trackable object includes a representation of a map (e.g., map 1064 in FIG. 10N) including an indication of a location of the trackable object (e.g., a current location and/or last-known location of the trackable object). For example, the location of the trackable object is visually indicated on a virtual map, such as via a representation of the trackable object (e.g., an image or cartoon representation of the trackable object) that is displayed at a location on the map corresponding to the location of the trackable object. In some embodiments, the map corresponds to a predefined region (e.g., a predefined radius or area) of a physical location of the trackable object. For example, if the current or last-known location of the trackable object is an airport, the map is a map of the airport. Alternatively, the map is optionally an area within the airport (e.g., defined by a 1, 2, 5, 10, 15, 30, 40, 50, or 100 m radius or a particular terminal in which the location of the trackable object is located). In some embodiments, the map corresponds to a portion of the map included within the item locating application, as similarly discussed with reference to method 700. Providing an indication of the information that will become known to an entity, including the location of the trackable object, via a link before the link is shared with the entity facilitates user understanding of the information that will be accessible by the entity and/or facilitates user input for confirming or forgoing the sharing of the link with the entity, thereby improving user privacy and user-device interaction.

In some embodiments, providing access to the link that, if shared with the entity, would enable the entity to access the one or more first features associated with the trackable object includes displaying, via the display generation component, one or more options that are selectable to initiate a process for sharing the link (e.g., in the user interface associated with the trackable object discussed above), such as options 1076a-1076e in FIG. 10P. In some embodiments, the one or more options for sharing the link with the entity (e.g., or other recipients) are displayed based on whether the entity is configured to access the one or more first and the one or more second features associated with the trackable object, as similarly described with reference to method 900. For example, if the entity is not configured to access the one or more first and the one or more second features associated with the trackable object, the electronic device displays the one or more options that are selectable to initiate a process for sharing the link. In some embodiments, the electronic device detects, via the one or more input devices, a selection input directed to a respective option of the one or more options. For example, the electronic device detects a tap or touch on a touch-sensitive surface (e.g., touchscreen) of the electronic device directed to the respective option in the user interface associated with the trackable object. In some embodiments, in response to detecting the selection of the respective option, the electronic device initiates the process to share the link (e.g., with the entity). In some embodiments, as discussed below, the electronic device shares the link via an application running on the electronic device, such as via a messaging application (e.g., text or email), a web-browsing application, and/or a social media application. In some embodiments, if the electronic device detects, via the one or more input devices, selection of one of the one or more options, the electronic device initiates the process to share the link via a respective application associated with the selected option (e.g., with the entity or other recipient(s)). Providing one or more options for initiating a process to share a link that provides access to a location of the trackable object with an entity when the link is generated reduces the number of inputs needed to share the link with the entity and/or facilitates discovery that the link has not yet been shared with the entity, thereby improving user-device interaction and reducing user concern regarding the access to the location of the trackable object.

In some embodiments, the one or more options include a respective option that is selectable to initiate a process to copy the link (e.g., saving text corresponding to the link to memory of the electronic device), such as fourth option 1076d in FIG. 10P. For example, the one or more options include a list of options, including the respective option for copying the link. In some embodiments, once the link has been copied by the electronic device, the link is able to be pasted into a text-entry region of a respective user interface that enables the link to be shared (e.g., with the entity or other recipients), as discussed in more detail below. In some embodiments, copying the link enables the user to select the recipients of the link, including the entity. In some embodiments, if the electronic device detects, via the one or more input devices, selection of the respective option (e.g., a tap or touch on a touchscreen of the electronic device directed to the respective option), the electronic device copies the link (e.g., saves the text corresponding to the link to memory of the electronic device for pasting into a text-entry region, as discussed below). Providing an option for copying a link that provides access to a location of the trackable object with an entity when the link is generated reduces the number of inputs needed to share the link with the entity and/or facilitates discovery that the link has not yet been shared with the entity, thereby improving user-device interaction and reducing user concern regarding the access to the location of the trackable object.

In some embodiments, while displaying the one or options for sharing the link, the electronic device detects, via the one or more input devices, a sequence of one or more inputs, including a respective input corresponding to selection of the respective option, such as selection of fourth option 1076d in FIG. 10P. For example, the electronic device detects a selection of the respective option for copying the link. In some embodiments, the sequence of one or more inputs includes an input corresponding to a request to launch an application via which to share the copied link. In some embodiments, the sequence of one or more inputs includes an input corresponding to a request to paste the copied link into a text-entry region for sharing the link with the entity (e.g., and/or other recipients). In some embodiments, the sequence of one or more inputs includes activating a machine-readable code associated with the link (e.g., in response to user input directed to the machine-readable code, such as a press and hold of (e.g., by a finger of the user) directed to the machine-readable code). For example, the machine-readable code includes a quick-response (QR) code, barcode, or other image displayed on the electronic device or on a second electronic device, separate from the electronic device, that, when selected, scanned, or otherwise activated, causes the electronic device to initiate a process to share the link, such as displaying a representation of the link, as discussed below.

In some embodiments, in response to detecting the sequence of one or more inputs, the electronic device copies the link, as similarly described with reference to FIG. 10P. For example, the electronic device (e.g., temporarily) saves the link to memory of the electronic device in response to detecting a first input of the sequence of one or more inputs discussed above. In some embodiments, the electronic device creates a copy of the link for pasting into text-entry region of a respective user interface. In some embodiments, the copy of the link is saved for a threshold amount of time (e.g., 5 minutes, 15 minutes, 20 minutes, 30 minutes, 45 minutes, 1 hour, 2 hours, 5 hours, 6 hours, or 12 hours) and/or until other text (e.g., text different from the link) is copied in response to user input.

In some embodiments, the electronic device displays, via the display generation component, a representation of the link in a respective user interface for sharing the link, as similarly described with reference to FIG. 10P. For example, the electronic device pastes the link into a text-entry region of the respective user interface in response to detecting a second input (e.g., an input subsequent to the first input that causes the link to be copied) of the sequence of one or more inputs discussed above corresponding to a request to paste the copied link. In some embodiments, the respective user interface is a user interface of a messaging application, such as a text-messaging application or an email application, and the representation of the link is pasted into a text-entry region of the user interface, such as in a text message or in the body of an email that is able to be transmitted to a recipient, such as the entity. In some embodiments, the respective user interface is a user interface of a web-browsing application, such as a search engine, and the representation of the link is pasted into a text-entry region of the user interface, such as in a search bar that enables the website associated with the link to be navigated to. Providing an option for copying a link that grants access to a location of the trackable object to an entity when the link is generated reduces the number of inputs needed to share the link with the entity and/or facilitates discovery that the link has not yet been shared with the entity, thereby improving user-device interaction and reducing user concern regarding the access to the location of the trackable object.

In some embodiments, the one or more options include a respective option (e.g., fifth option 1076e in FIG. 10P) that is selectable to initiate a process to convert the link to a machine-readable code, such as QR code 1085 in FIG. 10S. For example, the respective option is selectable to convert the link to a QR code, a bar code, or other unique image that is able to be scanned (e.g., visually, such as via a camera or other optical sensor, electronically, such as via Bluetooth or Wi-Fi, and/or otherwise) by the entity. In some embodiments, subsequent to the link being converted to the machine-readable code (e.g., in response to detecting an input selecting the respective option), the machine-readable code is able to be shared with the entity (e.g., using the one or more options discussed above). For example, the electronic device shares the machine-readable code with the entity instead of the link, and the machine-readable code is scannable to access the one or more first features associated with the trackable object. Providing an option for converting a link that provides access to a location of the trackable object to machine-readable code that is scannable by the entity when the link is generated reduces the number of inputs needed to provide the entity access to the location of the trackable object entity, thereby improving user-device interaction and reducing user concern regarding the location of the lost trackable object.

In some embodiments, the one or more options include a respective option (e.g., second option 1076b or third option 1076c in FIG. 10P) that is selectable to initiate a process to share the link in one or more messages that include (optionally a representation of) the link. For example, the respective option is selectable to initiate a messaging session with the entity in which the link is displayed in the form of one or more messages (e.g., messages including text and the link). In some embodiments, the electronic device detects, via the one or more input devices, a selection input directed to the respective option. For example, the electronic device detects a tap or touch on a touch-sensitive surface (e.g., touchscreen) of the electronic device directed to the respective option in the user interface associated with the trackable object. In some embodiments, in response to detecting the selection of the second option, the electronic device initiates the process to display the user interface associated with the entity. In some embodiments, the messaging session is initiated with the entity via a messaging application of the electronic device (e.g., a system messaging application or another messaging application operating on the electronic device). For example, the one or more messages that are displayed are transmitted to a contact phone number or email of the entity via the messaging session. In some embodiments, the messaging session is initiated with the entity via an application associated with the entity (e.g., an airline application) operating on the electronic device. For example, the messaging session corresponds to a chat or help line for communicating directly with the entity within the application associated with the entity. In some embodiments, the one or more messages include images, video, or other content corresponding to the trackable object, in addition to the link (or machine-readable code as discussed above). Providing an option for composing a message that includes a link that grants access to a location of the trackable object to an entity when the link is generated reduces the number of inputs needed to share the link with the entity and/or facilitates discovery that the link has not yet been shared with the entity, thereby improving user-device interaction and reducing user concern regarding the access to the location of the trackable object.

In some embodiments, the respective option is a first option (e.g., second option 1076b in FIG. 10P) that is selectable to initiate a process to share the link in one or more first messages of a first type. In some embodiments, the one or more options further include a second option (e.g., third option 1076c in FIG. 10P) that is selectable to initiate a process to share the link in one or more second messages of a second type, different from the first type. In some embodiments, the first option and the second option are concurrently displayed. For example, the electronic device concurrently displays multiple options that are selectable to initiate messaging sessions of different types with the entity. For example, the electronic device concurrently displays the first option that is selectable to initiate a messaging session with the entity in which the link is displayed in the form of one or more text messages using a text-messaging application, and the second option that is selectable to initiate a messaging session with the entity in which the link is displayed in the form of text in a body of an email using an email application. Additionally, in some embodiments, the electronic device also displays a third option that is selectable to initiate a messaging session with the entity in which the link is displayed in the form of one or more messages within a chat or help line for communicating directly with the entity using an application associated with the entity.

In some embodiments, while displaying the one or options for sharing the link, including the first option and the second option, the electronic device detects, via the one or more input devices, a selection input, such as tap of contacts 1003b and 1003c as shown in FIG. 10P. For example, the electronic device detects a tap or touch on a touch-sensitive surface (e.g., touchscreen) of the electronic device directed to the first option or the second option in the user interface associated with the trackable object. In some embodiments, the selection input has one or more characteristics of the inputs discussed above.

In some embodiments, in response to detecting the selection input, in accordance with a determination that the selection input corresponds to a selection of the first option (e.g., the selection input is directed to the first option), the electronic device initiates the process to share the link in the one or more first messages of the first type, such as messages 1081a and 1081b in FIG. 10R. In some embodiments, in accordance with a determination that the selection input corresponds to a selection of the second option (e.g., the selection input is directed to the second option), the electronic device initiates the process to share the link in the one or more second messages of the second type, as similarly described with reference to FIG. 10P. In some embodiments, if the electronic device detects, via the one or more input devices, selection of the first option, the electronic device initiates the messaging session with the entity and displays a representation of the link in one or more text messages within a user interface of the text-messaging application. In some embodiments, if the electronic device detects, via the one or more input devices, selection of the second option, the electronic device initiates the messaging session with the entity and displays a representation of the link in a body of an email within a user interface of the email application. Providing multiple options for composing different types of messages that include a link that grants access to a location of the trackable object to an entity when the link is generated reduces the number of inputs needed to share the link with the entity and/or provides the user with greater agency regarding the manner in which the link is shared with the entity, thereby improving user-device interaction and reducing user concern regarding the access to the location of the trackable object.

In some embodiments, access to the one or more first features associated with the trackable object via the link is limited by an access request threshold, as similarly described with reference to accessing web page 1088 in FIG. 10T. For example, access to the location of the trackable object is rate limited, such as limited to a threshold number (e.g., 1, 2, 3, 4, 5, 8, 10, or 12) of (optionally unique) access credentials, as similarly discussed below, or limited to a threshold number (e.g., 1, 2, 3, 4, 5, 8, 10, 15, 20, or 30) of total access requests. In some embodiments, the access to the one or more first features associated with the trackable object via the link is (e.g., automatically) revoked/terminated when the threshold number of requests is reached/exceeded (e.g., by the electronic device). For example, the link is no longer selectable/activatable to access the location of the trackable object when the threshold number of requests is reached/exceeded and/or to more than a threshold number of (optionally unique) access credentials. In some embodiments, the access to the one or more first features associated with the trackable object via the link is (e.g., automatically) revoked/terminated when the threshold number of requests is reached/exceeded within a respective (e.g., predefined) time period (e.g., 1 hour, 2 hours, 6 hours, 12 hours, 1 day, 2 days, 4 days, or 1 week). Limiting access to a location of a trackable object that is accessible via a link to a threshold number of access requests helps ensure that the location of the trackable object is accessed by the intended recipient(s) of the link and/or helps ensure that access to the location of the trackable object is not provided to the entity for longer than necessary for locating the trackable object, thereby improving user privacy and user-device interaction and reducing user concern regarding who has access to the location of the lost trackable object.

In some embodiments, access to the one or more first features associated with the trackable object via the link requires authentication of a respective access credential, as similarly described with reference to accessing web page 1088 in FIG. 10T. For example, when the link is activated/selected (e.g., by a recipient of the link, such as a person associated with the entity), a website is launched (e.g., in a web-browsing application) that prompts the recipient of the link to enter a login credential, such as an authorized username and password. In some embodiments, the respective access credential is determined by the electronic device (e.g., when the link is generated and/or shared). In some embodiments, the respective access credential is determined by the user of the electronic device (e.g., the electronic device prompts the user to create a username and/or password via which to access the one or more first features associated with the trackable object when the link is activated). In some embodiments, the respective access credential is determined by the entity (e.g., after the link is shared with the entity) and is known by authorized personnel associated with the entity (e.g., employees of the airline). In some embodiments, a same access credential (e.g., the respective access credential) is able to be used to access one or more first features associated with a second trackable object (e.g., and/or a third trackable object), different from the trackable object discussed above, that is owned by the user of the electronic device (e.g., if access to the location of the second trackable object (e.g., and/or the third trackable object) has also been granted to the entity via the link (or a different link) in the manner discussed above). In some embodiments, the respective access credential corresponds to any access credential that is associated with a user account (e.g., a valid user account), and not necessarily determined by the user of the electronic device. For example, the access to the one or more first features associated with the trackable object is granted based on a determination that the username and/or password entered by a person, after activating the link, are associated with an existing and valid user account (e.g., irrespective of whether the user account is associated with the owner of the trackable object or the entity). In some embodiments, if the respective access credential is not provided and/or is not authenticated, the access to the one or more first features associated with the trackable object is not granted. Requiring an access credential to access a location of a trackable object that is accessible via a link when the link is activated helps ensure that the location of the trackable object is accessed by the intended recipient of the link, thereby improving user privacy and user-device interaction and reducing user concern regarding who has access to the location of the lost trackable object.

In some embodiments, in response to detecting the first input, in accordance with a determination that a location of the trackable object was near a location associated with a user of the electronic device within a threshold period of time (e.g., from a current time and/or a time when the first input was detected), the electronic device displays, via the display generation component, an alert user interface object (e.g., alert 1093 in FIG. 10V) that indicates the location of the trackable object was near the location associated with the user recently. For example, when the electronic device detects the first input and/or while the electronic device is detecting the first input, the electronic device determines that the user of the electronic device (and/or the electronic device) and the trackable object (and thus the item) have recently (e.g., within the past 1 minute, 3 minutes, 5 minutes, 10 minutes, 15 minutes, 25 minutes, 30 minutes, 1 hour, 3 hours, or 5 hours) been within a threshold distance (e.g., 0.1, 0.2, 0.5, 0.8, 1, 1.2, 1.5, 2, 5, 10, 20 or 40 m) of each other and have moved together (e.g., moved while not becoming farther than the threshold distance apart) a predefined distance (e.g., 1, 2, 5, 10, 15, 20, 30, 35, or 40 m) and/or have not been stationary for at least a threshold amount of time (e.g., 1 minute, 5 minutes, 15 minutes, 30 minutes, 1 hour, or 2 hours), as similarly described with reference to method 900. In some embodiments, the electronic device proceeds with the process for granting permission to the entity to access the one or more first features associated with the trackable object discussed above despite displaying the alert user interface object (e.g., without the need for additional user input after displaying the alert user interface object). Alternatively, in some embodiments, when the alert user interface object is displayed, the electronic device forgoes proceeding with the process to grant the entity access to the one or more first features associated with the trackable object until additional user input is detected for proceeding with the process (e.g., user input directed toward the alert user interface object or other selectable option). In some embodiments, when the alert user interface object is displayed, the electronic device forgoes proceeding with the process to grant the entity access to the one or more first features associated with the trackable object and optionally does not provide an option (e.g., a selectable option) for proceeding with the process. In some embodiments, in accordance with a determination that the location of the trackable object was not near the location associated with the user of the electronic device recently, the electronic device forgoes displaying the alert user interface object that indicates the location of the trackable object was near the location associated with the user recently (e.g., and optionally provides access to the link as discussed above). Generating an alert at an electronic device when a location associated with a user of the electronic device and a location of a trackable object associated with the user are or have recently been near each other when the trackable object is reported as lost to an entity facilitates discovery that the user of the electronic device is in possession of the trackable object and/or helps the user avoid unintentionally and/or undesirably granting the entity access to the location of the trackable object, thereby improving user-device interaction and improving user privacy.

In some embodiments, in response to detecting the first input, in accordance with a determination that a location of the trackable object was updated (e.g., or otherwise known) more than a threshold amount of time ago (e.g., 5 minutes, 15 minutes, 30 minutes, 1 hour, 2 hours, 5 hours, 10 hours, 1 day, 3 days, or 1 week) (e.g., from a current time and/or from a time when the first input was detected), the electronic device displays, via the display generation component, an alert user interface object (e.g., alert 1096 in FIG. 10W) that indicates the location of the trackable object was updated more than the threshold amount of time ago (e.g., an alert that the location of the trackable object is outdated and/or would otherwise not assist the entity in locating the item). For example, when the electronic device detects the first input and/or while the electronic device is detecting the first input, the electronic device determines that a last-known location of the trackable object (and thus the item) is known based on location data reported by the trackable object more than the threshold amount of time ago, as similarly described with reference to method 900. In some embodiments, the electronic device proceeds with the process for granting permission to the entity to access the one or more first features associated with the trackable object discussed above despite displaying the alert user interface object (e.g., without the need for additional user input after displaying the alert user interface object). Alternatively, in some embodiments, when the alert user interface object is displayed, the electronic device forgoes proceeding with the process to grant the entity access to the one or more first features associated with the trackable object until additional user input is detected for proceeding with the process (e.g., user input directed toward the alert user interface object or other selectable option). In some embodiments, when the alert user interface object is displayed, the electronic device forgoes proceeding with the process to grant the entity access to the one or more first features associated with the trackable object and optionally does not provide an option (e.g., a selectable option) for proceeding with the process. In some embodiments, in accordance with a determination that the location of the trackable object was updated less than the threshold amount of time ago, the electronic device forgoes displaying the alert user interface object that indicates the location of the trackable object was updated more than the threshold amount of time ago (e.g., and optionally provides access to the link as discussed above). Generating an alert at an electronic device when a location of a trackable object associated with the user of the electronic device is outdated when the trackable object is reported as lost to an entity facilitates discovery that the location of the trackable object will not assist the entity in locating the trackable object and/or helps the user avoid unintentionally and/or undesirably granting the entity access to the location of the trackable object, thereby improving user-device interaction and improving user privacy.

In some embodiments, in response to detecting the first input, in accordance with a determination that a location of the trackable object corresponds to a respective location of one or more user-specified locations (e.g., at a current time and/or at a time when the first input was detected), the electronic device displays, via the display generation component, an alert user interface object (e.g., similar to alert 1091 in FIG. 10U) that indicates presence of the trackable object at the respective location. For example, when the electronic device detects the first input and/or while the electronic device is detecting the first input, the electronic device determines that the trackable object (and thus the item) is located at a location that is known to the user of the electronic device (e.g., a “safe” or “trusted” location), such as one or more locations saved in memory of the electronic device, as similarly described with reference to method 900. In some embodiments, the electronic device proceeds with the process for granting permission to the entity to access the one or more first features associated with the trackable object discussed above despite displaying the alert user interface object (e.g., without the need for additional user input after displaying the alert user interface object). Alternatively, in some embodiments, when the alert user interface object is displayed, the electronic device forgoes proceeding with the process to grant the entity access to the one or more first features associated with the trackable object until additional user input is detected for proceeding with the process (e.g., user input directed toward the alert user interface object or other selectable option). In some embodiments, when the alert user interface object is displayed, the electronic device forgoes proceeding with the process to grant the entity access to the one or more first features associated with the trackable object and optionally does not provide an option (e.g., a selectable option) for proceeding with the process. In some embodiments, in accordance with a determination that the location of the trackable object does not correspond to a respective location of the one or more user-specified locations, the electronic device forgoes displaying the alert user interface object that indicates presence of the trackable object at the respective location (e.g., and optionally provides access to the link as discussed above). Generating an alert at an electronic device when a location of a trackable object associated with the user of the electronic device corresponds to a safe location when the trackable object is reported as lost to an entity facilitates discovery that the trackable object is located at the safe location and/or helps the user avoid unintentionally and/or undesirably granting the entity access to the location of the trackable object, thereby improving user-device interaction and improving user privacy.

It should be understood that the particular order in which the operations in FIG. 11 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700 and/or 900) are also applicable in an analogous manner to method 1100 described above with respect to FIG. 11. For example, remote locator objects, sharing access to one or more features of findable items, displaying item locating applications, displaying user interfaces associated with findable items, displaying status updates related to findable items, and displaying user interfaces associated with entities findable items described above with reference to method 1100 optionally have one or more of the characteristics of findable items, sharing access to locations of findable items with entities, displaying item locating applications, displaying user interfaces associated with findable items, and displaying user interfaces associated with entities described herein with reference to other methods described herein (e.g., methods 700 and/or 900). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5H) or application specific chips. Further, the operations described above with reference to FIG. 11 are, optionally, implemented by components depicted in FIGS. 1A-1B. For example, displaying operation 902a and detecting operation 902b are optionally, implemented by event sorter 170, event recognizer 180, and event handler 190. Event monitor 171 in event sorter 170 detects a contact on touch screen 504, and event dispatcher module 174 delivers the event information to application 136-1. A respective event recognizer 180 of application 136-1 compares the event information to respective event definitions 186, and determines whether a first contact at a first location on the touch screen corresponds to a predefined event or sub-event, such as selection of an object on a user interface. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is the gathering and use of data available from specific and legitimate sources to improve the ability for users to track and locate items that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to identify the location of remote locator objects and/or identify the location of the user. Accordingly, use of such personal information data enables users to identify, find, and otherwise interact with remote locator objects. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data and notifications can be delivered to users based on aggregated non-personal information data or a bare minimum amount of personal information.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at an electronic device in communication with a display generation component and one or more input devices:
while displaying, via the display generation component, a user interface associated with a trackable object that is associated with the electronic device, receiving, via the one or more input devices, a first input corresponding to a request to associate the trackable object with a time-bounded event; and
in response to receiving the first input, initiating a process to share information corresponding to a location of the trackable object with an entity associated with the time-bounded event, wherein the information corresponding to the location of the trackable object is shared with the entity for a respective duration associated with the time-bounded event.

2. The method of claim 1, wherein:
the user interface associated with the trackable object includes a first selectable option that is selectable for requesting associating the trackable object with the time-bounded event; and
the first input includes selection of the first selectable option.

3. The method of claim 1, wherein the entity associated with the time-bounded event is an organization associated with the time-bounded event.

4. The method of claim 1, wherein the user interface associated with the trackable object is a management user interface for the trackable object, wherein the management user interface is a user interface of an item locating application.

5. The method of claim 4, wherein the item locating application provides for management of a plurality of trackable objects including the trackable object.

6. The method of claim 4, wherein initiating the process to share information corresponding to the location of the trackable object with the entity associated with the time-bounded event includes:
displaying, via the display generation component, information corresponding to one or more respective future time-bounded events, including the time-bounded event.

7. The method of claim 4, further comprising:
after sharing the information corresponding to the location of the trackable object with the entity associated with the time-bounded event, displaying, via the display generation component, an indication that the trackable object is associated with the time-bounded event in the management user interface.

8. The method of claim 1, wherein the user interface associated with the trackable object is a management user interface for the time-bounded event.

9. The method of claim 8, wherein the management user interface for the time-bounded event is a user interface of an application associated with the entity.

10. The method of claim 8, wherein the management user interface for the time-bounded event is a user interface of a virtual wallet application configured to store digital passes, including a digital pass associated with the time-bounded event.

11. The method of claim 1, wherein the first input includes input directed to a system alert of the electronic device that is displayed via the display generation component.

12. The method of claim 1, wherein a beginning of the respective duration associated with the time-bounded event is determined based on a beginning of the time-bounded event.

13. The method of claim 1, wherein a beginning of the respective duration associated with the time-bounded event is determined based on a current location of the electronic device.

14. The method of claim 1, wherein a beginning of the respective duration associated with the time-bounded event is determined based on detection that the location of the trackable object is more than a threshold distance from a current location of the electronic device.

15. The method of claim 1, wherein an end of the respective duration associated with the time-bounded event is determined based on an anticipated end of the time-bounded event.

16. The method of claim 1, wherein an end of the respective duration associated with the time-bounded event is determined based on detection that the location of the trackable object is within a threshold distance of a current location of the electronic device.

17. The method of claim 1, wherein:
before receiving the first input, a current location of the trackable object is updated at the electronic device at a first frequency; and
while sharing the information corresponding to the location of the trackable object with the entity associated with the time-bounded event, the current location of the trackable object is updated at the electronic device at a second frequency, greater than the first frequency.

18. The method of claim 1, further comprising:
while sharing the information corresponding to the location of the trackable object with the entity associated with the time-bounded event, displaying, via the display generation component, information corresponding to a status of the trackable object relative to the time-bounded event, wherein the information is determined based on:
a current location of the trackable object; and
tracking updates for the trackable object provided by the entity.

19. The method of claim 1, wherein initiating the process to share information corresponding to the location of the trackable object with the entity associated with the time-bounded event includes initiating a process to grant permission to the entity to access one or more features of the trackable object for enabling locating the trackable object based on signals transmitted by the trackable object.

20. An electronic device, comprising:
one or more processors;
memory; and
one or more programs, wherein the one or more programs are stored in the memory and configured to be executed by the one or more processors, the one or more programs including instructions for:
while displaying, via a display generation component, a user interface associated with a trackable object that is associated with the electronic device, receiving, via one or more input devices, a first input corresponding to a request to associate the trackable object with a time-bounded event; and
in response to receiving the first input, initiating a process to share information corresponding to a location of the trackable object with an entity associated with the time-bounded event, wherein the information corresponding to the location of the trackable object is shared with the entity for a respective duration associated with the time-bounded event.

21. A non-transitory computer readable storage medium storing one or more programs, the one or more programs comprising instructions, which when executed by one or more processors of an electronic device, cause the electronic device to perform a method comprising:
while displaying, via a display generation component, a user interface associated with a trackable object that is associated with the electronic device, receiving, via one or more input devices, a first input corresponding to a request to associate the trackable object with a time-bounded event; and
in response to receiving the first input, initiating a process to share information corresponding to a location of the trackable object with an entity associated with the time-bounded event, wherein the information corresponding to the location of the trackable object is shared with the entity for a respective duration associated with the time-bounded event.

22-90. (canceled)
